(19) United States
(12) Patent Application Publication
(10) Pub. No.: US 2014/0236728 A1
(43) Pub. Date: Aug. 21, 2014

(54) INTERACTIVE SERVICE AND ADVERTISING SYSTEMS AND METHODS

(71) Applicant: Seeln Systems, Inc., Saratoga, CA (US)

(72) Inventor: Jason Robert Wright, Saratoga, CA (US)

(73) Assignee: Seeln Systems, Inc, Saratoga, CA (US)

(21) Appl. No.: 14/185,810

(22) Filed: Feb. 20, 2014

Related U.S. Application Data
(60) Provisional application No. 61/767,752, filed on Feb. 21, 2013.
(60) Provisional application No. 61/906,365, filed on Nov. 19, 2013.

(51) Int. Cl. G06Q 30/02

(52) U.S. Cl. CPC G06Q 30/0272; G06Q 30/0269; G06Q 30/0261; G06Q 30/0267
USPC 705/14.58; 705/14.68; 705/14.66; 705/14.64

(57) ABSTRACT

Systems and methods for providing interactive services and adaptive advertising in a retail environment such as a shopping mall are provided. One or more systems and a data network are used to provide services which in turn are used to collect information about users and user's preferences at a site area to adapt digital multimedia advertising content at that site. User's preferences at a site area are compiled from selections made by users on systems with fixed or mobile terminals located at the site and which provide services to the users relating to the site area. The selections are used to automatically adjust digital multimedia advertisement at the site and at specific systems with displays at the site which are in the proximity or viewable range of the user or along an approximate path that the user may take at the site.

### CROSS-REFERENCE TO RELATED APPLICATION

The present application claims priority under 35 U.S.C. 119 to U.S. Provisional Application No. 61/767,752, entitled “INTERACTIVE SERVICE AND ADVERTISING SYSTEMS AND METHODS,” filed on Feb. 21, 2013 and U.S. Provisional Application No. 61/906,365, entitled “INTERACTIVE SERVICE AND ADVERTISING SYSTEMS AND METHODS,” filed on Nov. 19, 2013, both of which are incorporated herein as if set forth in full.

### FIELD OF THE INVENTION

The present invention relates to the field of interactive maps and advertisements. More particularly, the present invention relates to dynamic interactive maps and advertisements that are able to dynamically adjusted based on sensory input.

### BACKGROUND

Currently mall maps are primarily shown on static free standing displays. These maps can be difficult and sometimes time consuming to use due to the fact that directory items listed under static categories must be matched by number and sometimes color to an area and location on a map. This information is typically out of date due to the fact that malls are changing and print static maps take time and money to update. Also, current mall maps are large and take up a great deal of valuable real-estate in shopping malls and block the view to stores.

Currently advertisement displays in malls are print static posters located on walls or stands near high foot traffic areas or are digital displays consisting of large LCD or LED displays which show rolling advertisements on timed loops. The static print advertisements are not easily or quickly updated if an error is made during printing and discovered after installation or if a new offer is available for a short period of time such as a 3 day sale. When compared to digital displays, print ads do not capture as much attention due to their static nature. Current digital display advertising show ads on a rolling timed loop. They do not have the ability to adapt or display advertisements based on the current interests of the shoppers in the area.

Currently shopper analytics for the characterization of a mall's shoppers is limited. City and national demographic and trending data does not capture the true demographic and interests of the mall shoppers which can change rapidly. Human surveys take time and cannot provide real-time data and cannot adjust to shoppers' preference quickly enough. Vision systems cannot determine interest of shoppers outside of stores, and cannot determine interests inside of stores.

Mobile solutions to some of the above issues have been and are in development to improve on each of the above issues but cannot tie together an integrated solution. Additionally, mobile solutions will always suffer from small display screen size severely limiting the information shown to the user of the mobile device. A big picture view of something like a shopping mall with the shopper's location, a destination store and surrounding stores cannot be shown in a legible method on a mobile device.

### SUMMARY OF THE INVENTION

The interactive service and advertising system, method and device is directed to an interactive map and advertisement display system for use in, for example, a retail environment. The interactive service and advertising system, method and device is able to comprise a touchscreen display, non-touchscreen digital display, sensors and camera inputs, wireless RF connections, a controller, and a frame and covers. The touchscreen is able to display a touch selectable and linked mall map and directory display which is able to also display information and images relating to the site of installation based on selections made by a user. A non-touch digital display which is able to show image, text, and multimedia advertisements that operate on timed loops, are triggered by user input selections from the touchscreen, or are triggered by timed events, or any combination of the three to provide advertisements which are able to be highly relevant to the current user of the system or the local demographic. Sensors and camera inputs are able to be used to determine the number and location of people in viewable range of the system. Sensor inputs are able to be used to increase the accuracy of the camera inputs by comparing input status.

The camera is able to also be used to determine characteristics about the user of the system which is able to include items such as gender and age of and be used with inputs from the touchscreen display to determine likely preferences of the user and show data and advertisements based on those determined preferences on the displays. Wireless data connections can be used to update the systems content for the area of installation, and to report system usage data such as user or shopper analytics to a remote server. The wireless data connection is able to also be used to couple a shopper's mobile device such as smart phones in proximity of the system to the system and accept requests from the mobile device and return information and data relating to the site of installation, such as the mall and stores, which is available on the touchscreen of the system. Furthermore, the mobile device is able to be used as a means of input control and the non-touchscreen display is able to be used and a large format display for information that would not be clearly legible on a smart phone display. A controller such as a computer motherboard is used to couple and control all electronic devices on the system and execute the operating system and main control program to perform the logical operations of the system. The frame and covers are used to support all the components and protect them from damage and enable the system to require only a small foot print when compared to current static mall maps.

A first aspect is directed to an interactive service and advertising system. The system comprises a first interactive device having a first display and a first content database storing one or more content items each having a first content score and a first controller coupled with the first interactive device, wherein the first controller selects and displays a selected content item having the highest first content score on the first display for a predefined content period. In some embodiments, the first interactive device comprises one or more first sensors that cause the first controller to select and display the selected content item when the first sensors detect one or more users are proximate the first interactive device. In some embodiments, the system further comprises a user database storing one or more user entries, wherein the first sensors detect one or more characteristics of users that are proximate the first interactive device and the first controller stores the characteristics for each of the users in one of the user entries. In some embodiments, the characteristics are selected from the group consisting of a media access control address of a device of the user, a presence of the user, one or more images of the user, a location of the user relative to the first interactive device, areas of the first interactive device gazed upon by the user and user data submitted by the user on the first interactive device. In some embodiments, the user data submitted by the user on the first interactive device is selected from the group consisting of a sale, a product and a destination. In some embodiments, based on one or more of the characteristics the first controller determines one or more attributes of the corresponding user selected from the group consisting of age, gender, hair color, eye color, clothing color, height, weight and race. In some embodiments, the first controller adjusts the first content score of one or more of the content items based on the characteristics, the attributes or both. In some embodiments, during the predefined content period the first sensors detect one or more content analytic values that are then associated with the selected content item in an analytic database by the first controller, wherein the content analytic values are selected from the group consisting of a quantity of users proximate the first interactive device, a duration that each of the users proximate the first interactive device is proximate the first interactive device, whether the selected content item was displayed in the areas gazed upon by the users proximate the first interactive device and the user data submitted by the users proximate the first interactive device relating to the selected content item, the attributes of the users proximate the first interactive device. In some embodiments, the first controller identifies a user detected by the first sensors by matching one of the user entries to the user based on the characteristics stored in the matched user entry, and further wherein the first controller adjusts the first content score of one or more of the content items based on the matched user entry. In some embodiments, the system further comprises a second controller coupled with a second interactive device having a second display, one or more second sensors and a second database storing one or more of the content items each having a second content score, wherein the second controller selects and displays the content item having the highest second content score on the second display. In some embodiments, the second controller identifies a user detected by the second sensors by matching one of the user entries to the user based on the characteristics stored in the matched user entry, and further wherein the second controller adjusts the second content score of one or more of the content items based on the matched user entry. In some embodiments, the second controller adjusts the second content score of one or more of the content items based on one or more of the characteristics detected by the first sensors and a location of the second interactive device relative to a location of the first interactive device. In some embodiments, the adjustment of the second content score of the one or more of the content items based on one or more of the characteristics detected by the first sensors and the location of the second interactive device relative to the location of the first interactive device is limited to a predetermined walk period whose length is based on the distance between the first and second interactive devices. In some embodiments, the first controller increases the value of the content score of a content item displayed on the first display when the first sensors detect that the one or more users are proximate the first interactive device for a predefined score period while the content item was being displayed. In some embodiments, the first controller decreases the value of the content score of the selected content item upon the display of the selected content item on the first display. In some embodiments, the first interactive device is configured to wirelessly couple to a mobile device such that the first controller receives one or more commands from the mobile device and transmits one or more of the content items from the first content database to the mobile device based on the commands.

A second aspect is directed to an interactive service and advertising device. The device comprises a first display, a memory storing a first content database including one or more content items each having a first content score and a first controller coupled to the first display and the memory, wherein the first controller selects and displays a selected content item having the highest first content score on the first display for a predefined content period. In some embodiments, the device further comprises one or more first sensors that cause the first controller to select and display the selected content item when the first sensors detect one or more users are proximate the first display. In some embodiments, the device further comprises a user database storing one or more user entries, wherein the first sensors detect one or more characteristics of users that are proximate the first display and the first controller stores the characteristics for each of the users in one of the user entries. In some embodiments, the characteristics are selected from the group consisting of a media access control address of a device of the user, a presence of the user, one or more images of the user, a location of the user relative to the first display, areas of the first display gazed upon by the user and user data submitted by the user via the first sensors. In some embodiments, the user data submitted by the user via the first sensors is selected from the group consisting of a sale, a product and a destination. In some embodiments, based on one or more of the characteristics the first controller determines one or more attributes of the corresponding user selected from the group consisting of age, gender, hair color, eye color, clothing color, height, weight and race. In some embodiments, the first controller adjusts the first content score of one or more of the content items based on the characteristics, the attributes or both. In some embodiments, during the predefined content period the first sensors detect one or more content analytic values that are then associated with the selected content item in an analytic database by the first controller, wherein the content analytic values are selected from the group consisting of a quantity of users proximate the first display, a duration that each of the users proximate the first display is proximate the first display, whether the selected content item was displayed in the areas gazed upon by the users proximate the first display and the user data submitted by the users proximate the first display relating to the selected content item, the attributes of the users proximate the first display. In some embodiments, the first controller identifies a user detected by the first sensors by matching one of the user entries to the user based on the characteristics stored in the matched user entry, and further wherein the first controller adjusts the first content score of one or more of the content items based on the matched user entry. In some embodiments, the first controller increases the value of the content score of a content item displayed on the first display when the first sensors detect that the one or more users are proximate the first display for a predefined score period while the content item was being displayed. In some embodiments, the first controller decreases the value of the content score of the selected content item upon the display of the selected content item on the first display. In some embodiments, the first controller is configured to wirelessly couple to a mobile device such that the first controller receives one or more commands from the mobile device and transmits one or more of the content items from the first content database to the mobile device based on the commands.

A third aspect is directed to an interactive service and advertising server. The server comprises a memory storing a content database including one or more content items each having a first content score associated with a first interactive device and a second content score associated with a second interactive device and a server controller coupled with the first interactive device, wherein the server controller selects and displays a selected content item having the highest first content score on a first display of the first interactive device for a predefined content period. In some embodiments, the first interactive device comprises one or more first sensors that cause the server controller to select and display the selected content item when the first sensors detect one or more users are proximate the first interactive device. In some embodiments, the server further comprises a user database stored on the memory and including one or more user entries, wherein the first sensors detect one or more characteristics of users that are proximate the first interactive device and the server controller stores the characteristics for each of the users in one of the user entries. In some embodiments, the characteristics are selected from the group consisting of a media access control address of a device of the user, a presence of the user, one or more images of the user, a location of the user relative to the first interactive device, areas of the first interactive device gazed upon by the user and user data submitted by the user on the first interactive device. In some embodiments, the user data submitted by the user on the first interactive device is selected from the group consisting of a sale, a product and a destination. In some embodiments, based on one or more of the characteristics the server controller determines one or more attributes of the corresponding user selected from the group consisting of age, gender, hair color, eye color, clothing color, height, weight and race. In some embodiments, the server controller adjusts the first content score of one or more of the content items based on the characteristics, the attributes or both. In some embodiments, the memory further comprises an analytic database and during the predefined content period the first sensors detect one or more content analytic values that are then associated with the selected content item in the analytic database by the server controller, wherein the content analytic values are selected from the group consisting of a quantity of users proximate the first interactive device, a duration that each of the users proximate the first interactive device is proximate the first interactive device, whether the selected content item was displayed in the areas gazed upon by the users proximate the first interactive device and the user data submitted by the users proximate the first interactive device relating to the selected content item, the attributes of the users proximate the first interactive device. In some embodiments, the server controller identifies a user detected by the first sensors by matching one of the user entries to the user based on the characteristics stored in the matched user entry, and further wherein the server controller adjusts the first content score of one or more of the content items based on the matched user entry. In some embodiments, the second interactive device comprises a second display and one or more second sensors, wherein the server controller selects and displays the content item having the highest second content score on the second display. In some embodiments, the server controller adjusts the second content score of one or more of the content items based on one or more of the characteristics detected by the first sensors and a location of the second interactive device relative to a location of the first interactive device. In some embodiments, the adjustment of the second content score of the one or more of the content items based on one or more of the characteristics detected by the first sensors and the location of the second interactive device relative to the location of the first interactive device is limited to a predetermined walk period whose length is based on the distance between the first and second interactive devices. In some embodiments, the server controller increases the value of the content score of a content item displayed on the first display when the first sensors detect that the one or more users are proximate the first interactive device for a predefined score period while the content item was being displayed. In some embodiments, the server controller decreases the value of the content score of the selected content item upon the display of the selected content item on the first display.

A fourth aspect is directed to a method of providing an interactive service and advertising system. The method comprises scoring one or more content items in a first content database with a first controller such that each of the content items has a first content score, selecting a selected content item of the content items that has the highest first content score with the first controller and displaying the selected content item on a first display of a first interactive device for a predefined content period with the first controller. In some embodiments, the method further comprises detecting when one or more users are proximate the first display with one or more first sensors and initiating the selection and display of the selected content item when the first sensors detect that the one or more users are proximate. In some embodiments, the method further comprises detecting one or more characteristics of users that are proximate the first display with the first sensors and storing the characteristics for each of the users in a separate user entry within a user database. In some embodiments, the characteristics are selected from the group consisting of a media access control address of a device of the user, a presence of the user, one or more images of the user, a location of the user relative to the first interactive device, areas of the first interactive device gazed upon by the user and user data submitted by the user on the first interactive device. In some embodiments, the user data submitted by the user on the first interactive device is selected from the group consisting of a sale, a product and a destination. In some embodiments, the method further comprises based on one or more of the characteristics determining with the first controller one or more attributes of the corresponding user selected from the group consisting of age, gender, hair color, eye color, clothing color, height, weight and race. In some embodiments, the method further comprises adjusting the first content score of one or more of the content items with the first controller based on the characteristics, the attributes or both. In some embodiments, the method further comprises, during the predefined content period, detecting one or more content analytic values with the first sensors and associating the analytic values with the selected content item in an analytic database with the first controller, wherein the content analytic values are selected from the group consisting of a quantity of users proximate the first interactive device, a duration that each of the users proximate the first interactive device is proximate the first interactive device, whether the selected content item was displayed in the areas gazed upon by the users proximate the first interactive device and the user data submitted by the users proximate the first interactive device relating to the selected content item, the attributes of the users proximate the first interactive device. In some embodiments, the method further comprises identifying a user detected by the first sensors with the first controller by matching one of the user entries to the user based on the characteristics stored in the matched user entry, and adjusting the first content score of one or more of the content items with the first controller based on the matched user entry. In some embodiments, the method further comprises storing one or more of the content items in a second content database with a second controller such that each of the content items has a second content score, selecting a content item of the content items having the highest second content score with the second controller and displaying the content item on a second display of a second interactive device with the second controller. In some embodiments, the method further comprises identifying a user detected by the second sensors with the second controller by matching one of the user entries to the user based on the characteristics stored in the matched user entry, and adjusting the second content score of one or more of the content items with the second controller based on the matched user entry. In some embodiments, the method further comprises adjusting the second content score of one or more of the content items with the second controller based on one or more of the characteristics detected by the first sensors and a location of the second interactive device relative to a location of the first interactive device. In some embodiments, the adjustment of the second content score of the one or more of the content items based on one or more of the characteristics detected by the first sensors and the location of the second interactive device relative to the location of the first interactive device is limited to a predetermined walk period whose length is based on the distance between the first and second interactive devices. In some embodiments, the method further comprises increasing the value of the content score of a content item displayed on the first display with the first controller when the first sensors detect that the one or more users are proximate the first interactive device for a predefined score period while the content item was being displayed. In some embodiments, the method further comprises decreasing the value of the content score of the selected content item with the first controller upon the display of the selected content item on the first display. In some embodiments, the method further comprises wirelessly coupling a mobile device with the first controller such that the first controller receives one or more commands from the mobile device and transmits one or more of the content items from the first content database to the mobile device based on the commands.

Other features of the present invention will become apparent from consideration of the following description taken in conjunction with the accompanying drawings.

### BRIEF DESCRIPTION OF THE DRAWINGS

The novel features of the invention are set forth in the appended claims. However, for purposes of explanation, several embodiments of the invention are set forth in the following figures.

FIG. 1 illustrates a block diagram of an interactive service and advertising system according to some embodiments.

FIG. 2 is an illustration showing graphical representation of the system according to some embodiments.

FIG. 3 is a block diagram illustration showing the interaction methods between components of the system according to some embodiments.

FIG. 4 is an illustration showing a graphical representation the system according to some embodiments.

FIG. 5 is an overview illustration showing major components at a distribution of sites, and general relationships between major components, in a coupled system to provide services and advertising to a plurality of sites according to some embodiments.

FIG. 6 is an illustration showing a use case method of a plurality of service and advertising systems at single site from the perspective of four individual users as they move through a site and in viewable range of service and advertising systems according to some embodiments.

FIG. 7 is a sequence diagram illustration showing a method of loading, using advertisement and service data, and logging systems usage in a coupled system for the benefit of end users and suppliers of services and advertisements according to some embodiments.

FIG. 8 is a sequence diagram illustration showing a method of using a mobile device with control application to gain access and become part of a coupled system to provide a user with site services according to some embodiments.

FIG. 9 is an illustration showing database distribution and relation on servers for a single site and on two unique service and advertising systems according to some embodiments.

FIG. 10 is an illustration showing the relation of system and server databases with associated control programs also with interfaces to users, site patrons and beneficiaries according to some embodiments.

FIG. 11 is an illustration showing an isometric exploded view of the interactive mall map system according to some embodiments.

FIG. 12 is an illustration showing a front and left side angular view of the assembled interactive mall map system according to some embodiments.

FIG. 13 is an illustration showing the back and right side angular view of the assembled interactive mall map systems according to some embodiments.

FIG. 14 is an isometric illustration showing an alternate embodiment of the interactive mall map system with a touchscreen display mounted parallel to the front side of the system in landscape orientation according to some embodiments.

FIG. 15 is an isometric illustration showing an alternate embodiment of the interactive mall map system with an interactive touchscreen display mounted parallel to the front side of the system in portrait orientation according to some embodiments.

FIG. 16 is an isometric illustration showing an alternate embodiment of the interactive mall map system with all three sides mounted with touchscreen displays and general displays as well as other components on each of the sides of the system according to some embodiments.

FIG. 17 is a block diagram illustrating electronic components of the interactive mall map system showing general connection and grouping relationships according to some embodiments.

FIG. 18 is a block diagram illustrating the layered construction of the interactive mall map system general operational structure from hardware interface to control program according to some embodiments.

FIG. 19 is a block diagram illustrating system input methods and how they relate to logical control program and database modules used for the operation of the interactive mall map system according to some embodiments.

FIG. 20 is a block diagram illustrating the logical control program and database modules used for the operation of the interactive mall map system and how they relate to system output methods according to some embodiments.

FIG. 21 is a flow chart illustrating the general startup and general user input interaction with the interactive mall map system according to some embodiments.

FIG. 22 is an illustration showing a wireframe layout of the main screen for the interactive mall map system showing the location and components of the content to be displayed according to some embodiments.

FIG. 23 is an illustration showing a wireframe layout of the main screen with example display elements for interactive mall map system according to some embodiments.

FIG. 24 is an illustration showing a wireframe layout of the interactive mall map system screen in an alternate view to display information and respond to user selections according to some embodiments.

FIG. 25 is an illustration showing a wireframe layout of the interactive mall map system screen in an alternate view showing more display frame elements to show site related information and respond to user selections according to some embodiments.

FIG. 26 is a collection of illustrations showing selectable display elements which can be shown in the frame outline elements according to some embodiments.

FIG. 27 is an illustration showing a wireframe layout of the interactive mall map system screen in an alternate view showing a layout for a user search and resultant display according to some embodiments.

FIG. 28 is a sequence diagram illustration showing a method of user detection and touchscreen selection for the interactive mall map system according to some embodiments.

FIG. 29 is an illustration of a front isometric exploded view of the advertisement display system according to some embodiments.

FIG. 30 is an assembled front isometric view of advertisement display system according to some embodiments.

FIG. 31 is an assembled back view of advertisement display system according to some embodiments.

FIG. 32 is an illustration of an alternate advertisement display system which uses two display panels and is shown as an exploded isometric view according to some embodiments.

FIG. 33 is a block diagram showing electronic components of the advertisement display system showing general connection and grouping relationships according to some embodiments.

FIG. 34 is a block diagram illustrating the layered construction of the advertisement display system general operational structure from hardware interface to logical control program according to some embodiments.

FIG. 35 is a block diagram illustrating system input methods and how they relate to functional blocks of the logical control program and database modules used for the operation of the advertisement display system according to some embodiments.

FIG. 36 is a block diagram illustrating the logical control program and database modules used for the operation of the advertisement display system and how they relate to system output methods according to some embodiments.

FIG. 37 is a flow chart illustrating the basic function of the advertisement display system for the display of advertisements on the system according to some embodiments.

FIG. 38 is an illustration of a basic screen wireframe layout with a small set of frames for the display of multimedia advertisements and site of installation information according to some embodiments.

FIG. 39 is an illustration of a basic screen wireframe layout with additional frames for the display of multimedia advertisements and site of installation information for the advertisement display system according to some embodiments.

FIG. 40 is a sequence diagram illustration showing a method of shopper detection and advertisement display for the advertisement display system in a general sequence according to some embodiments.

FIG. 41 is a block diagram illustrating a layered construction and general operational structure from hardware interface to logical control application for a mobile device with installed application according to some embodiments.

FIG. 42 is a block diagram illustrating system input methods and how they relate to functional blocks of the logical control application and remote database modules used for the operation of a mobile device with the mall map mobile application installed according to some embodiments.

FIG. 43 is a block diagram illustrating the logical control application modules used for the operation of the mobile device with mall map mobile application and how they relate to system output methods according to some embodiments.

FIG. 44 is a sequence diagram illustration showing a method of user interaction with the host company server outside of a site with the host company systems, using a mobile device with an application installed which allows access to the host company mobile server databases according to some embodiments.

FIG. 45 is a flow chart illustrating sequential general startup and general user input interaction with a mobile device using the host company mobile application to access data from the host company systems located at a site of use of the mobile device according to some embodiments.

FIG. 46 is an extension of FIG. 45 and is a flow chart illustrating a method of getting and processing input from a user with a mobile device using a host company application to access data from the host company systems located at the site of use of the mobile device according to some embodiments.

FIG. 47 is an illustration showing a wireframe layout of the main screen on a mobile device using a mobile control application showing the location and components of the content to be displayed according to some embodiments.

FIG. 48 is an illustration showing an alternate wireframe layout of the main screen on a mobile device using a mobile control application showing the location and components of the content to be displayed according to some embodiments.

FIG. 49 is an illustration showing a wireframe layout for a main display screen of the mobile control application on a mobile device display with additional details of possible display elements according to some embodiments.

FIG. 50 is a collection of illustrations showing selectable display elements which can be shown in the display area of a mobile device with the mobile control application installed according to some embodiments.

FIG. 51 is an illustration showing a wireframe layout of two frames showing one possible display layout in a tree structure according to some embodiments.

FIG. 52 is a block diagram illustrating the layered construction of a server with general operational structure from hardware interface to control program and databases for the operation of the server in a coupled system according to some embodiments.

FIG. 53 is a block diagram illustrating system input and output methods and how they relate to functional blocks of the server control program and server database modules used for the operation of the server in a coupled system according to some embodiments.

### DETAILED DESCRIPTION

In the following description, numerous details and alternatives are set forth for the purpose of explanation. However, one of ordinary skill in the art will realize that the invention can be practiced without the use of these specific details. In other instances, well-known structures and devices are shown in block diagram form in order not to obscure the description of the invention with unnecessary detail.

The interactive service and advertising system, method and device described herein comprises one or more systems and a data network that are used to provide services which in turn are used to collect information about users and user's preferences at a site area to adapt digital multimedia advertising content at that site. User's characteristics, attributes and/or preferences at a site area are compiled from selections made by users on systems with fixed or mobile terminals located at the site and which provide services to the users relating to the site area. The selections are used to automatically adjust digital multimedia advertisement at the site and at specific systems with displays at the site which are in the proximity or viewable range of the user or along an approximate path that the user may take at the site. As a result, the system provides the benefit of dynamic advertisements, maps and other data presented based on sensed or inputted user input collected in real time as well as stored and analyzed in an analytics database.

### Device Overview

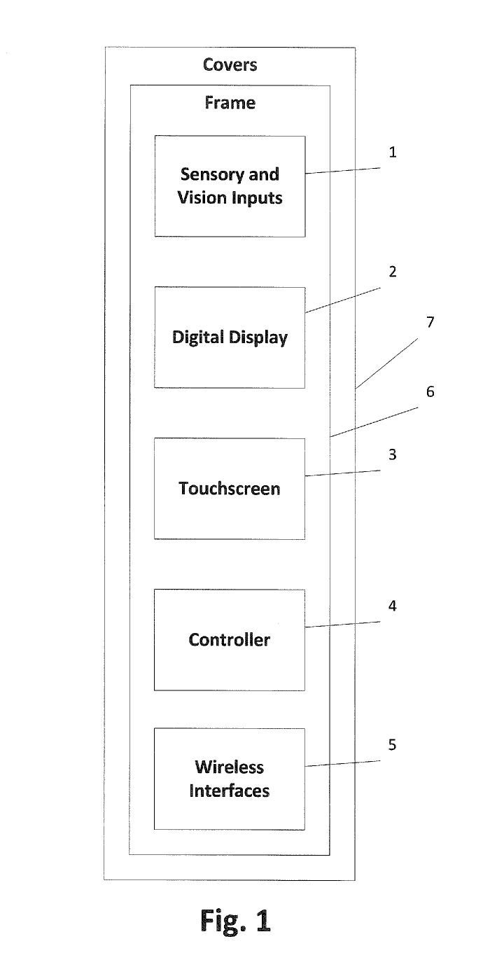

FIG. 1 illustrates a block diagram of a system for an interactive service and advertising device according to some embodiments. As shown in FIG. 1, the system comprises a sensory and vision input module 1, a digital display module 2, a touchscreen module 3, a controller module 4, a wireless interface module 5, a frame module 6 and a cover module 7. The system is able to comprise more or less modules as desired. For example, in some embodiments a system is able to omit the touchscreen module 3 such that it is limited to the digital display module 2 for displaying data and the wireless interface module 5 for inputted data from a user.

The sensory and vision input module 1 is able to detect the status and actions of surrounding objects in line of sight and proximity of the system. As used herein, proximity is able to be defined as a distance between zero (e.g where a user would be touching the system) to a maximum detection range of one or more sensors of the module 1 (e.g. a distance of thirty feet). The objects detected are able to include people (using or not using the system), static displays, columns, floors, ceilings, tables, carts, buggies, strollers, and any other objects. The sensory and vision input module 1 is able to comprise one or more of cameras, ultrasonic sensors, passive infrared sensors and/or infrared cameras. The sensory and vision input module 1 is also able to include active infrared sensors such as reflective type IR sensors. The camera or cameras can be used to detect the visual surroundings and determine if people are present and how many, their location relative to the system and if they are viewing the system. For example, whether a user is viewing the system is able to be determined by detecting the outline of part or all of a person and common facial features such as eyes. Detection of clothing color or other distinguishing features can also be captured by the cameras. Furthermore, personal characteristics such as gender, age, or race can be determined based on the captured video. For example, one or more of the frames of the video are able to be analyzed (in real-time or near real-time) for any or all of previously stated characteristics, wherein the determined characteristics are able to then be stored and/or transmitted to one or more desired locations (e.g. databases) and/or used for further processing.

In some embodiments, one or more of the frames are able to be used as a reference to determine and/or remove static objects from the field of view when determining/detecting non-static objects. In some embodiments, the sensory and vision input module 1 comprises one or more ultrasonic sensors to detect the presence of a person in close proximity of the system. In some embodiments, the passive infrared sensors are able to be used to detect the presence or lack of presence of people in a wide area of view. Further, the IR sensors are able to be used for detection of the presence or lack of presence of a person in narrow fields of view by restricting the angle of view of the sensor and/or using multiple sensors to view a set area. In some embodiments, one or more passive infrared cameras are able to be used to detect the presence or motion of non-static objects in the field of view. Additionally, the one or more active reflective infrared sensors are able to be used for the detection of objects in a set area or field of view.

The digital display module 2 is able to comprise a video display (e.g. a television or monitor) and includes all control components to generate an image from input signals. As a result, the system is able to use the video display to present static and/or dynamic visual images such as static advertisements, multimedia advertisements, maps, text messages and/or notices relating to the installation location area. In some embodiments, the digital display module 2 is configured to display one or more of the video data in a timed loop. For example, the loop is able to be triggered by time of day, inputs to the system from modules 1, 3, and/or 5, and/or a combination any of these triggers or events.

The touchscreen module 3 comprises one or more video displays each having a transparent or near transparent overlay capable of detecting human touch. Furthermore, all control components required to generate an image from video or data input signals and control components to interpret and report signals from the touchscreen are included. The touchscreen is able to be projective capacitive, capacitive, resistive, surface acoustic wave, surface capacitive, infrared, optical, or any other types touchscreen technologies. As a result, the touchscreen module 3 enables users to input of information to the system. Selections made on the touchscreen module 3 which are aligned with the underlying image on the display are used to determine the input requests from the user and the underlying image is able to be updated by the touchscreen module 3 in response to the selection/input of the user. Similar to the digital display module 2, the touchscreen module 3 is able to be used to show static and/or dynamic images such as maps (e.g. store, mall, street), a directory of stores, products, sales, events, services, general descriptions, reviews, current sales, coupons, web addresses phone numbers and/or other information.

Further, all or some of the images displayed by the module 3 are able to have corresponding audio signals and/or programs. For example, the displayed images and/or audio on the touchscreen module 3 are able to comprise a graphical user interface for one or more applications such that by interacting with the touchscreen module 3, the users are able to access and manipulate the functions of the program via the graphical user interface. In some embodiments, one or more of the image displayed via the digital display module 2 are similarly associated with audio signals and/or programs such that by interacting with the touchscreen module 3 users are able to access and manipulate the functions of the program/graphical user interface displayed on the digital display module 2.

The controller module 4 is the central controller of the system and is able to comprise a PC motherboard or other similar master control PCB with related components such as CPU, RAM, video and data connections, and hard drive or drives, power distribution, and power supplies. All system electronic and data related components are coupled to or integrated into the controller module 4. Software such an operating system such as Windows or Linux variant is executed by the controller module 4. Furthermore, a master software control program is executed on the controller module 4 to manage displayed images on display modules 2 and 4, and interpret input signals from sensors and vision input module 1 as well as wireless interface module 5. The controller module 4 and associated master software control program with any required support software to display images, read physical inputs, read data inputs, and write data outputs, together contain the logic and is used make decisions on the actions of the system including but not limited to what images to display or data to write out on a data network or data connection. For example, the controller module 4 outputs one or more video and/or audio signals to the display module 2 and the touchscreen module 3, inputs data (e.g. user input via the touchscreen module 3, sensor data via the sensory module 1 and/or data received via the wireless interface module 5) and adjust the one or more video and/or audio signals output to the display module 2 and the touchscreen module 3 based on the input. This enables the system to provide interactive maps, advertisements and other images to a user.

The wireless interface module 5 is able to comprise a wired and/or wireless data input/output interface that is able to receive and transmit data with other processing elements, such as a host network, and/or databases over one or more networks (e.g. Ethernet, Bluetooth or other cellular and/or packet data networks). In some embodiments, the wireless interface module 5 is able to comprise radio frequency input/output interfaces configured to detect active and/or passive radio frequency devices such as RFID tags or indoor positioning beacons. Still further, the wireless interface module 5 is able to comprise visual input/output interfaces configured to communicate to devices in proximity of the system to output information such as QR codes, bar codes or other related optical output communications methods. In operation, the wireless interface module 5 is able to communicate with the host network to access remote servers to receive and transmit digital data. For example, some or all of the data input via the sensory and vision input module 1 and/or the touchscreen module 3 is able to be stored in a database associated with the host network for access and/or processing. In the same manner, data from outside sources is able to be downloaded/uploaded to the system via the host network and used to adjust the operation of the system. Similarly, the wireless interface module 5 is able to communicated with one or more mobile devices (e.g. smart phones, tablets, laptops, or other computing devices) that are able to couple to the host network to provides information to and receive input from the devices. For example, the module 5 is able to transmit one or more of the video and/or audio data to coupled devices and/or receive user input via the devices such that a user is able to interact with the system via the devices in substantially the same manner as they would interact with the touchscreen module 3.

The frame module 6 comprises all the components required to physically support and arrange the modules 1-5. For example, the frame module 6 is able to comprise a frame structure that positions the displays of modules 2 and 3 at easily viewable level for an average person and to position the touchscreen display of module 3 at a level and angle for an average person to comfortably touch and comply with common height requirements for the area of installation. In some embodiments, the frame structure is able to be adjustable such that the positions of the displays and/or touchscreens are able to be adjusted as desired. The frame module 6 is also able to be configured to attach to one or more covers of the cover module 7. The cover module 7 is able to comprise one or more shields or covers that surround and/or further support the system to protect users from contact with the components of modules 1-5 which can be damaged by human contact. The shields are able to be constructed of one or a combination of metal, plastics or other materials. In some embodiments, the shields are able to comprise air flow to prevent overheating of the contained components.

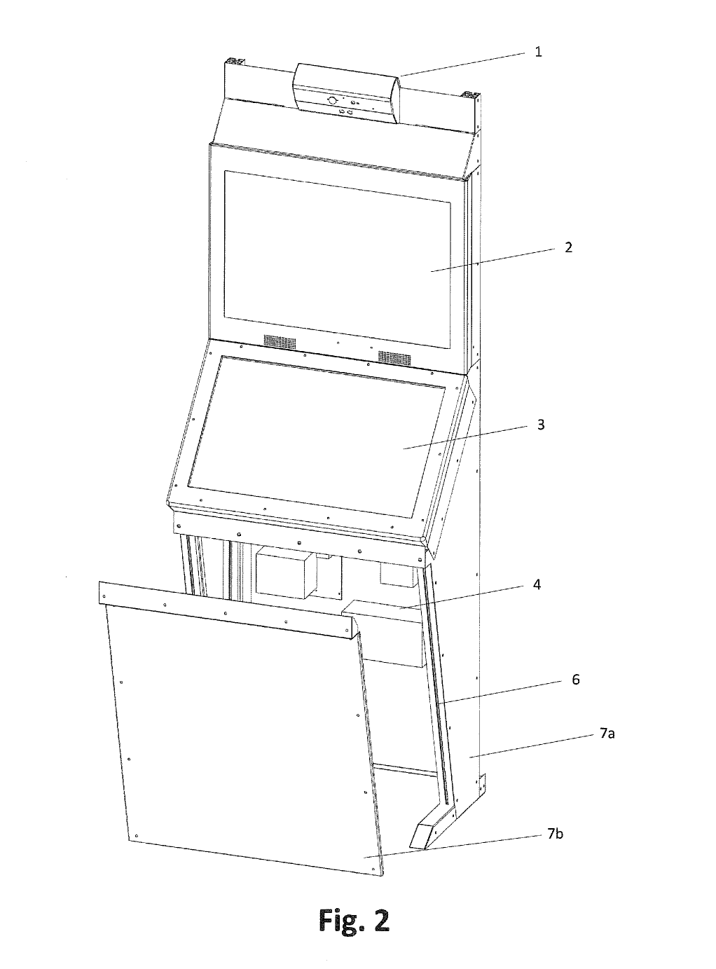

FIG. 2 illustrates a perspective view of an interactive service and advertising system according to some embodiments. Covers 7a, 7b are coupled to the sides of the frame 6 to shield the internal components. In some embodiments, a front cover 7b is configured to be selectively removable from the frame 6 in order to provide access to the internal components. Shapes and sizes of covers 7 and frame 6 can change to accommodate different sizes and orientation of displays 2 and 3 as well as and can include one or more apertures for sound to exit the covers 7. As shown in FIG. 2, the frame 6 comprises legs to support the system. Alternatively, the legs are able to be omitted and/or the frame 6 is able to be mounted onto or into a wall. Sensor and vision module 1 illustrated in FIG. 2 are shown contained in one area of inside one cover 7 but can be placed in different and separate location. If two or more vision cameras are used, one can be located high on the system as shown for large field of view with the second in a lower position or aimed in a different angle to put a system user's face in view. Wireless interfaces 5 are not shown in FIG. 2 as they are typically integrated into the controller 4.

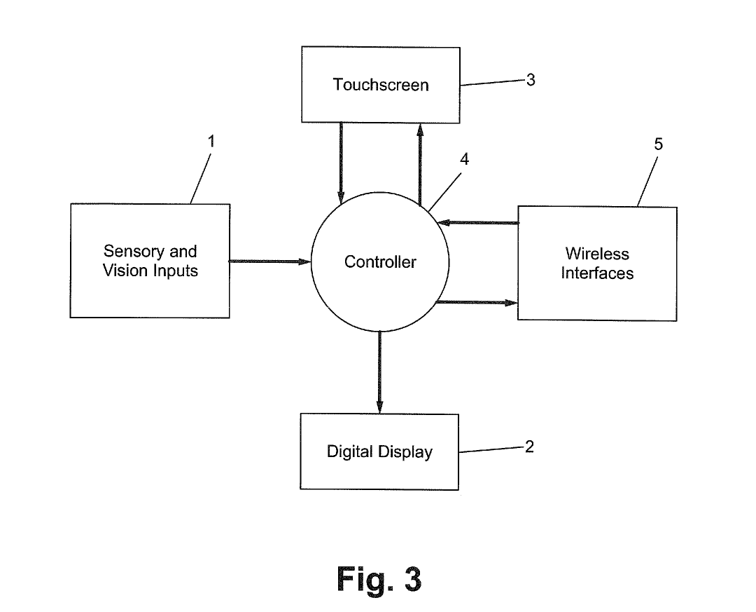

FIG. 3 is a block diagram illustration showing the interaction methods between the modules 1-5 described in FIGS. 1 and 2. As shown in FIG. 3, the touchscreen module 3 is coupled to the controller 4 such that the controller is able to read the selections or touches from a user of the touchscreen 3 and produce a logical response based on the master software executing on the controller 4. This logical response output can be sent back to touchscreen 3 which in order to update the image on the touschscreen 3. Additionally, the response or a second response is able to be transmitted to digital display module 2 to update an image or multimedia display on the digital display 2. For example, when user selects a store or product listing on touchscreen 3, the controller 4 inputs the selection and updates the touchscreen 3 and/or display 2 to display an advertisement relating to that store or product of selection. In some embodiments, the output signal is able to comprise audio data to adjust the audio produced by the touchscreen 3 and/or display 2. The sensory and vision input module 1 is also coupled to the controller 4 such that the sensors and cameras of the module 1 are able to connect and send data to controller 4. The controller 4 is then able to store, process and/or transmit the data in addition to using the master control software to perform logical operations based on the status of the sensors.

For example, upon detection of a person in detection range of a passive IR sensor from module 1, the controller 4 and the logic of the master control software is able to signal digital display 2 and touchscreen 3 to automatically turn on if in a powered off or standby state. As another example, upon visually detection of a user of the system, the logic of the master control software is able to analyze the video input and determine the gender of the user. Based on this determination, the controller 4 is able to cause the touchscreen 3 and/or display 2 to display data (e.g. advertisement video and/or audio) related to the gender of the user. The wireless interface module 5 is also coupled to the controller 4. As a result, the controller 4 is able to utilize the module 5 to send and receive serial data between any radio frequency modules or antennas from the system to a host wireless network or any mobile device in RF range of the RF communications technology used by the system as well as fixed RF devices. For example, the controller 4 is able to download updated software with updated content and operational data for the area of installation. Similarly, the controller 4 is able to cause the module 5 to provide data relating to the use of the system to the host system or other locations for storage and/or analysis.

Additionally, in some embodiments the controller 4 is able to cause the wireless interface module 5 to transmit display data that is shown on displays 2 (and/or touchscreen 3) to a mobile wireless device. In the same manner, the controller is able to receive commands and/or messages from coupled mobile wireless devices via the wireless interface module 5, update the data presented by the display 2 (and/or touchscreen 3) and/or transmit a response back to the mobile device based on the commands/messages. For example, a person with wireless enabled mobile device in proximity and wirelessly connected to the system, is able to make a request to the system for information, such as location, relating to a store in the mall of installation of the system. The controller 4 via the interface module 5 is able to respond with information, such as directions, to the user's mobile device and update digital display 2 with an advertisement relating to the store. Alternatively, a wirelessly enabled mobile device can be connected to the system through a close distance RF wireless connection through wireless interface 5 and display 2 and updated to show a large view of information relating to the request from the mobile device. For example, a mobile user is able to request information from the system through a close distance wireless connection and sensory and vision inputs 1 could be used to verify the presences of the user and display 2 could update with display information which would otherwise not be clearly visible on the mobile users devices screen. Information such as a mall map and current location and destination location within a mall could be requested and not are easily visible on the mobile users screen but could be displayed clearly on the large display of digital display 2.

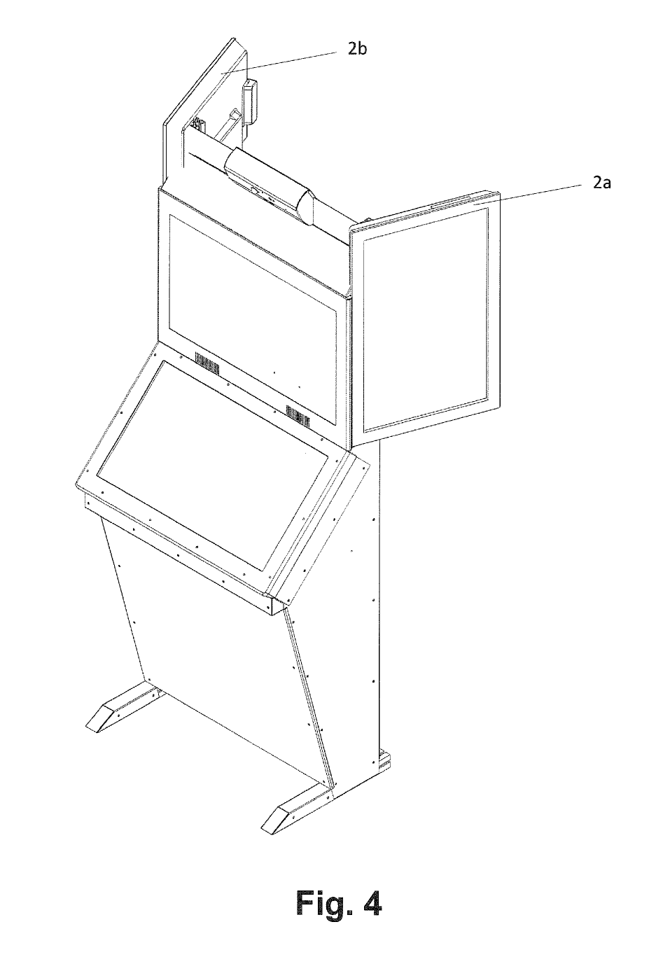

FIG. 4 is illustrates a perspective view of an interactive service and advertising system according to some embodiments. The system as shown in FIG. 4 is substantially similar to the system of FIG. 2 except for the differences described herein. Specifically, as shown in FIG. 4 the display module 2 is able to comprise one or more additional displays 2a and 2b. These additional displays 2a, 2b are able to show advertisements that are the same or different from the other digital displays 2. The displays 2a, 2b are able to be used for large format display of information with control inputs for selection of information shown on the displays coming from a user's mobile device. In some embodiments, the system is able to comprise a sensory and vision module 1 for each display 2. For example, a set of sensors of the module 1 is able to be positioned adjacent to each display screen to provide addition analytical data relating to the users of that display. Additionally, the adjacent sensors are able to be used as a method of confirming the user's mobile device which is controlling the display is located in front of the display 2.

### Interactive Service and Advertising Network

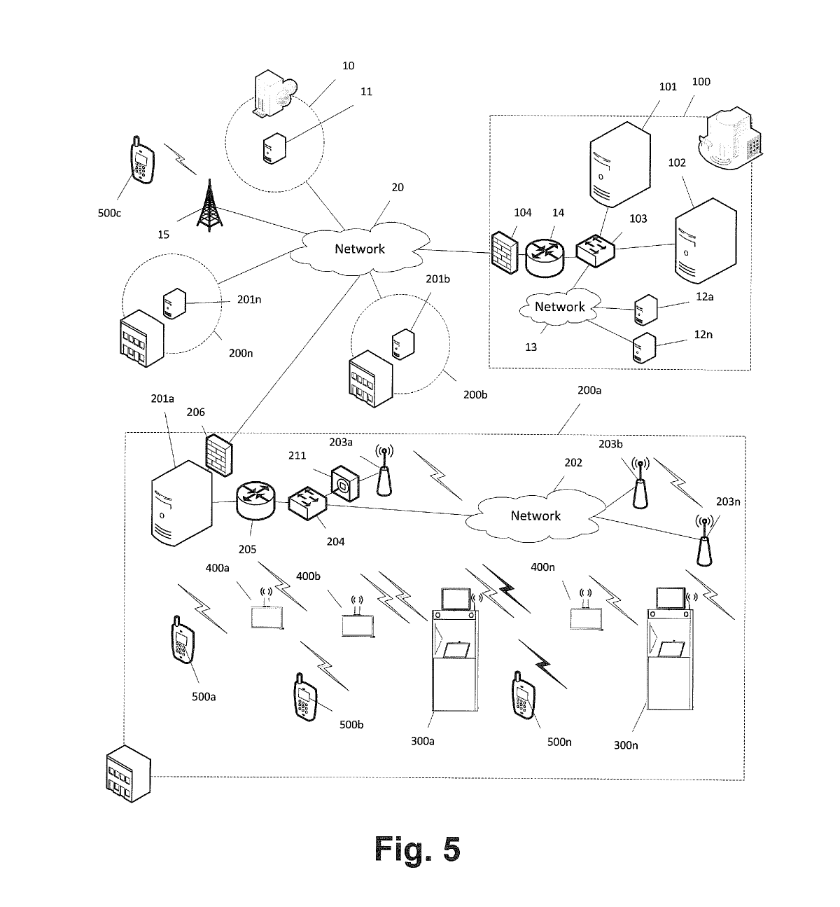

FIG. 5 illustrates a network of an interactive service and advertising system according to some embodiments. As shown in FIG. 5, the host site 100 comprises a server and database 101 that receives, manages, stores and distributes advertising and service content in the form of multimedia such as text, pictures, video and audio as well as URL links from entities such as a host company, marketing and brand firms, stores, malls, manufacturers or individuals. Host server and database 101 also receives, manages and stores system data such as use data from all systems installed at remote sites. Server and database 101 services permanently installed systems. Server and database 102 can be located at a host company designated site and receives request from mobile devices such as smart phones over a wide area network, such as the internet, with an application installed on the mobile device that identifies itself as having rights to access data from the server 102. Server 102 provides service data and advertising content based on request from a mobile device. As an alternate embodiment, servers 101 and 102 can be combined to as a single server or operated as virtual servers on one more physical servers providing the same services and advertising contents.

Host data network 13 can couple servers 101 and 102 to a wide area network 20, such as the internet, to a plurality of sites where service and advertising systems are installed and are shown as 200a, 200b, and 200n as well as possibly a remote backup site 10 with a backup server and databases 11. Host data network firewall 104 can be used to protect the host data network 13 from unwanted access. Router 14 and switch 103 can be considered part of the host data network but is shown separate for clarity and are used to manage access for servers 101 and 102 as well as other host computers 12a and 12n.

A plurality of sites 200a, 200b, 200n located in geographically different locations is shown coupled to a wide are data network 20 which can be the internet. Each site has a site server 201a, 201b, 201n for each site 200a, 200b, 200n respectively, which comprises a site specific database and acts as the gateway for the site systems to the external wide area network 20. Site 200a shows more detail of what each site can comprise in regards to systems as well as component that would be used to provide a data connection between the site server 201a and systems 300a, 300n, 400a, 400b,400n,500a,500b, and 500n. Firewall 206 can be used to protect the data network from unwanted access to the sites data network. Data network 202 can be any local or wide area data network. In one embodiment, this can be an Ethernet network comprised of both wired and wireless network or networks. The wireless network is able to comprise of network nodes on the interactive mall map systems 300 and advertisement display systems 400 and can function as a wireless mesh network if access to wired Ethernet connections are not available in every system installation location.

Wired connections can be managed by a network router 205 and a network switch 204 that couple the data network 202 to the site server. A plurality of wireless nodes 203a, 203b, and 203n are distributed throughout the site to provide wireless access coverage to the site and can extend data network 20 to the entire site. Wireless data network traffic and security can be managed by wireless LAN controller 211. Network router 205 and network switch 204 can comprise of more than one router or switch depending on the size of the site data network in other embodiments of the site layout described. Network router 205, a network switch 204, and wireless controller 211, as well as wireless data network nodes 203a, 203b, 203n can be considered as part of data network 202 but are shown as separate components for clarity. In one embodiment site server 201a, firewall 206, router 205, wireless controller 211, and switch 204 are located in a secure location at site 200 with access limited to approved site employees and host company employees. In an alternate embodiment, site server 201a, firewall 206, router 205, wireless controller 211, and switch 204 can be located in system 300a if system 300a has access to a wired broadband data connection to network 20.

Device systems 300a, 300n, 400a, 400b, 400n, 500a, 500b, and 500n are systems that will interface with end users, which can be but is not limited to shoppers, to provide services and advertising to users. Systems 300a and 300n can be described as interactive mall map systems and will be referred to as this herein. In one embodiment, the interactive mall map systems provide information to shoppers that are currently being provided by a print mall map and print directories common in shopping malls. In addition to providing information that are common in print mall maps, systems 300a, and 300n are able to provide significantly enhanced services and advertising capabilities. The interactive mall map systems such as 300a can comprise a copy of the database of service data and advertising content from site server 201a. Although systems 300a and 300n in FIG. 5 are shown as a plurality of systems at the site, a single system installed at a site can perform the same functions as a larger number of systems but at reduced accessibility for users at the site.

Systems 400a, 400b, and 400n can be described as advertising display systems and will be referred to herein. In one embodiment, advertisement display systems are intended to provide advertising targeted at patrons of a site such as shoppers at shopping malls. Advertisement display systems such as 400a would comprise a copy of the database of service data and advertising content from site server 201a. Although systems 400a, 400b, and 400n in FIG. 5 are shown as a plurality of systems at a site, a single system is contemplated. In one embodiment, a site 200a is able to comprise more advertisement display systems 400n than interactive mall map systems 300n. Furthermore, the advertisement display systems 400n and interactive mall map systems 300n at a site 200a are able to supplement the wireless data network nodes 203n to provide wireless data network coverage for the site 200a thereby reducing the number of wireless data network nodes that can be installed in the site. Another aspect of providing data network access nodes on systems with site databases such as the interactive mall map system 300a and advertisement display system 400a, are service and advertising data can quickly be transmitted to a mobile device such as 500a in coupling range of the systems.

Systems 500a, 500b, 500c and 500n are mobile devices such as smart phone, tablet computers, laptop computers or other computing devices. In some embodiments, the mobile device is a smart phone with a control application installed to use hardware features of the mobile device to couple to a site data network 202 through a wireless data network node such as 203a or an advertisement display systems such as 400a or an interactive mall map systems such as 300a. Once coupled, the mobile device with the control application installed such as 500a can access service data and advertising content from the site server and database such as 201a or interactive mall map and database such as 300a and advertisement display system and database such as 400a. After connection is made between a mobile device such as 500a and a site database located on a site server or system, service data and advertising content will be accessible to the mobile device user through the control application installed on the mobile device using the mobile device's hardware.

System 500c is a mobile device that is not located in a site serviced by a site server such as 201a, 201b, of 201n or a site data network such as 202 for site 201a. To gain access to service data and advertising content can couple to a wireless data node 15. The wireless data network node 15 can be a cell tower or a wireless data network node other than a site data network, such as 202, that couples to a wide area network shown as data network 20. A control application installed on mobile device 500c is able to use hardware features of the mobile device to couple to the wireless data network node 15 through a wide area network 20 and finally to the mobile server and database 102. After connection is made between a mobile device 500c and the mobile server and database 102, service data and advertising content is able to be accessible to the mobile device user through the control application installed on the mobile device using the mobile device's hardware.

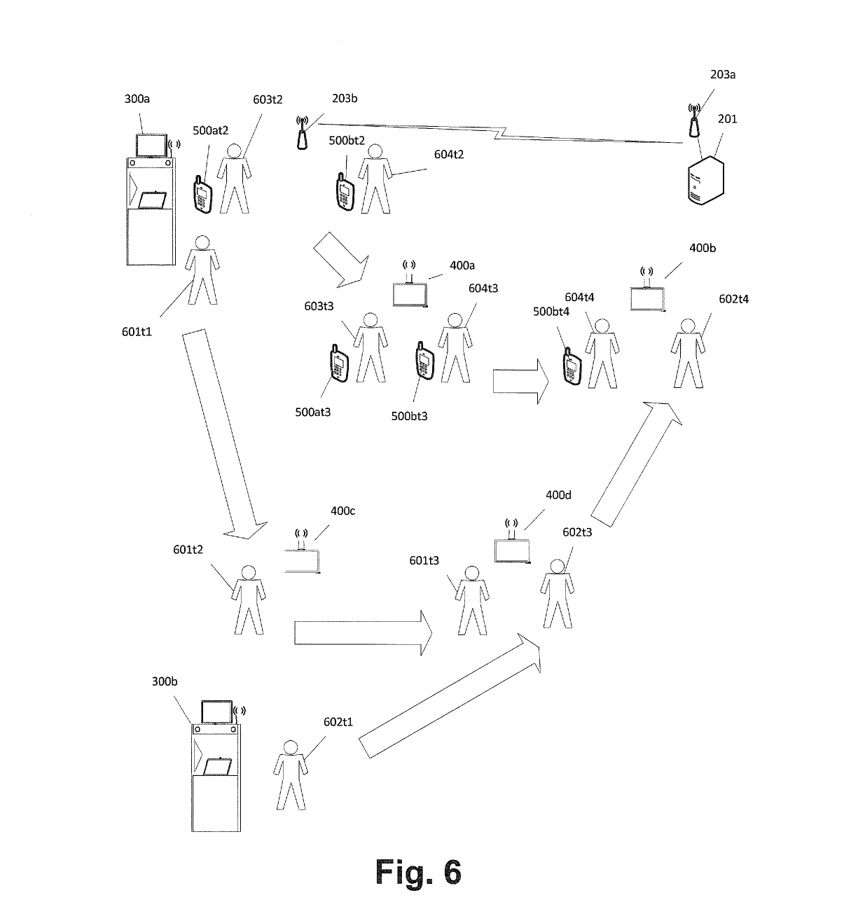

FIG. 6 is an illustration showing methods of use of the interactive mall map system shown as interactive mall map system shown as 300a and 300b, the advertisement display system shown as systems 400a, 400b, 400c, and 400d as well as the control application operating on a mobile devices shown as 500a and 500b at a site according to some embodiments. Site server 201 and wireless data network connection nodes 203a and 203b are also show. The methods described for FIG. 6 demonstrates the abilities of the interactive service and advertising system at a site, such as site 200a in FIG. 5, to provide highly relevant advertising to users by way of the individual networked systems. Users of the interactive mall map system 300a and 300b, advertisement display system systems 400a, 400b, 400c, and 400d and mobile device with control application system 500a and 500b, which are shoppers in some embodiments, are shown in FIG. 6 as 601, 602, 603, and 604. The suffix designator shown as t1, t2, t3 and t4 are used differentiate users 601, 602, 603 and 604 as well as systems 500a and 500b at different locations in the site at different points in time but are the same user or system. Although as described in FIG. 6 each of the systems (e.g. 300a-b, 400a-d) individually adjust advertisement scores and/or other data stored in the databases, it is contemplated that one or more centralized servers (e.g. site server 201) are able to perform/initiate one or more of the described operations in order to control the systems.

User 1 601t1 is shown using the interactive mall map system 300a at a site such as a shopping mall. User 1 601t1 uses the interactive mall map system 300a to get service information such as store information at the shopping mall site, product information, event information for the shopping mall site, mall site facilities information, or directions to stores or products at the shopping mall site. Store information can include products sold, hours of operation, phone numbers, sales and specials or any other information that a store can wish to promote or provide to a shopper. In a more specific scenario, User 1 601t1 uses the interactive mall map system 300a to get a location to a store in a shopping mall site. Once the user has completed a selection for the store location, the interactive mall map system 300a increases the advertisement score for advertisements relating to the selected store on system 300a. Furthermore, the advertisement scores for the selected store advertisements are increased on the advertisement display systems 400c and 400d along paths that can be taken from system 300a to the destination selected store in a time delayed sequence. As a result, the advertisement scores for the selected store advertisements are able to be increased in a way which approximates the user's viewable range to each advertisement display system 400c and 400d such that they are displayed when the user is predicted to be in the viewable range based on the location of the display and the movement of the user.

Advertisement score is a method in one embodiment which increases the chance of an advertisement being shown in relation to all advertisement in a database of advertisements on a system such as 300a and 400a. In the scenario given in this paragraph the increased score would increase the chance of advertisements relating to the selected store be shown thereby increase advertisement relevance to the user. The advertisement score is a component of the ad score algorithm. The ad score algorithm manages some aspects of the advertisement score such as the amount to adjust each specific advertisement's score, manages score arbitration, and determines which specific systems at a site is able to have a specific advertisement scores adjusted. Score is able to be used in this disclosure as a definition of a ranking of how likely an advertisement is able to be shown over other advertisements. The method in which an approximation can be made for the user's viewable range to an advertisement display system such as 400c in one embodiment can be by walk time estimates or walk time estimates coupled with sensor input such as a camera identifying clothing color or personal distinguishing features.

User 1 601t2 is shown at a point in time after the user has moved to a different location in the mall site away from system 300a and in viewable ranges, of advertisement display system 400c. At this point the approximations made for the time delayed sequence of increasing the selected store advertisements would have increased and would be showing advertisements relating to the selected store on system 400c at the point in time when User 1 601t2 passes within viewable range. Within the time frame of User 1 601t1 moving from system 300a to system 400c User 2 602t1 uses the interactive mall map system 300b to get the location of a different store from which was selected by User 1 601t1 at the mall site. The same process as described with User 1 601t1 and 601t2 occurs for User 2 602t1 and 602t3 with the exception of the mall map system used, which results in the increase of the score of advertisements for the selected store by User 2 602t1 on system 300b and on the advertisement display system 400d and 400b along possible paths to User 2's 602t1 selected store.

User 2 602t3 is shown at a point in time after User 2 602t1 has moved away from system 300b and in viewable range of advertisement display system 400d which can be the same point in time in which User 1 601t3 has moved to viewable range system 400d. Scores for selected store advertisements from Users 1 601t3 and User 2's 602t3 selected stores are able to both be increased at the same level based on the same type of selections made by both users as well as approximations made when the users would be at system 400d. Score arbitration can be used to determine which advertisements for the selected stores would be shown first. Arbitration of score can be accomplished in many ways, but one method involves including more attributes of the advertisements which can include but not limited to length of advertisement display time, store relationship with host company, predetermined bidding or payment to raise score, number of other same store selection that has occurred in select time period, or number of advertisements or products available from a selected store. Once an advertisement with the higher score is shown on a system, that advertisement is able to have its score decreased thereby increasing the chance of the second selected advertisement, which also had a high score, to be shown. In the scenario of User 1 601t3 and User 2 602t3 converging on system 400d at the same time, if the score arbitration resulted in an advertisement being shown for User 1's 601t3 selected store, the advertisement for User 2's 602t3 is able to have a high probability of being shown immediately afterward. This method increases the advertisement relevance for both users.

Continuing with FIG. 6 with User 3 603t2 who is carrying a mobile device 500at2, with wireless network capabilities enabled, uses system 300a to get service information such as store information at the shopping mall site, product information, event information for the shopping mall site, mall site facilities information or direction to store or product at the shopping mall site. In this scenario User 3 603t2 uses system 300a to get a location to a store in the shopping mall site. The store selection made can be linked to a wireless unique identifier such as MAC address of the mobile devices 500at2 wireless Ethernet or Bluetooth interfaces. Advertisements for the selected store are able to be increased in score to increase the chance of display of the selected store advertisement on system 300a as was done earlier with User 1 601t1. Since User 3 603t2 has a mobile device 500at2 that has an enabled method of identifying the user as the user moves through the site no approximation methods can be needed to determine if the user is in viewable range of advertisement display system 400a. When User 3 603t3 is in viewable range of system 400a the score for the advertisement for the store selected on system 300a earlier is able to increase when mobile device 500at3 is in proximity of system 400a that is able to be considered viewable range. The increased score when a user is in viewable range greatly increases the probability of an advertisement being shown for the selected store or interest thereby greatly increases advertisement relevance.

User 4 604t2 who is carrying mobile device 500bt2, with wireless network capabilities enabled and a mall map control application installed enters the site and uses the control application. When User 4 604t2 starts the mobile application on mobile device system 500bt2, the device is able to couple to the local data network and present the user with selections and services similar to the ones that are able to be available on an interactive mall map system such as systems 300a or 300b. User 4 604t2 uses mobile device system 500bt2 to get service information such as store information at the shopping mall site, product information, event information for the shopping mall site, mall site facilities information or direction to store or product at the shopping mall site. In this scenario User 4 604t2 uses mobile device system 500bt2 to get a location to a store in a shopping mall site. The store selection made can be linked to a wireless unique identifier such as MAC address of the mobile device system 500bt2 wireless Ethernet or Bluetooth interfaces. When User 4 604t3 is in viewable range of system 400a the score for an advertisement for the store selected earlier on mobile device system 500bt2 is able to increase when mobile device system 500bt3 is in proximity of system 400a that is able to be considered viewable range.

If mobile device systems 500at3 and 500bt3 move in proximity of system 400a at the same time, score arbitration can be used to determine which advertisements for the selected stores are able to be shown first. Arbitration of score can be accomplished in many ways but one method involves including more attributes of the advertisements which can include but is not limited to length of advertisement display time, store relationship with host company, predetermined bidding or payment to raise score, number of other same store selection that has occurred in select time period, or number of advertisements or products available from a selected store. Once an advertisement with the highest score is shown on a system, that advertisement is able to have its score decreased thereby increasing the chance of the second selected advertisement to be shown. If mobile device system 500at3 move in proximity of system 400a shortly before mobile device system 500bt3, the advertisement associated with system 500at3 is able to have a higher probability of being shown first as its score was raised first and the advertisement is able to already be the in process of being displayed when mobile device system 500bt3 moves in proximity. After the advertisement associated with mobile device system 500at3 completes, the advertisement associated with 500bt3 is able to have a high probability of starting next.

If User 4 604t4 and mobile device system 500bt4 move in proximity of system 400b at the same time as User 2 602t4, score arbitration can be used to determine which advertisements for the selected stores are able to be shown first. In this scenario, since one user has mobile device system 500bt4 carried with them, mobile device system 500bt4 is a more definitive method of determining User 4's 604t4 proximity to system 400b than User 2 602t4. Therefore, User 4 604t4 is able to have a higher probability of having the advertisement associated with mobile device system 500bt4 shown before the advertisement associated with User 2 602t4. Once an advertisement with the highest score is shown on a system, that advertisement on that system is able to have its score decreased thereby increasing the chance of the second selected advertisement to be shown. If User 2 602t4 is approximated to have moved into viewable range of system 400b before User 4 604t4, but the advertisement associated with User 2 602t4 has not yet started before User 4 604t4 moves into viewable range of system 400b, the advertisement associated with User 4's mobile device system 500bt4 is able to have a higher probability of starting first.

As a result, the system and methods described in relation to FIG. 6 are able to provided higher advertisement relevance than is currently common at sites such as shopping malls by collecting user preferences determined by the user selection made on systems, user location awareness, and location approximation. Furthermore, the scenarios describe methods of how arbitration can be handled in cases with equal advertisement score.

### Data Loading

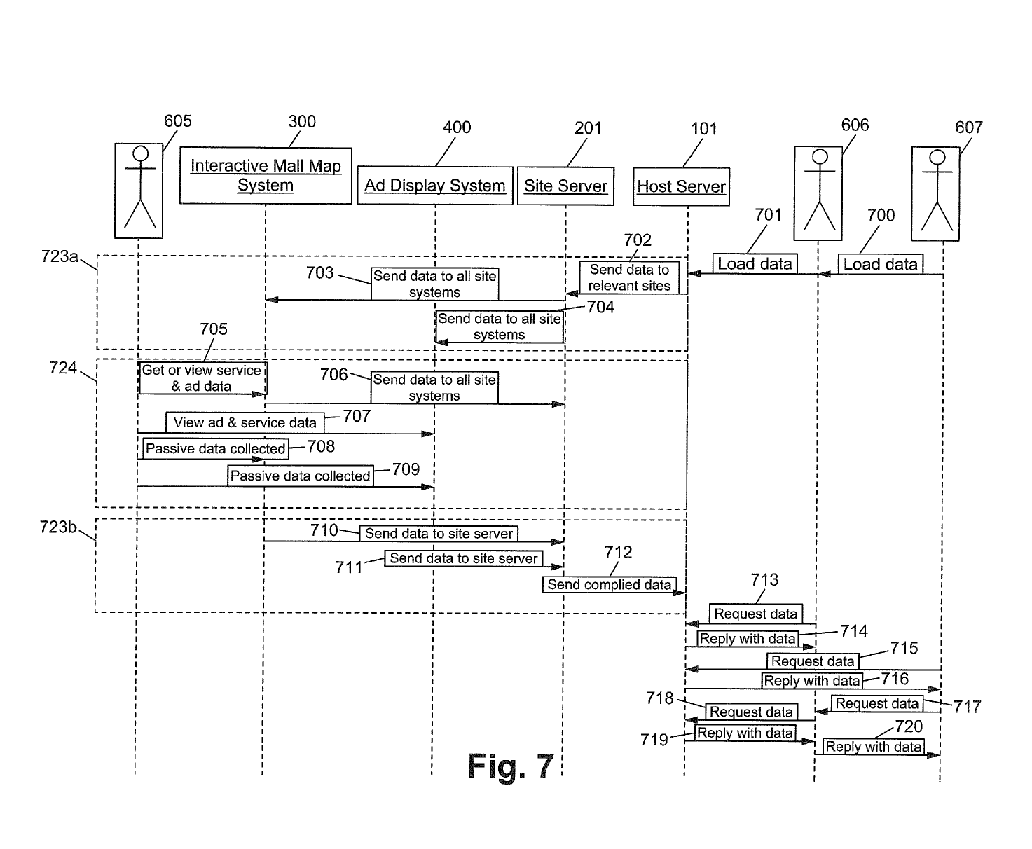

FIG. 7 is a sequence diagram illustrating a method demonstrating how service and advertisement data can be loaded and used in a interactive service and advertising system with efficient data network utilization according to some embodiments. As shown in FIG. 7, element 605 is an end user or shopper in a mall site, element 606 is a host company employee or a mall employee or a store employee or store owner at any site with internet access, and element 607 is marketing firms, brands, manufacturers, manufacturers' representatives, or product supplier located at any site with internet access. An interactive mall map system 300 located in a site such as shopping mall and is shown as a single system for ease of illustration. However, a plurality of systems 300 can be installed at a site performing actions illustrated by the single system 300. Similarly, an advertisement display system 400 located in the same site such as mall site or within a store in the mall site and is shown as a single system for ease of illustration. However, a plurality of systems 400 can be installed at a site performing action illustrated by the single system 400.

As shown in FIG. 7, a site server 201 is located at the site and a host server 101 (and host database) is located at the host company site which is able to be in a geographically different location from systems 300, 400, 201 and 101. Dotted blocks 723a and 723b comprise sequential actions that are able to take place at night or times of low data network traffic under normal operation. Dotted block 724 comprises sequential action that are able to likely take place at time of high data traffic and normal mall operating or shopping hours. Sequential actions not in block 723 or 724 are able to occur at any time.

At action 700 a user 607 (or users) loads advertisements or product data to the host server and database 101. At action 701, the user 606 (or users) loads data such as one or more of single media type and multimedia advertisements, service data, event data, store data, site data, product data or general information to host server and database 101. In some embodiments, access to host server and database can be available from any computer with internet access and web browser as well as directly on server and database 101 by a host company employee 606. In some embodiments, access can be restricted to account holders and authentication. In some embodiments, access can also be restricted to only rights granted by the host company to an account to read, write, download, or upload data to an account which can subsequently be pushed to systems such as 300, 400, and 201.

After data is loaded in host server and database 101, it can be sent to all sites for which the data is applicable. For example, if an advertisement for a store is uploaded and the store is located in two different sites, the advertisements are able to be sent to the two sites only. In FIG. 7, only one site is shown to demonstrate the method of distribution of data and interaction of the systems. Only one of system 300 and 400 is shown at a site, but a plurality of both systems are able to be deployed. Once the site server and database 201 has received the data from the host server and database 101 in action 702, the site server 201 is able to send the data to the appropriate systems at the site. At action 703, site server 201 sends database updates to the interactive mall map system 300. Site server 201 is able to replicate its database to all interactive mall map systems 300 at the site. At action 704, site server 201 sends database updates to the advertisement display systems 400. Site server 201 is able to replicate its database to all advertisement display systems 400 at the site. This enables a plurality of site databases to be available and distributed throughout the site.

At action 705, the end user 605 accesses system 300 to get service or advertisement data from the replicated data 703 that had been uploaded earlier. Furthermore, at action 705 the user 605 views service or advertisement data from the system 300. At action 706, the mall map system transmits usage/log data to site server 201. The usage/log data can be used to log the user's 605 interaction with the system 300 which can be used to adjust advertisement scores, or gain insight into the site user's preferences. At action 707, user 605 views services or advertisements from system 400 which is located in the database replicated earlier by action 704. At action 708, user 605 performs a passive action in proximity of system 300. A passive action can be but is not limited to, walking past the mall map system 300 or standing in front of the system 300 without touching the system. At action 709, the user 605 performs a passive action in the proximity of ad display system 400. The passive action can be logged on the mall map system 300 and ad display system 400 for which the action occurred.

At action 710, mall map system 300 reports system usage and passive action information logged back to site server 201. Usage information for the day for mall map system 300 includes but is not limited to, which advertisements and how many times they were shown, the real-time or near real-time usage information 706 previously sent in the day, as well as passive information 708 such as how many users walked pass the mall map system 300 or approached the system but did not interacted with the system. At action 711, ad display system 400 reports system usage and passive action information back to site server 201. Usage information for the day for system 400 includes but is not limited to, which advertisements and how many times they were shown and passive information 709 such as how many user walked pass the system 400 or approached the system but did not interacted with the system. At action 712, site server 201 sends a compiled report of site systems 300 and 400 usage and logged information 705, 707, 708, 709 to host server 101 to be analyzed to increase effectiveness and relevance of advertisements and services and systems 300, 400 performance.

At action 713, the user 606 requests usage and compiled logged information 712 from host server 101. At action 714, the host server 101 replies to the request with the requested data. Information available to user 606 can dependent on the users access level granted to the users account. The host company can have access to usage and logged information, stores can have access to information relating to systems 400 installed in their stores, and malls can have access to information on the systems 300 in their malls. Some information and logged data from system 400 and 300 can be restricted to user 606 especially others besides the host company. At action 715, the user 607 requests usage and compiled logged information from host server 101. At action 716, the host server 101 replies to the request with the requested data. Information available to user 607 can dependent on the users access level granted to the users account as described earlier in this paragraph but users such as marketing firms, brands, manufacturers, manufacturers' representatives, or product supplier can be limited to information relating to their products and advertising campaigns and contracts.

Additionally, if the user 607's definition is broadened to include any user or requester and user 606 is narrowed to host company. At action 717, the user 607 sends a request to the host company 606 requesting information which can not be part of a standard report or information that can not be readily accessible from host server 101 to user 607. Host company 606 is able to create and compile information per the request and access information from host server 101 by request 718 and reply 719 to create a report to satisfy request 717 with reply 720. Alternatively, actions 717 to 720 are able to be omitted.

### Mobile Device Accessing

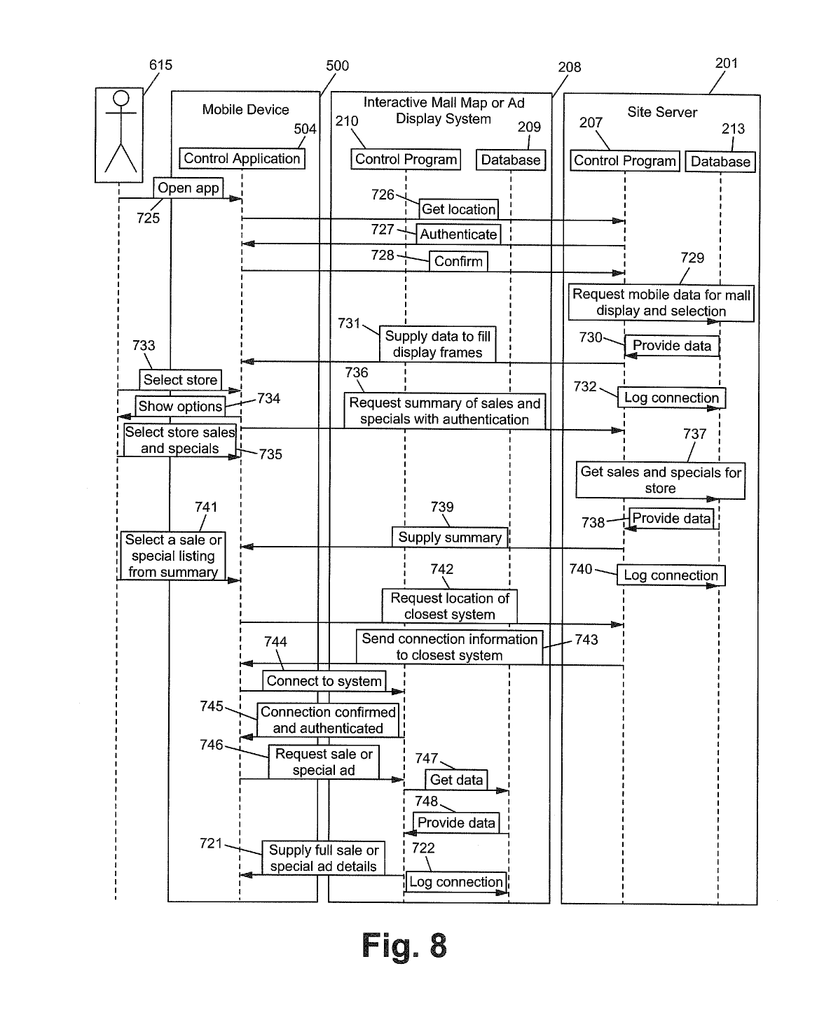

FIG. 8 sequence diagram illustration shows a method of using a mobile device with control application to gain access and become part of to the interactive service and advertising system to provide a user with site services according to some embodiments. Site server 201 is shown with site server database 213 and site server control program 207. Either an interactive mall map 300 or advertisement display system 400 is represented as 208. For the purposes of the following description and scenario of operation, either system is designated as 208 as both systems provide the capabilities for the mobile device 500 to couple and exchange data. Furthermore, database 209 and control program 210 represent the database and control program for either system 300 or 400. Mobile device 500 is illustrated showing the control application 504 installed on the mobile device 500. User 615 illustrates an end user at a site supported by systems 300, 400, or 201 who is using the mobile device, with authorized mobile control application installed, 500 to access data on the interactive service and advertising system site data network such as a mall site wireless data network.

At action 725, the user 615 opens the control application 504 on mobile device 500 which is able to provide access to service data on the site systems. At action 726, the control application 504 sends a request to the site server 201 and more specifically site server control program 207 over the site wireless data network to determine the location where the mobile device can be currently located. Control program 207 replies to the request 726 with a response 727 with an authentication request to control application 504 to determine if it is a control application that can be approved by the host company to access and at what level to grant access to the site server 201. A reply 728, from control application 504 to control program 207 for request 727 is able to be used to determine if control application 504 is authorized to access site server 201 and what restrictions can be placed on that access. If access is authorized the following description of actions are able to proceed, but if access is not authorized control application 504 and mobile device 500 can be denied access to any data on site server 201.

After authorization for control application 504 to access site server 201, site server control program 207 requests 729 service data for the site from site server database 213 which in turn replies 730 to the control program 207 with the requested data. Control program 207 then sends 731 to control application 504 the site service data which provides a site user interface to user 615 as well as provides the location of mobile device 500 from the request 726. At action 732, control program 207 logs data into database 213 the interactions between control application 504 and site server 201. Logged data is able to include information such as time and date of transactions, control application information such as version, and mobile device information.

Because the control application 504 has a user interface specific for the site where mobile device 500 is located, the user 615 is able to interact with and make selections from the control application 504 on the mobile device (via a touch screen or other input method provided by the device). Thus at action 733, selection options are presented by the control application 504 to user 615 on the mobile device 500 and the user 615 is able to make a selection of one of the options (e.g. a store at the mall site). After the store selection in action 734, control application 504 is able to present the user 615 with sub-options relating to the store selection. At action 735, the user 615 selects one or more of the sub-options. For example, the selection of a sub-option is able to be a request to view sales and specials offered by the selected store from action 733. Thus, the action 735 causes control application 504 to send a request 736 to site server control program 207 based on the sub-option selection. In this scenario, the request for information from control application 504 is needed because the application and stored data on mobile device 500 for the operation of control application 504 is kept to a minimum to conserve memory usage on mobile device 500. Alternatively, the information is able to be stored in a local database (e.g. when downloading the control application 504 and via updates or synchronization steps) and the request is unnecessary. When control program 207 receives a request such as action 736, the control program 207 is able to send a request 737 for the requested data to the database 213 and the database 213 is able to provide the data in a reply 738. Control program 207 is able to perform any need process of the data provided by action 738 and send the information request from action 736 back to control application 504 as a reply 739.

To continue the scenario of the request to view sales and specials, in the transactions described from action 736 to 739 a summary showing the selected store sales and specials information is sent to control application 504. At action 741, the user 615 makes a selection from the summary (which was received in the reply 739) to get more information relating to a specific sale or special. At action 742, the control application 504 requests the control program 207 to determine the closest system with the desired data. Control program 207 determines the closest system and transmits the location to the control application 504 at action 743. This enables the control application 504 to couple to the nearest system 208 for the information requested in order to conserve data network bandwidth and provide increased probability of the fastest data connection available. Alternatively, the closest system is able to be determined by mobile device 500. Next, the control application 504 requests to couple with the indicated system in action 744. As a result, the system control program 210 checks authentication information for request 744, and if authenticated, transmits a reply 745 with confirmation of connection. At action 746, the control application 504 sends a get message to the system control program 210 to reply with the requested data from the request action 741. The system control program interprets the request 746 and in turn requests the needed data from system database 209 in action 747. System database 209 replies to action request 747 with reply 748 providing the requested data to system control program 210, which formats the data and sends a reply 721 with the information requested (e.g. the sale or special information). Reply 721 is sent from system control program 210 to control application 504 to be displayed on mobile device 500 for the user to view. Transactions with system 208 from control application 504 and mobile device 500 are able to be logged on system 208 as illustrated by action 722 and stored in the database 209. Although FIG. 8 shows only one mobile device 500 and associated user 615 and one system 208 it is understood that a plurality of systems 208 at a site as well as a plurality of mobile devices 500 connecting to the site server 201 and systems 208 are contemplated.

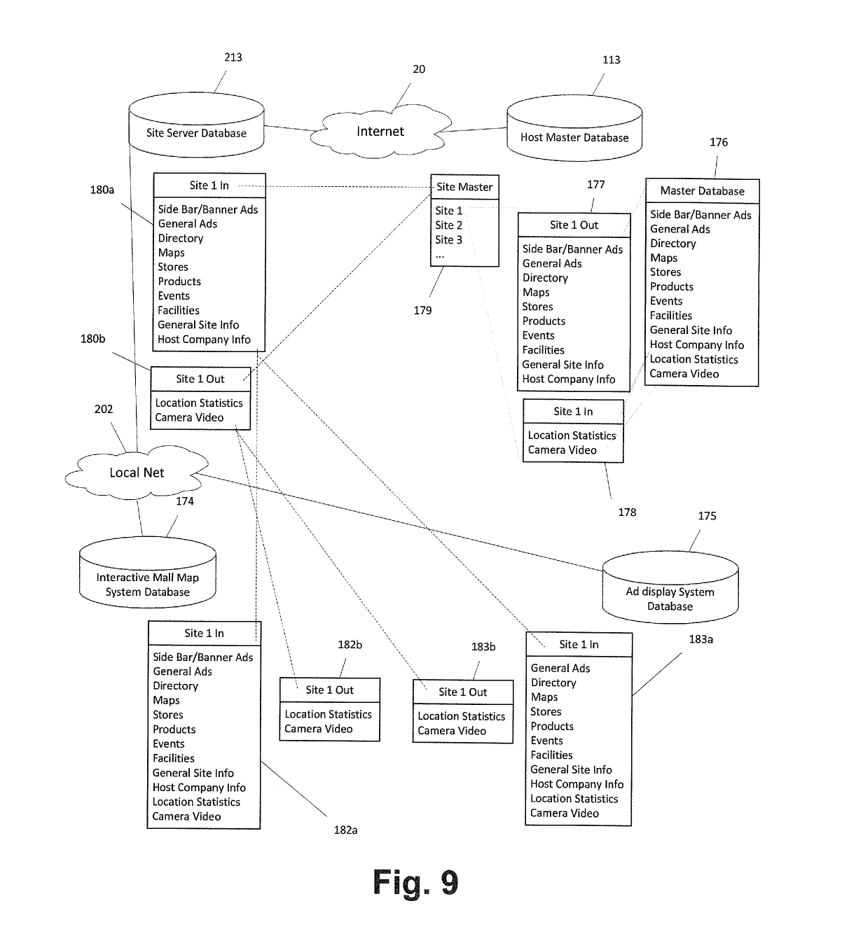

FIG. 9 illustrates database distribution, replication and relation on servers from the host company to a single site and systems at the site according to some embodiments. Database 113 represents the host master database which comprises data for all sites. Tables 176, 177, 178, and 179 represent a general view of some categories and organization of the host master database. Database 213 represents the site server database which comprises data specific for the site.

Tables 180a and 180b represent a general view of some categories and organization of the site database. Database 174 represents the database located on an interactive mall map system 300. Tables 182a and 182b represent a general view of some categories and organization of interactive mall map database. Database 175 represents the database located on an advertisement display system 400. Tables 183a and 183b represent a general view of some categories and organization of the advertisement display system database. Wide area data network 20 such as the internet can be used to couple the host master database to each remote site. Network 202 is a site local data network such as a wireless Ethernet data network connecting all system databases 174, 175 at the site to the site server database 213.

Table 176 illustrates the master database which can comprise database attributes to build the master database for services data, advertisements data, and general information which can be needed to provide the services, advertisements, and general information to all sites databases such as 213 and subsequently system databases such as 174 and 175. Contents of the database include but are not limited to text data, multimedia data such as video, audio, still images, and selectable links such as URL links. Some text data can be used as attributes for each set of data in the database to provide categorization of the data for actions such as data routing, management, addressing, and reporting. Tables 177 and 178 illustrate a site categorization of data from the master database 176 into data that is designated for site one. Although one site categorization is shown as table 177 and 178, a plurality of sites are able to exist each with a site categorization. Table 177 further illustrates site categorized data from master database 176 to be replicated out from host database 176 across network 20 to site server database 213. Table 178 further illustrates site categorized data received from site server 213 across network 20 into master database 176. Table 177 and 178 illustrated data moving from and to the master database 176 keeping each site database 213 and site categorized database on master database 176 updated with replicated data. The moving of data to make data entries in site server database 213 and site categorized data 177 and 178 in master database 176. The moving of the data, or replication, can occur over a twenty-four hour period as some data, determined by host company, is able to be replicated at different times to efficiently use data network bandwidth. Table 179 illustrates indexing of sites to enable the proper routing of site categorized data 177 and 178 to and from master database 176.

Tables 180a and 180b illustrate two site database categorization with table 180a illustrating data categorized that is received from the host master database 113 over network 20; more specifically site categorized data 177 routed by indexing table 179 to site database section 180a. Furthermore, table 180b illustrates data categorized which is received from system databases 174 and 175 over local data network 202 and then subsequently sent to host master database 113 over network 20; more specifically site categorized data 178 routed by indexing table 179 from site database section 180b. Tables 182a, 182b and 183a, 183b illustrate system databases for a system such as interactive mall map system 300 and advertisement display system 400 respectively. System databases 182a, 182b and 183a, 183b replicate with site database 213 and comprise data shown as database categorization 180a and 180b. Replication of data between database 213 across local data network 202 to and from databases 174 and 175 can occur over a 24 hour period as some data, determined by the host company, is able to be replicated at different times to efficiently use data network bandwidth.

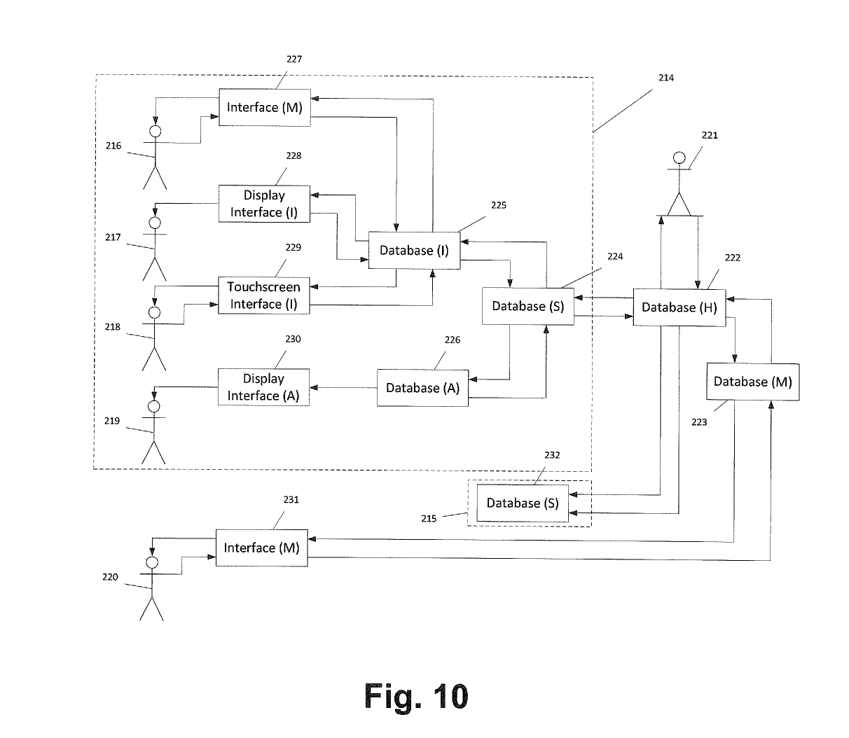

FIG. 10 is an illustration showing the relation of system and server databases with associated control programs also with interfaces to users, site patrons and beneficiaries according to some embodiments. Blocks and people representations are shown with connecting arrows which illustrate data flow direction and relation between the blocks and people representations. Dotted outlines 214 and 215 represent sites where systems 300, 400, and site server 201 can be installed and mobile devices 500 can be in use. The elements shown inside the dotted outline 214 represents a sampling of each system and server that manages a database at a site. Dotted outline 215 is only shown with a site server with database and associated control program 232 but is able to comprise the same configuration as shown in outline 214. Additionally, although FIG. 10 only shows two sites, more or less than the two sites are contemplated.

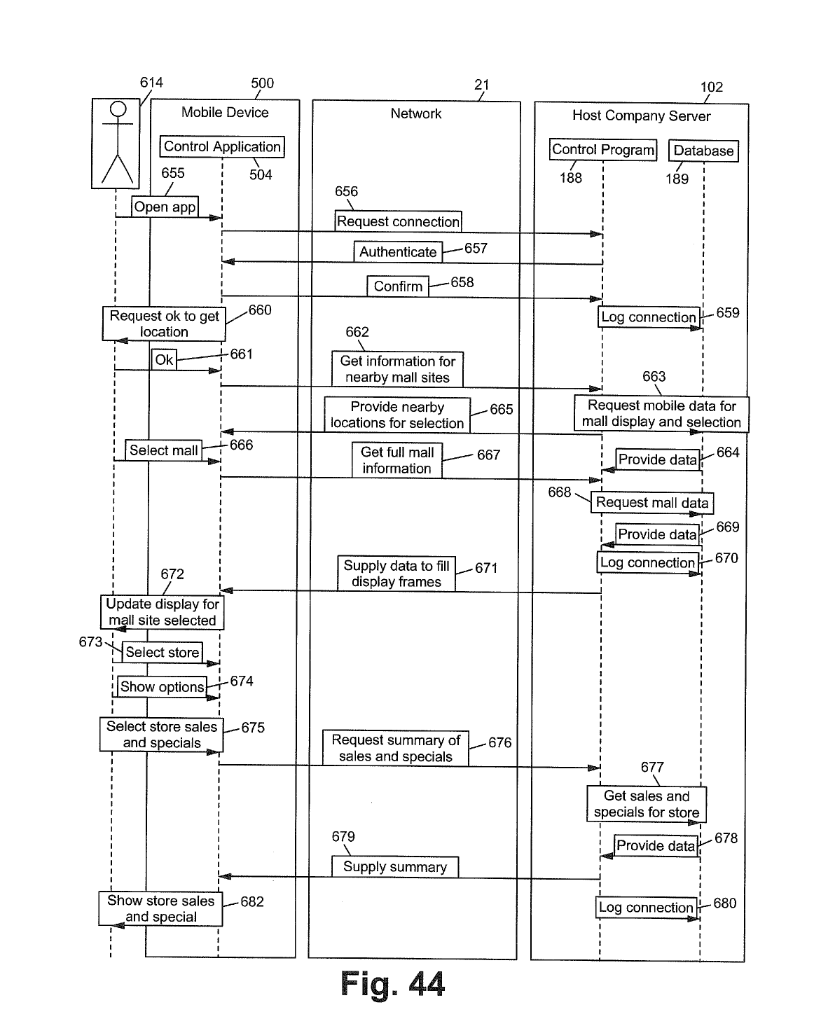

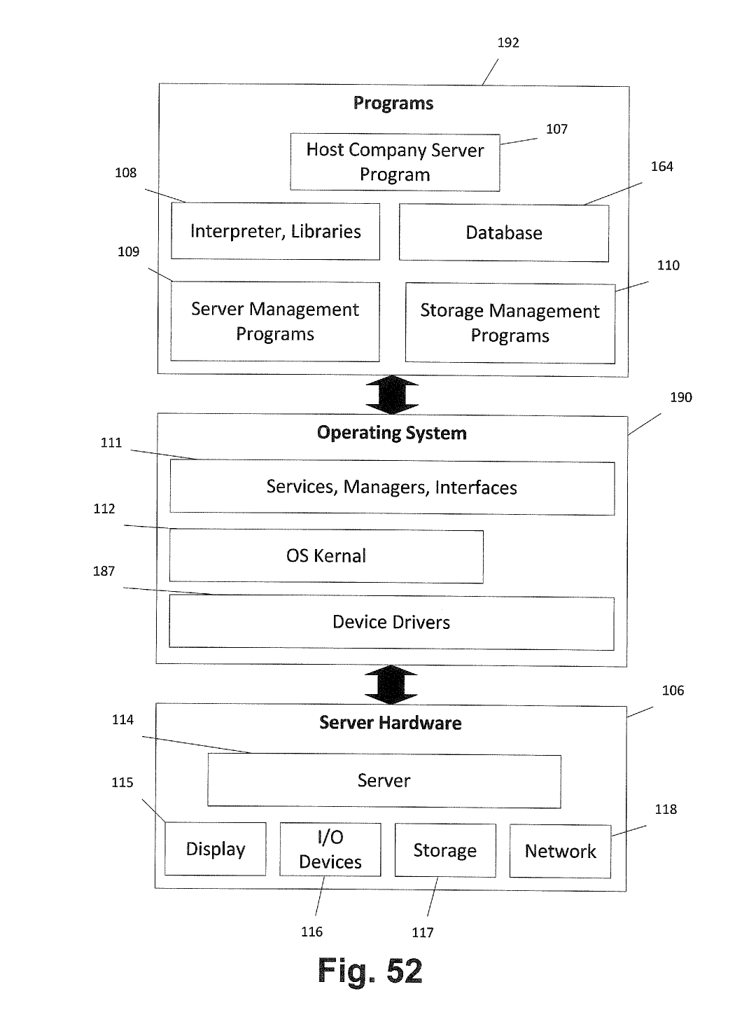

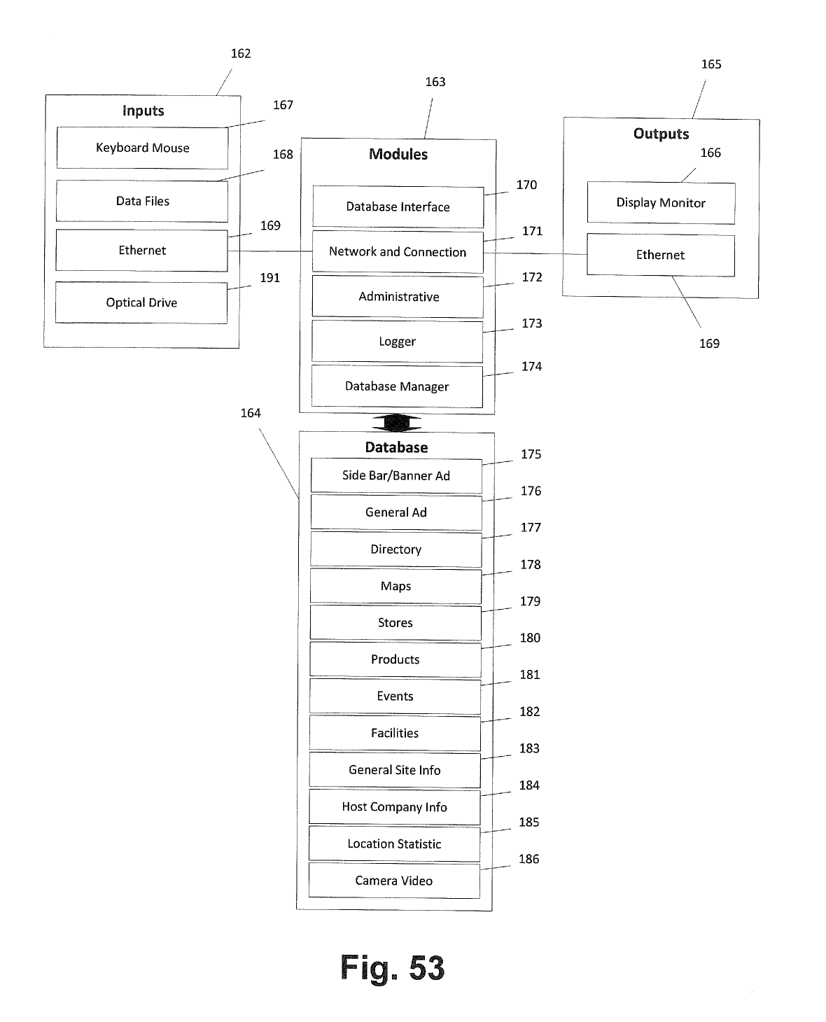

As shown in FIG. 10, element 221 represents a person, a group of people, or entity such as a host company or a beneficiary such as a store, marketing firm, mall, brand, product supplier and the like who can enter data into the database 222 for dissemination or can retrieve collected data from the database 222 to understand users preferences at sites as well as other analytical data relating to sites. Database and associated control program block 222 represents the host master database as described in FIG. 5, element 101, FIG. 9, element 113, and later in FIGS. 52 and 53. Database block 222 takes and provides data to person 221 based on manual access or automated reports and automatically disseminates and collects data from the master database to site server databases with associated control programs such as databases 224 and 232 as well as mobile database with associated control program such as 223. Mobile database with associated control program 223 automatically receives a copy of the master database to be accessed by mobile devices with authorized control application 500 and manages the access by each coupled mobile device 500 which can not be in a site covered by the site systems such as systems 300, 400, and 201. Additional information relating to the database block 223 is described in FIG. 5 for item 102 and later in FIG. 44 for items 188 and 189. Person 220 represents a user of a mobile device 500 which is represented as interface 231 and used to request data from database 223. If authorized the requested data is returned to the interface 231.

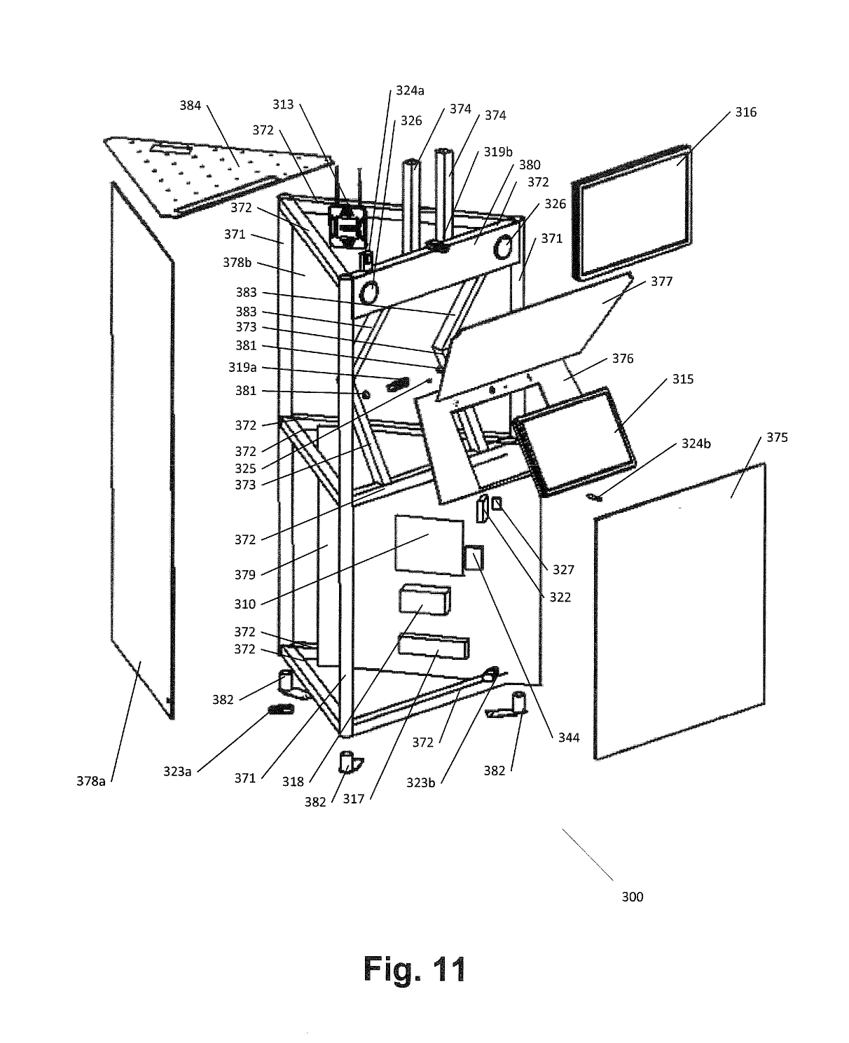

Site server with site database and associated control program is represented as block 224 and can only receive data that is relevant to the site. Site database block 224 receives data from the master database 222. Additional information relating to site database block 224 is described in FIG. 9 for element 213, FIG. 5 for element 201a, and later in FIGS. 52 and 53. Site database 224 replicates the database to interactive mall map system database with associated control program 225 and advertisement display systems 400 database with associated control program represented by block 226 located at the site. Person 218 uses the interactive mall map system touch screen interface block 229 to interface with the system to access data on the system database 225. Data is presented to person 218 through touchscreen interface block 229 as well as through system general display interface 228 to person 217. Additional information relating to the interfaces 228 and 229 are described later for FIG. 11 items 316 and 315 respectively. Person 219 receives information and advertisements from interface block 230 which is part of the advertisement display system 400 which comprises a database with associated control program shown by block 226. Person 216 uses a mobile device comprising an interface 227 to request data from a system or server within the site 214 that comprises a site database. The interface 227 couples to a nearby interactive mall map system database and associated control program 225. If person 216's request made through interface 227 is authorized, the requested data is transmitted from database block 225 to the interface 227.

### Interactive Mall Map System

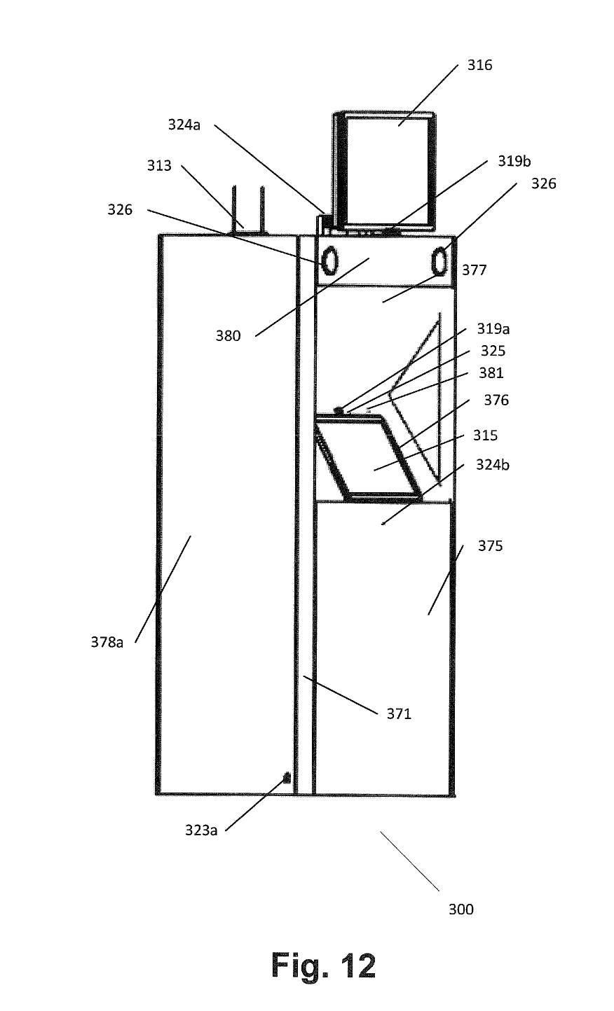

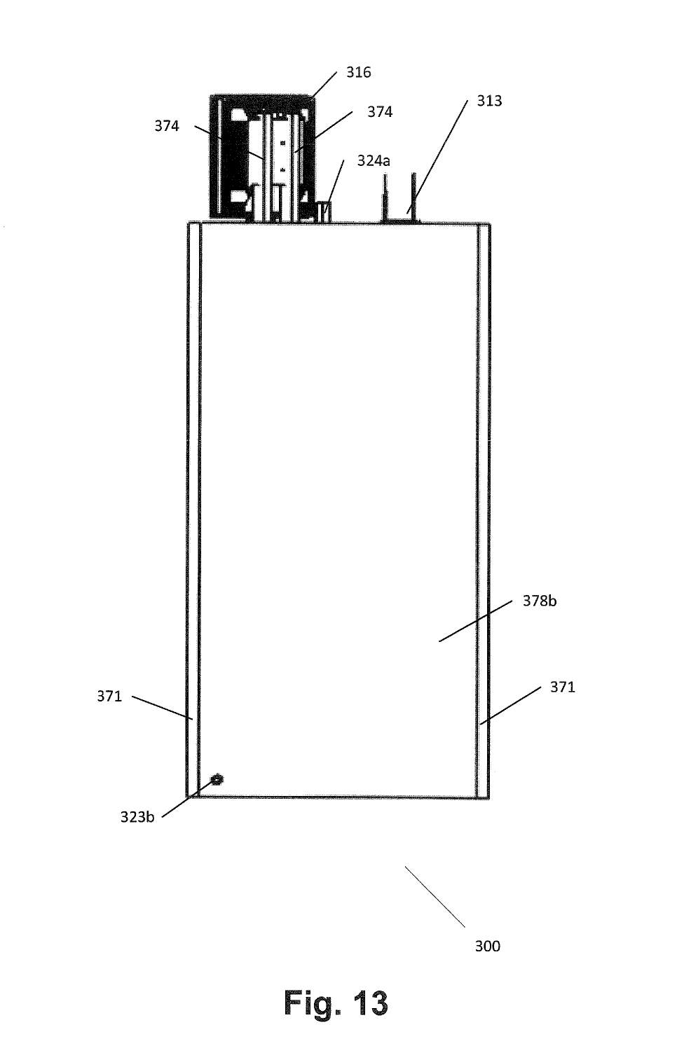

FIG. 11 illustrates an exploded view of an interactive mall map system 300 according to some embodiments. FIG. 12 is illustrates a front left view of the assembled interactive mall map system 300 according to some embodiments. FIG. 13 illustrates the back right side view of the assembled interactive mall map systems according to some embodiments. The system 300 of FIGS. 11-13 are able to be substantially similar to the systems shown in FIGS. 2 and 4 except for the differences described herein. As shown in FIG. 11, display 315 comprises a display panel such as an LCD or LED display, a touchscreen such as a capacitive, resistive or acoustic touchscreen to overlay the display, and a protective covering such as glass, if not part of the touchscreen, with coatings to minimize finger print smudges and scratches, and any controllers which can be needed for operation of the display and touchscreen combination. Furthermore, the touchscreen used on display 315 can be single or multitouch capable. Display 315 can also incorporate a frame to hold the components of the display together and provide mounting features for the display. Display 315 is an interface between the system 300 and a user of the system as the user is able to make selections and view results of the selections from the display 315. Display 315 is positioned on system 300 at a level and angle that can be convenient and where possible considered ergonomic for the site demographic to view and use. In some embodiments, in addition or in lieu of the touchscreen, display 315 is able to receive input from a mouse and keyboard, voice commands from a microphone, or other device for navigation tools well known in the art. Display 316 comprises a display such as an LCD or LED display and can not incorporate any touchscreen interface. One use of the display 316 is to display information such as multimedia advertisement and other site specific information. Display 316 can also incorporate a frame to hold the components of the display together and provide mounting features for the display as well as a cover to enclose all sensitive internal components. Although displays 316 and 315 are shown as each comprising a single display screen, both or one of the displays 315 and 316 are able to comprise a plurality of screens. For example, one or both of the displays 315, 316 are able to have a screen for each lateral side of the frame.

Device 317 is an AC power supply disconnect, overcurrent protection, overvoltage protection and distribution device such as a surge protector. Incoming supply AC power is able to couple to device 317 and the device is able to distribute the AC power to all components within system 300 requiring AC power. The location of device 317 is able to be in a position near the point where the AC power is incoming to the system 300. In an alternate embodiment, the device 317 is able to comprise more than one device to provide the AC power supply disconnect, overcurrent protection, overvoltage protection and distribution. Device 318 is a DC power supply which provides system 300 with any DC voltages and current levels needed to operate components on the system that can need DC power. Placement of DC supply 318 is able to be in an area where electrical wiring can be minimized, and electrical interference such as EMI to other components can be minimized, as well as meets the cooling specifications of the power supply. DC supply 318 is able to comprise a cooling fan which is able to maintain the temperature of the supply within its specified operating range. The DC supply fan or the addition of an external fan can also be used force air through the system 300 to cool other internal components. In an alternate embodiment, the DC supply 318 is able to comprise of more than one DC supply to provide DC voltages and at required current levels.

Device 310 is a printed circuit board controller for system 300 that comprises components and additional circuit boards coupled to provide the control for the system 300. The controller 310 is able to be in an area to minimize electrical wiring, electrical noise, and meet cooling specifications of the controller. In some embodiments, device 344 is non-volatile data storage device such as a hard drive coupled to controller 310 to provided data storage for system 300. In some embodiments, the hard drive 344 comprises two hard drives in a redundant configuration such as a RAID configuration. Alternatively, the hard drive 344 is able to comprise a single hard drive or more than two to provide sufficient storage and data protection. Device 322 is a converter module to convert input and output signals such as digital signal into a serial data stream such as USB which is coupled to controller 310. Signal converter 322 takes signals from sensors placed on the system, such as through-beam and proximity sensors, and converts these signals into a data stream that can be interpreted by controller 310. In some embodiments, the converter 322 is able to covert both digital and analog signals, and the data stream is able to also be Ethernet of other high speed data connection. In some embodiments, the converter 322 is integrated into controller 310 or comprises more than one converter device. The converter 322 is positioned to minimize electrical wiring and noise, and comply with the physical connection media length requirements to the controller 310.

Device 327 is an audio driver or amplifier for speakers 326 which can be used on system 300. The driver 327 amplifies the audio signals from controller 310 to speakers 326 to provide clear audio at a level appropriate for the background noise for the installed site such as a shopping mall. The driver 327 is positioned to limit electrical wiring and electrical noise to surrounding components and wires. Speakers 326 are placed in a location on system 300 to enable people such as shoppers in close proximity of system 300 to hear sounds from the speakers 326. Sounds from speakers are able to be correlated with multimedia being displayed on display 316. In FIG. 11, the speakers 326 are illustrated on the front side of the system 300, but are able to be positioned on different sides of system and comprise of more or less than two speakers and/or drivers. For example, in some embodiments there is at least one speaker for each display. Speakers 381 are able to be mounted in close proximity to display 315, mounted to panel 376, and provide audio correlation for multimedia displayed and action sounds such as user selection clicks on display 315. Speakers 381 can be driven directly from the output on controller 310 or can use a separate audio amplifier such as driver 327. In some embodiments, the driver 327 is a dual channel amplified coupled to two separate audio outputs from controller 310.

Sensors 323a and 323b are sensors to detect when a person such as a shopper walks past the system 300. In one embodiment, the sensors 323 are a through-beam or reflective type. For example, the reflector is able to be in proximity of the system with light or laser transmitter and receiver in one package installed on both sides of system 300 (e.g 323a covering left side and 323b covering right side). Alternatively, other photoelectric type sensors, ultrasonic type sensors, or other technology can be used. People detected passing the system 300 by sensors 323a and 323b are able to be counted and logged by the system. In some embodiments, sensors 323a and 323b are able to be installed low to the ground to detect feet or the leg area of the person passing the sensor, but can be positioned higher. In some embodiments, more or less than two sensors are able to be installed. This is beneficial if the system 300 was installed in a converging foot traffic area as well as if additional monitors are added or if the number sides on the system were increased beyond three sides.

Detector 324a is an infrared motion detector or ultrasonic proximity detector, or other similar detector to detect a person coming within viewable range of the system. It can be installed in a position to ensure full coverage of area without the detector being blocked by surrounding obstacles in the area of the system 300. To accomplish this, the detector is able to be installed at a high level such as at the top of the system. The detector 324a is able to be used to trigger an event when a person is in viewable range of the system 300. For example, the detector 324a is able to turn on or off displays if a person is or is not detected for a predetermined period of time. Detector 324b is a proximity detector to detect when a person or user in standing in front of and within clear view and touch range of display 315. The sensor can be positioned in a location near display 315. Proximity sensor 324b is able to be a photoelectric or ultrasonic sensor. Detection of a person by sensor 324b can trigger an event and can be logged for processing. For example, the event triggered can be causing change on the display 315 (e.g. changing to the default display screen after a user has left the detection range or providing a prompt to get a person's attention when they approach the system such as a hello message). Furthermore, a person can be detected by detector 324b and logged standing in front of and in view and touch range of display 315 but not interact with the system 300 and only view the default material shown on display 315. Detection and logging of a person interacting or not interacting with system 300 can provide information to the host company on how to improve the system and displayed material relevant for the site.

Cameras 319a and 319b, 319 collectively, can be used to detect people in viewable range of the system 300 and the video or images can be logged and processed if necessary. Camera 319a can be installed in a location near display 315 and positioned in a way to give a clear view of the user interacting with display 315. Camera 319a enables features which can require video or in a situation where video would enhance a service such as providing connection and interaction with another person at a remote terminal with video to provide additional help or shopper information to a shopper using system 300. Camera 319b enables the system 300 to monitor and log video and images of the area surrounding the system beyond the area where a person would be standing if using display 315. It is able to be located at a high point on the system to provide a wider view area that camera 319a. Camera 319b is able to perform the activities performed by detector 324 and if the camera view angle is sufficiently wide enough to cover the entrance area, it is able to perform the activities of sensors 323a and 323b. In some embodiments, camera 319b is able to comprise a plurality of cameras. In some embodiments, the camera 319b is able to be positioned to view the touchscreen 315 to remotely assist in or perform maintenance and troubleshooting relating to the touchscreen.

Device 325 is a microphone located near display 315 to provide additional features and enhanced features to system 300. Microphone 325 can be used to enhance a service such as providing connection and interaction with another person at a remote terminal with audio to provide additional help or shopper information to a shopper using system 300. In some embodiments, one or more of the electronic components such as microphone 325, speakers 326, 381, sensors 324, 323, and cameras 319 are able to be omitted from the system 300.

Wireless node 313 couples system 300 to the site wireless or wired data network.

Wireless node 313 is a wireless access point with wired data network connection and network switching capability. It couples controller 310 to the site data network 202 and is able to also function as a wireless access point for connection of site mobile devices 500 within range, to the site wireless network 202. Furthermore, it is the wireless data network link between mobile device 500 in proximity of system 300 and the database stored on system 300. It can be located on a high point of the system 300 and in a location to minimize electrical interference from other components on the system 300 such as display 316.

Panel 379 is a main panel for the installation of electronic control components on the system 300. It physically couples to frame members 372 with fasteners such as screws or bolts and is able to be selectively removed. In some embodiments, the panel 379 comprises mounting holes and stand-offs and other features to secure the electronic components which are able to be installed onto the surface of the panel. The panel 379 is located in the lower portion of the system 300 and should have easy access to all components installed for maintenance and service activities. Furthermore, the panels can be constructed of metals or synthetic polymers materials such as steel, aluminum, ABS or Polycarbonate with steel being the preferred material. It can be preferable to use a pacification layer on metals if not fully painted and can be pacified even if painted.

Vertical support members 371 are primary vertical support framing members and define the corners of the system 300. Support members 371 are coupled to horizontal support members 372 to form the core framing structure for the system 300. Connection of vertical and horizontal support members can be accomplished with fasteners such as screws or bolts, or welding. Support member 371 and 372 are constructed of structurally ridge material to support the weight of the electronic components and side panels. Material such as but not limited to, hollow extruded aluminum or hollow steel can be used and pacified to prevent corrosion. Plastic such as PVC can be used if sufficiently thick enough and components on the system are light enough for system 300 frame construction. Support members 372 provide mounting location to all components on the system 300 as well as define the width of the system and number of sides of the system along with support member 371. In one embodiment, three horizontal rows are at different heights to provide structural strength and support for side panels 378a, 378b, and 375. In alternate embodiment, two horizontal rows can be used with thicker side panel or the side panel is able to incorporate additional features to improve structural strength. Furthermore, with proper anchoring of vertical member 371, side panel 378a, 378b, 375, and 380 can replace horizontal members 372.

Vertical support members 371 can be anchored to the floor at the site of installation by anchors 382. Anchors 382 can couple to frame members 371 with screws, bolts, or can be welded and are anchored to the flow by screw, bolts or other anchoring method to ensure that system 300 cannot be pushed over by a person or fall during an earthquake for the site of installation. In an alternate embodiment system 300 can be secured to the floor by weights on anchors 371 or weights on a solid floor of system 300 in an amount to ensure the system cannot be pushed over by a person or fall during an earthquake for the site of installation. In the embodiment shown in FIG. 11, the system 300 is shown with three sides constructed of the core frame component 371, 372 and 382. Alternatively, the system 300 can be constructed with more or less lateral sides, and/or with all displays 316 and 315 and electronics aligned in the same direction. A two-sided system can have the smallest footprint and can comprise only two vertical supports members 371, wherein anchors 382 are a sufficient size to anchor to the installation site floor to provide stability to the system. In contrast, systems 300 with more than three sides enable more surfaces to mounting displays 315 and 316, thereby enabling an amount of displays 315 and 316 to equal the number of sides used in construction.

Panels 378a and 378b form covers for the two sides without display 315. In one embodiment, panels 378a and 378b are mirror images with a small opening through the panel for the sensor 323a and 323b to function. In an alternate embodiment, panel 378 collectively can be constructed of four smaller panels with a top and bottom panel instead of the two large panels as shown in FIG. 11. Panel 375 is the front panel and is installed on the side comprising the display 315 and has a small through hole to enable operation of the proximity sensor 324b. Panels 378a, 378b, and 375 attached to the support frame members 371 and 372 with fasteners such as screw or bolts but can incorporate other methods such as hinges with locks to easier access to the internal components of the system 300. Panels 378a, 378b, and 375 can comprise print material such as a print mall map or print advertisements. Furthermore, the panels can be painted only or show other artistic graphic designs or identification markings. Panel 380 is the top front cover and provides a holes and mounting location for speakers 326. Panel 380 is fastened to frame members 371 and 372 with fasteners such as screw or bolts and can be painted, comprise print advertisement, or other artistic graphic designs or identification markings. Panels 378a, 378b, 375, and 380 can include features to increase panel structural rigidity such as side bends or the incorporation of a permanently attached frame to the panel. Furthermore, the panels can be constructed of metals, synthetic polymers or wood materials such as but not limited to steel, aluminum, ABS, Polycarbonate, or plywood. If plywood is used, it can be preferable to cover the painted wood with a clear covering such as polycarbonate or acrylic.

Frame 374 is attached to top frame member 372 and is constructed of two frame pieces for the mounting of display 316 to system 300. Connection to the frame 372 can be by fasteners such as screws or bolts or welded and at a dimension to mount the display 316 without interference of other components on the system 300. Monitor 316 is mounted to frame 374 by screw or bolts and can require and additional mounting plate to adapt the display 316 to frame 374. Frame members 373, bottom member, and 383, top member, are coupled to top and mid frame members 372 and for the mounting of display 315 and covers 376 and 377. Frame member 373 and 383 are coupled to frame members 372 and each other with fasteners such as screws or bolts or welded and at a spacing or dimension to mount the display 315 without interference of other components on the system 300. Frame member 374, 373, and 383 are constructed of the same materials as 372 in one embodiment. The mounting angles between 373 and 383 and 372 are able to be at an angle to provide optimal viewing angle for display 315 as previous defined for display 315 and sufficient clearance of panel 377 to enable a clear view of display 315 for the demographic of the installed site user. Panel 376 is mounted to frame members 373 with fasteners such as screws or bolts, made of the same material as other panels installed on the system 300 such as panel 375, and is used to cover the opening behind display 315 and provide mounting capabilities for microphone 325, speakers 381 and camera 319a. Furthermore, the panel comprises features to mount the components listed in the previous sentence and an opening to allow display 315 to recess into system 300 and allow wires from display 315 to pass into the system. Panel 377 is mounted to frame members 383 with fasteners such as screws or bolts, made of the same material as other panels installed on the system 300 such as panel 376. It covers the opening above display 315.

Panel 384 is mounted on top frame members 372 atop of system 300, attached with fasteners such as screws or bolts, made of the same materials as other panels such as panel 375. Panel 384 can be perforated to allow ventilation of heat from components in system 300 and to prevent debris from site of installation from falling into the system. Furthermore, it is able to comprise cutouts to enable routing of electrical cables, for protruding components such as wireless node 313 and for frame members 374. In one embodiment, there can be no bottom panel in system 300 as side panels 378a, 378b, and 375 extend to a distance from the floor prevent unwanted access to the system but still allow air flow for component cooling. In an alternate embodiment, a bottom panel can be installed with the same attributes described for panel 348 and/or no top cover can be installed. Panels 378a, 378b, 375, 376, 377, 380, and 384 enclose system 300 to allow component mounting and to protect from unwanted access to the system and to further act as an aesthetic feature of the system.

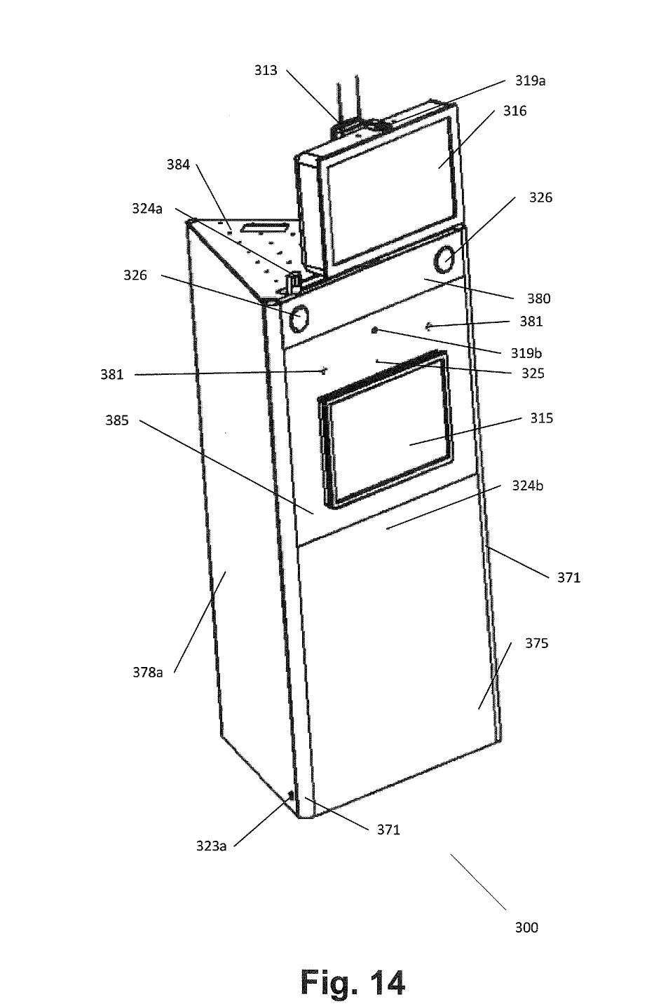

FIG. 14 illustrates an isometric view of an interactive mall map system having an interactive touchscreen display 315 mounted parallel to the front side of the system in landscape orientation according to some embodiments. The system of FIG. 14 is substantially similar to the system of FIGS. 11-13 except for the differences described herein. For example, panel 385 in FIG. 14 replaces panels 376 and 377 shown in FIG. 11 and support members 373 and 383 from FIG. 11 are replaced with two straight vertical support member mounted to the upper and middle horizontal support member 372 to support the display 315 in a vertical orientation instead of an angular orientation shown in FIG. 11. Microphone 325, speakers 381 and camera 319b are mounted to panel 385 as was done on panel 376 in FIG. 11. Display 316 is shown with a larger enclosure than shown in FIG. 11, with camera 316 mounted to the top and wireless access node 313 mounted to display 316. Components 313, 319a, 316 function and has attributes are described for FIG. 11 and are shown in an alternate locations with display 316 shown with an alternate enclosure to reuse components from advertisement display system 400 described above.

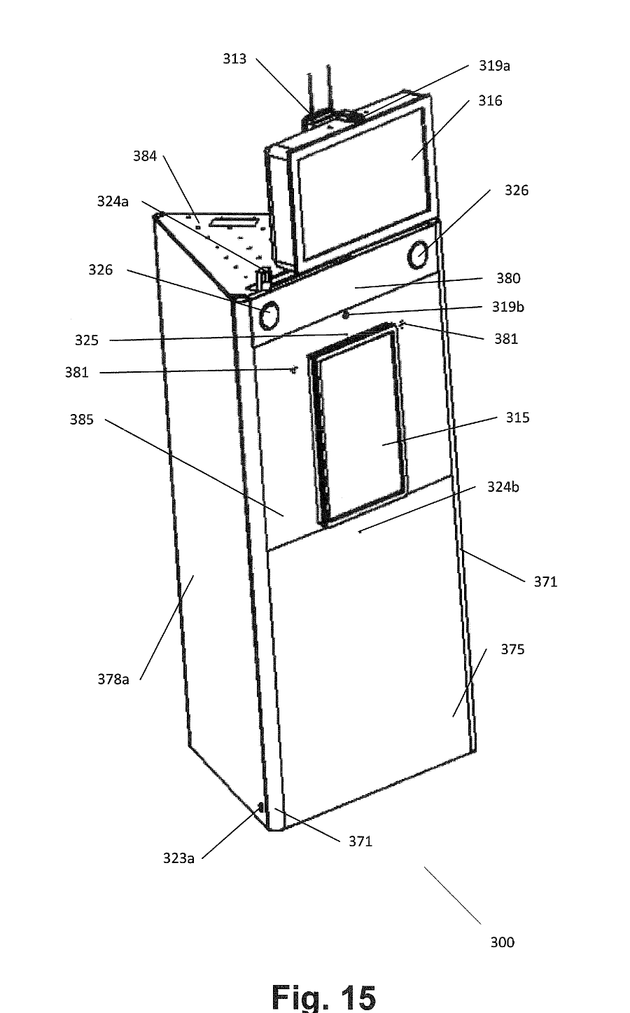

FIG. 15 illustrates an isometric view of the interactive mall map system with an interactive touchscreen display mounted parallel to the front side of the system in portrait orientation according to some embodiments. The system of FIG. 15 is substantially similar to the system of FIGS. 11-13 except for the differences described herein. For example, display 315 is installed in portrait orientation with microphone 325, speakers 381 and camera 319b repositioned to accommodate the portrait orientation of display 315. The orientation of portrait display allows alternate layout of displayed graphics and multimedia for the site of installation.

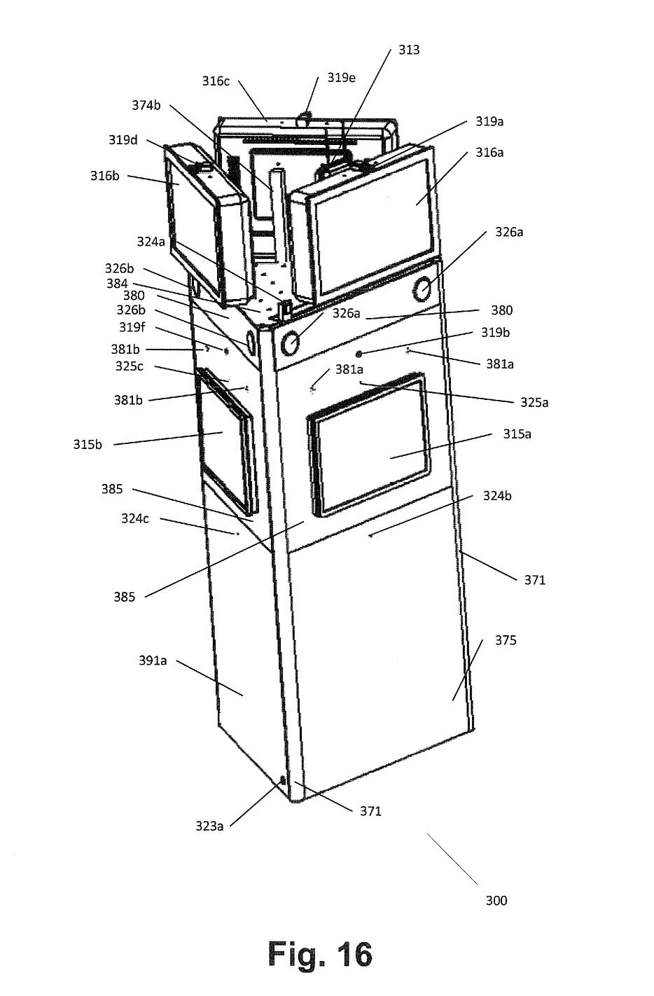

FIG. 16 illustrates an isometric view of the interactive mall map system with all three sides mounted with touchscreen displays and general displays as well as other components on each of the sides of the system according to some embodiments. The system of FIG. 16 is substantially similar to the system of FIGS. 11-13 except for the differences described herein. For example, touchscreen displays 315a and 315b are mounted and function as previously described for display 315 for FIG. 11, however there is an additional touchscreen display that is installed on the far side view of FIG. 16 which is not visible and functions as defined by display 315. As a result, system 300 in FIG. 16 has a touchscreen for each of the three sides on the system. Each of the three touchscreen displays, 315 collectively, which function independently and respond to a user's input independent of the action on another touchscreen. General displays 316a, 316b, and 316c are mounted and function as previously described for display 316 for FIG. 11. Three general display screens 316a, 316b, and 316c can be configured to display three different advertisements based on the advertisement score calculated from the use of each touchscreen display 315a, 315b and 316c or all three general displays 316a, 316b, and 316c can be configured to display the same advertisement synchronized and based on the advertisement score for the system 300.

Cameras 319a, 319d, and 319e are mounted and function as previously described for camera 319b for FIG. 11. Furthermore, each camera is able to operate independent of each other. Cameras 319b and 319f are mounted and function as previously described for camera 319a for FIG. 11. There is an additional camera that is installed on the far side view which is not visible and functions as defined by 319b for FIG. 11. Furthermore, each camera 319b, 319f, and 319c operates independently of each other. Detector 324a is associated with the side of installation and function as previously described for FIG. 11 with function tied to displays 315a and 316a. Each side of the system 300 has a detector 324a with functions tied to each touchscreen and general display for the side of installation. Speakers 326a and 326b are mounted and function as previously described for speakers 326 for FIG. 11. There are additional sets of speakers that are installed on the far side view of FIG. 16 which is not visible. The functions of speaker 326a, 326b and 326c are tied to the general displays 316a, 316b, and 316c on their respective sides of the system 300. Speakers 381a and 381b are mounted and function as previously described for speakers 381 for FIG. 11. There is an additional speaker that is installed on the far side view of FIG. 16 which is not visible. The functions of speaker 381a, 381b and 381c are tied to the touchscreen displays 315a, 315b, and 315c on their respective sides of the system 300.

Detectors 324b and 324c are mounted and function as previously described for detector 324b for FIG. 11. There is an additional detector that is installed on the far side view of FIG. 16 which is not visible. The functions of detector 324b, 324c and 324d are tied to the touchscreen displays 315a, 315b, and 315c on their respective sides of the system 300. Panel 391a is a side panel and has a small through hole to enable operation of the proximity sensor 324c and sensor 323a. Furthermore, the panel attaches to system 300 frame members and is able to be constructed of the same material as panel 375 as described for FIG. 11. The installation and functions of components 313, 380, 371, 375, 323a, 385 are the same as described in FIG. 11.

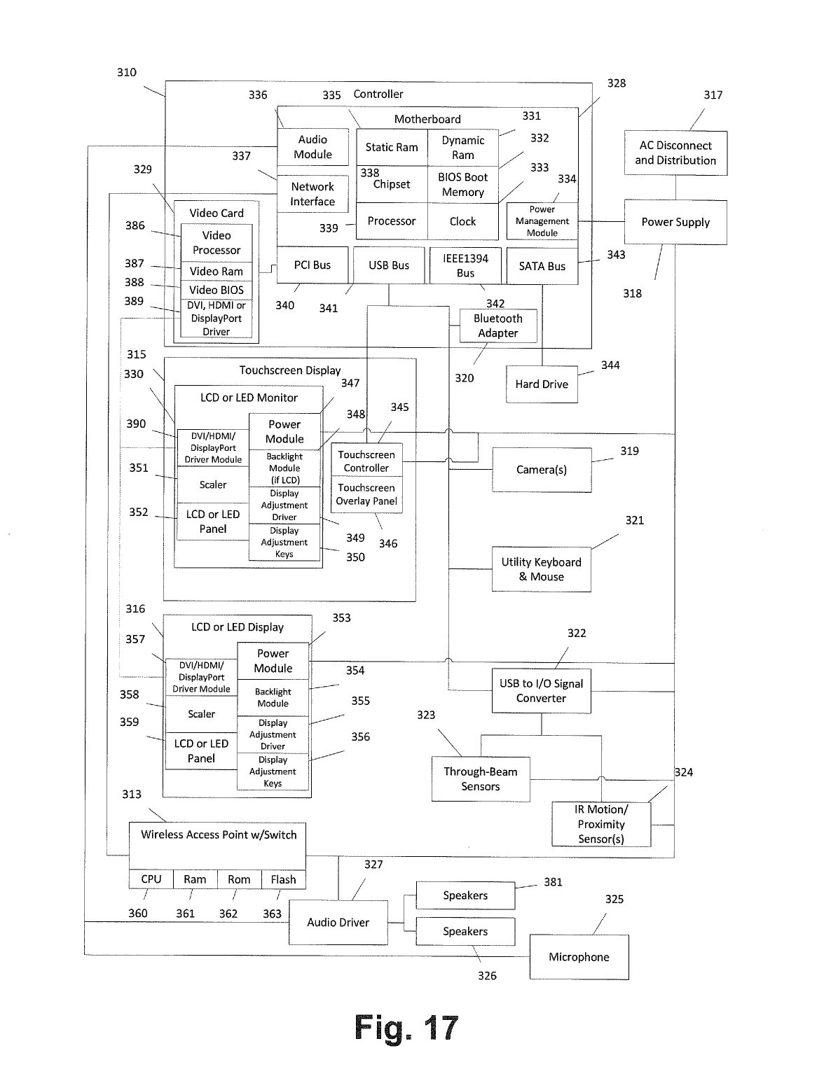

FIG. 17 is a block diagram showing electronic components of the interactive mall map system according to some embodiments. Device 317 is an AC power supply disconnect device which can provide features such as overcurrent protection, overvoltage protection and distribution to system 300. Device 317 is able to be coupled to a DC power supply 318 to supply power to power supply 318. Alternatively, AC distribution device 317 can couple to controller 310, display 315, display 316, wireless node 313, audio driver 327, and possible other devices to supply power to these devices instead of power supply 318. In some embodiments, the DC power supply device 318 is able to be coupled to controller 310's power management and distribution module 334, display 315's power module 347, display 316's power module 353, wireless node 313, audio driver 327, sensor 323, and detector 324. USB to Digital I/O Module 322 and camera 319 can additionally need DC power supplied from DC power supply 318 depending on the type of module and camera installed. DC power supply 318 can comprise a single power supply module with multiple outputs or a plurality of power supplies with a single or multiple outputs.

The Controller 310 for the interactive mall map system 300 is able to comprise a motherboard 328, a video card 329 and Bluetooth adapter 320. The video card 329 functions are able to be integrated into the motherboard 328. Motherboard 328 can be a standard personal computer motherboard, mainboard, system board or a custom PCB. The power management module 334 manages the power connection interfaces to power supply 318 and regulates and monitors voltage levels for motherboard 328. SATA bus 343 provides SATA, serial advanced technology attachment, or other related technology for connections and communication control interface to hard drives or other non-volatile storage devices coupled to the motherboard 328. IEEE1394 bus 342 provides connections and communication control interface for any devices that can be required to be coupled to the motherboard 328 using the IEEE1394 standard. USB bus 341 provides connections and communication control interface for any devices using USB, universal serial bus, or other serial communication protocols. PCI bus 340 is the Peripheral Component Interconnect standard peripheral bus or other related input output bus to provide a connection and control interface to attach circuit boards which conform to any of the standards of the Peripheral Component Interconnect bus.

Network interface 337 is an Ethernet or other related data network communication connection and control interface to provided network data connection between the motherboard 328 and a coupled network. Audio module 336 provides connections and any needed control to interface the motherboard 328 to attached audio devices. Processor 339 is the central processing unit of the motherboard and provides core control, interface with software and firmware programs, and data input/output and processing operations. Chipset 338 manages communication and interfaces between components on the motherboard such as processor 339, memory, input/output components and bus systems. Static ram 335 is memory on the motherboard which is non-volatile or does not require refreshing and is used by the processor 339 to move and store data as well as possibly other devices for data storage. Dynamic ram 331 is memory on the motherboard which is volatile and is used by the processor 339 to move and store data, and can also be used by other devices for data storage. BIOS Boot Memory 332 is non-volatile memory used to provide instructions to processor 339 on power up to initialize components on and coupled to motherboard 328. Clock 333 is the motherboard clock which provides a pulsed signal for the synchronization of logic and data transfer operation on components and between components attached to the motherboard.

Video card 329 is a video card which is part of controller 310, can be coupled to PCI Bus 340 on motherboard 328, and is coupled to displays 315 and 316 to provide video signals to the displays. Video card 329 is a single card with two video connections to displays in one embodiment for system 300. In alternate embodiments, video card 329 can comprise of a plurality of video cards with each having a connection to motherboard 328 or the video card functions can be integrated into the motherboard 328. Furthermore, display connections on video card 329 can comprise one connection for each card or a plurality of displays connecting on each card. Video card 329 can be a video card, but can also be any specialized video display device which interfaces with motherboard 328 and display 315 and 316 for the purpose of displaying images on attached displays. Video card 329 comprises but is not limited to a video processor 386, video ram 387, video BIOS 388, and display driver module 389. Video processor 386 is a graphics processing unit which provides central control and data processing for the video card. Video ram 387 provides volatile and non-volatile data storage for the video processor 386 and for input/output operations between components on and coupled to video card 329. Video BIOS 388 provides instructions and data to the video processor 386 and coupled components such as the motherboard processor 339. Display driver module 389 provides connections to video displays such as displays 315 and 316 as well as other interface components to interface with the connection and communication standards used by the attached displays to transmit video signals for graphics display on the attached displays. Hard drive 344 is a non-volatile data storage device coupled to SATA bus 343 with a SATA cable or other cable compliant with the hard drive 344 and motherboard 328 connection bus for non-volatile data storage. Although a single block is shown for hard drive 344 for ease in illustration, a plurality of hard drives (e.g. a redundant configuration such as RAID) are contemplated.

As shown in FIG. 17, the Bluetooth adapter 320 is able to be part of controller 310 and is attached to motherboard 328 by USB bus 341. Bluetooth adapter 320 can also be installed at a high position of system 300 for increased range and coupled to USB bus 341 using a USB cable or Bluetooth adapter 320 can be integrated into motherboard 328. Bluetooth adapter 320 provides wireless connection capability on system 300 for mobile devices 500 in range of the Bluetooth adapter 320 supporting a plurality of versions of the Bluetooth standard. A Bluetooth connection between mobile device 500 and system 300 provides an alternate data connection method to provide services, information and advertising information from the database on system 300 as can also be done with a wireless Ethernet connection. Furthermore, the connection can be used to determine a mobile device 500 proximity to system 300.

Cameras 319 are cameras installed on system 300 and are coupled to controller 310 using USB bus 341 and specification compliant USB cable. In some embodiments, the cameras are coupled to another bus or PCB card installed the motherboard 328. As shown in FIG. 17, the cameras 319 comprise cameras 319a and 319b. Utility keyboard and mouse 321 is a standard USB keyboard and mouse coupled to controller 310 using USB bus 341 to provide on-site troubleshooting and service access to data and control programs on system 300 by an authorized agent. Utility keyboard and mouse 321 can be located within the system 300 permanently or coupled by authorized agent at the time of troubleshooting and service. USB to I/O signal converter 322 provides an input and output interface between sensors and detectors attached to the converter and controller 310. Converter 322 is coupled to the controller 310 motherboard 328 by USB bus 341 and USB cable. Converter 322 is powered by either the USB connection or DC supply 318 depending on the module selected. Alternately, converter 322 can couple to controller 310 using the network interface 337 or coupled to or be integrated on a PCB card installed on the motherboard 328 instead of USB bus 341.

Sensors 323 and detectors 324 are substantially similar to sensors 323a and 323b, and 324a and 324b in FIG. 11. The sensors 323 and detectors 324 are coupled to signal converter 322 to provide digital output signals from the sensor to inputs on the converter 322 to be used by controller 310 for system 300 operations. Furthermore, sensors 323 and detectors 324 are electrically coupled to the DC power supply 318 to meet operating DC power specifications for each sensor. Audio driver 327 is coupled to audio module 336 on motherboard 328 and provides amplified audio output signals from the audio module to speakers 326 and 381 and is shown using DC power from DC power supply 318. Microphone 325 is coupled to audio module 336 on motherboard 328 and provides an audio input from a user to the controller.

Wireless node 313 is a wireless access point with wired data network connection and network switching capability. Wireless node 313 is coupled to network interface 337 with a cable such as on Ethernet cables providing a high speed data connection between controller 310 and wireless node 313 to couple to a site data network. As shown in FIG. 17, the wireless node 313 is coupled to DC supply 318 for any DC power required for operation of the node. Wireless node 313 is able to comprise a wireless access point. CPU 360 is the central processor of the wireless node providing central control for all data process and input and output operations. Ram 361 is volatile memory for data storage for data processing operations. Rom 362 is non-volatile read only memory for instruction and information which can be required to startup and basic operation of the wireless node 313. Flash 363 is non-volatile read and writable memory for data and configuration storage such as such as an operating system and control program.

Display 316 is video display device such as a LCD or LED monitor or TV display device. It is coupled to the controller 310 through video card 329 and is powered by DC supply 318. Power module 353 provides a power connection to DC supply 318 and manages, monitors, and distributes DC power for display 316. Backlight module 354 provides light and control for the backlight of the LCD or LED display panel 359. LCD or LED panel 359 is the display panel visible to a user which is driven by display driver 357 which translate input signals from the video card 329 and drives the inputs to panel 359 to display an image. Scaler 358 can adjust the image on panel 359 to a range of resolutions if needed and adjustment keys 356 and adjustment driver 355 can also adjust the displayed image quality on panel 359 as well as provide a button to turn the display on and off. Display driver 357 can also incorporate a controller with CPU and memory to provide menu options for the display 316.

Display 315 is touchscreen video display device such as a LCD or LED monitor or TV display 330 with touchscreen components comprising of a touchscreen overlay 346 and touch screen controller 345. Display 330 is part of the complete display assembly 315 and is coupled to the controller 310 through video card 329 and is powered by DC supply 318. Power module 347 provides a power connection to DC supply 318 and manages, monitors, and distributes DC power for display 330. Backlight module 348 provides light and control for the backlight of the LCD or LED display panel 352. LCD or LED panel 352 is the display panel visible to a user which is driven by display driver 390 which translates input signals from the video card 329 and drives the inputs to panel 352 to display an image. Scaler 351 can adjust the image on panel 352 to a range of resolutions if needed and adjustment keys 350 and adjustment driver 349 can also adjust the displayed image quality on panel 352 as well as provide a button to turn the display on and off. Display driver 390 can also incorporate a controller with CPU and memory to provide menu options for the display 330. Touchscreen overlay 346 provides the transparent covering material which overlays the display panel 352 and provides a surface for a user to touch to provide input which can be translated by the touchscreen controller 345 and sent to the USB bus 341 for processing by the controller 310. Touch screen controller 345 is power by DC supply 318. Touch screen controller 345 can be coupled and communicate with the controller 310 by other communication methods and connections such as IEEE1394 342.

In some embodiments, the interactive mall map system 300 of FIGS. 11-17 is able to comprise one or more additional sensors or input devices. For example, the system 300 is able to comprise sensors or input devices such as but not limited to RFID readers or bar code scanners. An RFID reader can be installed inside the system and attached to the internal frame or panel 379 or mounted externally at a high location on the system. It can be powered by power supply 318, and coupled to controller 310 by an available bus such as USB bus 341. An added RFID reader on the interactive mall map system 300 is able to enable detection of a purchased product moving with range of the system and can be logged into the system database and can be used to adjust advertisement score of an associated product and be used to determine common products purchased by the site demographic. A bar code reader can also be added to enable the user to scan a product UPC code and get additional information about a product which can be displayed on the system display. The information can include but is not limited to what stores sale the product and the site and what sales or specials can be occurring at the site relating to the product. The use of a bar code reader by a user is able to logged and can affect advertisement scores for associated products and be used to determine common products purchased by the site demographic.

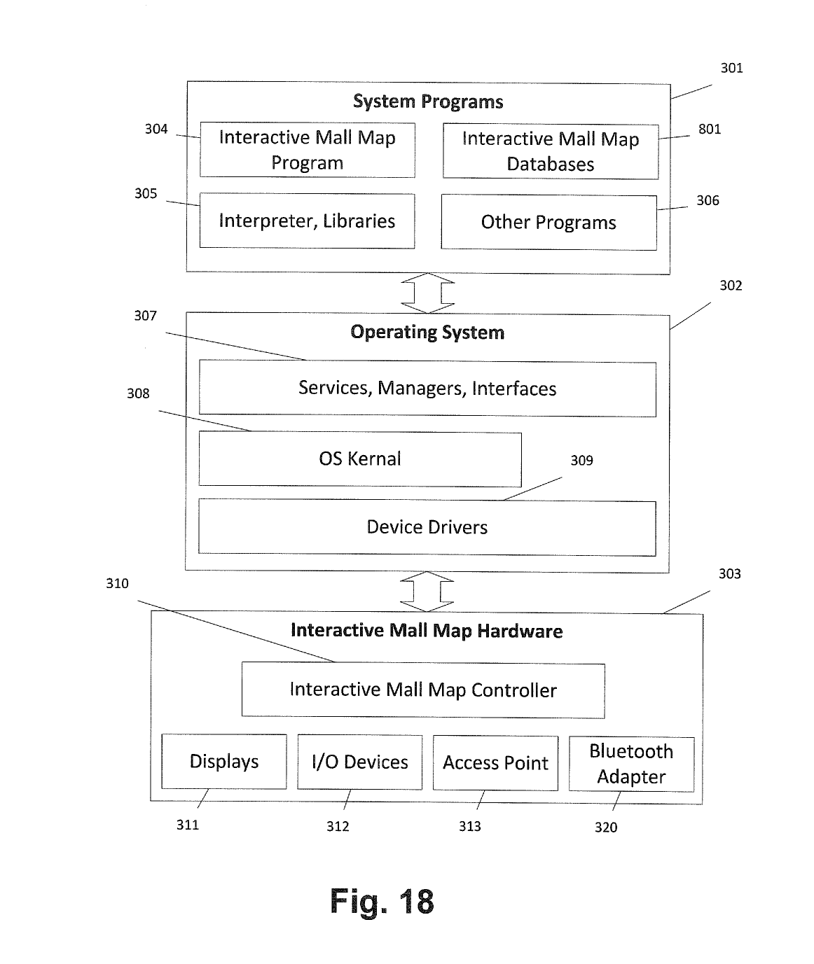

FIG. 18 is a block diagram illustrating the layered construction of the interactive mall map system 300 general operational structure from hardware interface to logical control program according to some embodiments. As shown in FIG. 18, the lower level block is the interactive mall map system hardware 303. The mid-level block is the operating system 302 and software drivers to interface the interactive mall map system hardware 303 for logical control operations. Top level 301 is the logical control program 301 for the interactive mall map system 300 which is able to perform data processing operations to achieve the functional results using the hardware components of system 300. The operating system 302 provides data interface between interactive mall map system hardware 303 and control program 301.

Block 303 illustrates the hardware of the interactive mall map system 300. Displays 311 are able to comprise touchscreen display 315 (see FIGS. 11 and 17), which provides input and output of information between the system and a user, and display 316 (see FIGS. 11 and 17), which provides output information to a user or group of users in viewable range of the system 300. I/O Devices 312 are able to comprise sensors 323, detectors 324, cameras 319, keyboard and mouse 321, speakers 326 and 381, and microphone 325 as well as I/O signal converter 322 and audio driver 327 (see FIGS. 11 and 17). Access point block 313 and Bluetooth adapter block 320 are used for data input and output operations. Interactive mall map system controller 310 interfaces input and output hardware devices 311, 312, 313, and 320 to software with the first level of low level software interface described by operating system block 302.

Block 302 illustrates components to efficiently link the hardware 303 of the interactive mall map system 300 to programs which enable the data processing to provide services, information and advertisements to users in visual range and mobile devices coupled to system 300. The components comprise of device drivers 309, operating system kernel 308, and software services programs, manager programs, and interface programs 307. The hardware to software interface component of operating system 302 is the device drivers 309. Device driver 309 comprise of all software programs to interface each hardware component to the operating system kernel 308, services programs, manager programs and interface programs 307 of the operating system as well as components of the system programs 301. Device drivers 309 can be specific to and defined by hardware used and operating system installed on system 300. OS kernel 308 is the core functionality of the operating system to function on system 300. Software services programs, manager programs and interface programs 307 are all programs and data files to support the functions of OS kernel 308 and to provide interface capabilities to interactive mall map system programs 301. Operating system 302 can be a commercial paid, open source, or custom software operating system to control the operation of and directs processing programs on the interactive mall map system 300.

Block 301 comprises of system programs which are the interactive mall map logical control program 304, any needed interpreter and libraries 305, interactive mall map databases 801, and any other software programs 306 to operate the interactive mall map system 300. Interactive mall map program 304 is a control program developed for the interactive mall map system to perform the functions in conjunction with other software and hardware components on the system 300. Interpreter and libraries 305 are software programs and data files to provide interface between interactive mall map program 304 and operating system 302. Additionally, some functions of interactive mall map program 304 can directly access operating system 302. The selection and use of interpreters and libraries 305 is determined by programming language or languages used to develop the interactive mall map program 304, operating system 302 selected for use, and the extent to which control functions are performed by custom developed control programs used or integrated third party software programs used. Other programs 306 comprise any other software program needed for operation and management of the interactive mall map system 300 such as a virus checker or software programs to monitor or perform service on a hardware or software component of the system 300.

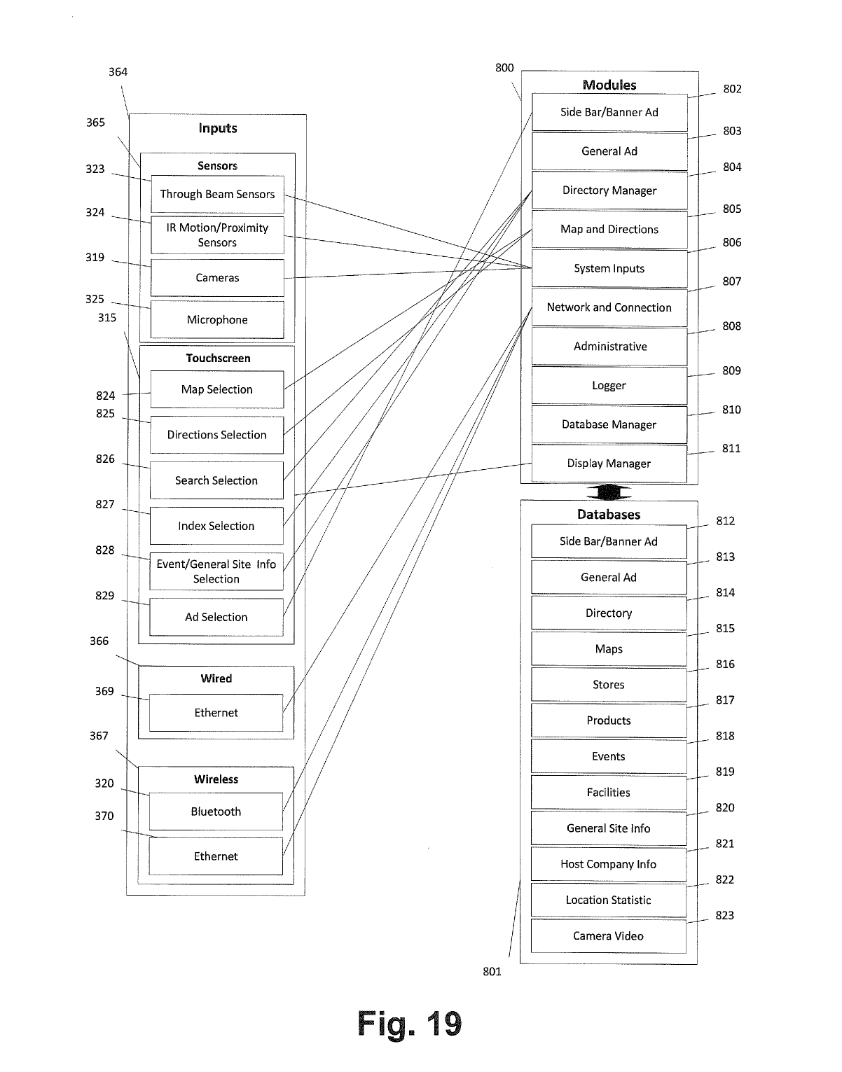

FIG. 19 is a block diagram illustrating system input methods and how they relate to functional blocks of the logical control program and database modules used for the operation of the interactive mall map system 300 according to some embodiments. The input block 364 comprises all the system inputs including both physical input devices and input methods. The functional modules 800 comprise the control program module which can include functional blocks of the interactive mall map system 300 control program. The databases block 801 comprises databases used to store and retrieve information for the interactive mall map system 300 control program. Block 364 inputs are segmented into blocks 365 sensors, block 315 touchscreen, block 366 wired connections, and block 367 wireless connections. Sensor block 365 comprise of through beam sensors 323, IR motion and proximity sensor 324, cameras 319, and microphone 325. Blocks within the touchscreen block 315 are input methods. Block 315 is the touchscreen display that was described in FIG. 11 and FIG. 17 but is shown in FIG. 19 with sub-blocks that represent input selections displayed on the screen of display 315 and used to link the user of the interactive mall map system 300 to information, advertisements, and services data through the touchscreen display 315. In some embodiments, the input selections are map selection 824, directions selection 825, search selection 826, index selection 827, event/general site info selection 828, and advertisement selection 829.

Map selection 824 represents a user selection option from the touchscreen display 315. On user selection 824, a displayed map which is able to result in the display of more detailed and related information about the selection. Directions selection 825 represents a user selection option from a displayed map or listing of points of interest, such as a directory for a site, which is able to display the user's current location and the destination location as well as possible routes between the two locations through the site covered by the system 300. Search selection 826 represents a user selection option using the search bar on the display which the user can enter a point of interest, a product, or any words that can be used to search for information, services or advertisements relating to the site of system 300 installation. Results from such a search are listed on the display for the user to make the appropriate selection. Index selection 827 represents a user selection options which comprises of a list of points of interests, services or advertisements from which a user can make a selection and more detailed information and related information to the selection is able to be displayed.

Event/general site info selection 828 represents a user selection option from which a user can select from a site map or list of events for the site, for any current or future events at the site, or special information about the site which results in the return display of more detailed and related information to the event. Advertisement selection 829 represents a user selection option from which a user can select any advertisement being displayed on the screen to get more and related information regarding that advertisement. More and related information includes but is not limited to information such as site stores that sell a product relating to the advertisement, or products sold by a store relating to the advertisement, or detailed description of a store or product from a selected advertisement, or specification for a product from a selected advertisement or pictures of the product or store relating to the selected advertisement.

Modules block 800 is shown with sub-blocks listing functional blocks of the interactive mall map system 300 control program. Database block 801 is shown with sub-blocks listing database blocks of the interactive mall map system 300 control program. In some embodiments, more or less modules are able to be a part of the system 300. Module block side bar/banner ad 802 represents the function which manages the side bar or banner ad which are displayed on the touchscreen display 315 and selected by the user through the ad selection interface selection 829. Data for display by the side bar/banner ad module 802 is stored and accessible on the system 300 in database 812 side bar/banner ad database but depending on user selections. Furthermore, the stores database 816, products database 817, events database 818 and host company info 821 can be accessed for more site store, product, event, or host information for display. Module block general ad 803 represents the function which manages the general advertisements which are displayed on the touchscreen display 315 and general display 316. Data for display by the general ad module 803 is stored and accessible on the system 300 by the general ad database 813. Module block directory manager 804 represents the function which manages the directory listing for the site of system 300 installation. Directory manager 804 manages content displayed on touchscreen 315 and manages user selections from the search selection 826, index selection 827, and event/general site info selection 828 inputs. Furthermore, while accessing data for display and selection is from the directory database 814, but depending on uses selection the stores database 816, products database 817, events database 818, facilities database 819, general site Info database 820 and host company information database 821 can be accessed for more information for display regarding site stores, products, events, facilities, general, or host information about the site.

Module block map and directions 805 represents the function which manages the map displayed and direction between the system 300 in use to a destination selected by the user at the site of installation. Map and direction module 805 displays the map on the touchscreen display 315 and manages user selections from the map selection 824 and direction selection 825 inputs, while accessing data for the map display and directions display from maps database 815. Depending on user selections the stores database 816, events database 818, and facilities database 819 is able to be accessed for more site store, event, or facility information for display. Module block system inputs 806 represents the function which manages the physical system inputs, through beam sensors 323, IR motion/proximity sensors 324, cameras 319, and microphone 325. System inputs 806 formats and stores data collected from sensor 365 to the location statistics database 822 and camera video database 823. In some embodiments, the microphone 325 input cannot be stored. Module block network and connection 807 represents the function which manages the data network connections through the wired Ethernet connection 369 and wireless Ethernet 370 and Bluetooth connection 320. Network and connection 807 manages the connections to the site server 201 (see FIG. 5) as well as connections to mobile devices 500 within range of the system 300. Some connection data is able to be stored in the location statistics database 822 such as but not limited to the number of mobile devices 500 coupled to the system with time stamp.

Module block administrative 808 represents the function which manages the version of control program installed on the system, ensures the databases are updated, and manages the unique system identifier for the system 300 along with other administrative control management activities such as background checks to ensure that everything is functioning as expected. Module block Logger 809 represents the function which manages the logging of activities on the system 300 and supports system Inputs module 806, Database manager 810, and network and connection module 807, while logging information to the location statistics database 822. Module block database manager 810 represents the function which manages access between all databases 801 and software module 800 which reads or writes to the database. Furthermore, management activities include but are not limited to ensuring no two module write to a database at the same time, ensuring the correct versions of the databases are installed on the system 300 and coordinate with the logger module 809 to log reads and writes to the databases. Module block display manager 811 represents the function which manages what multimedia information is displayed and when the information is displayed in frames on the touchscreen display 315 and general display 316. Display manager module 811 is able to call other control logic modules 800 to display multimedia information in display frames and can accept requests from other control logic modules 800 in response to user requests to have the display manager 811 update the display appropriately for the request made.

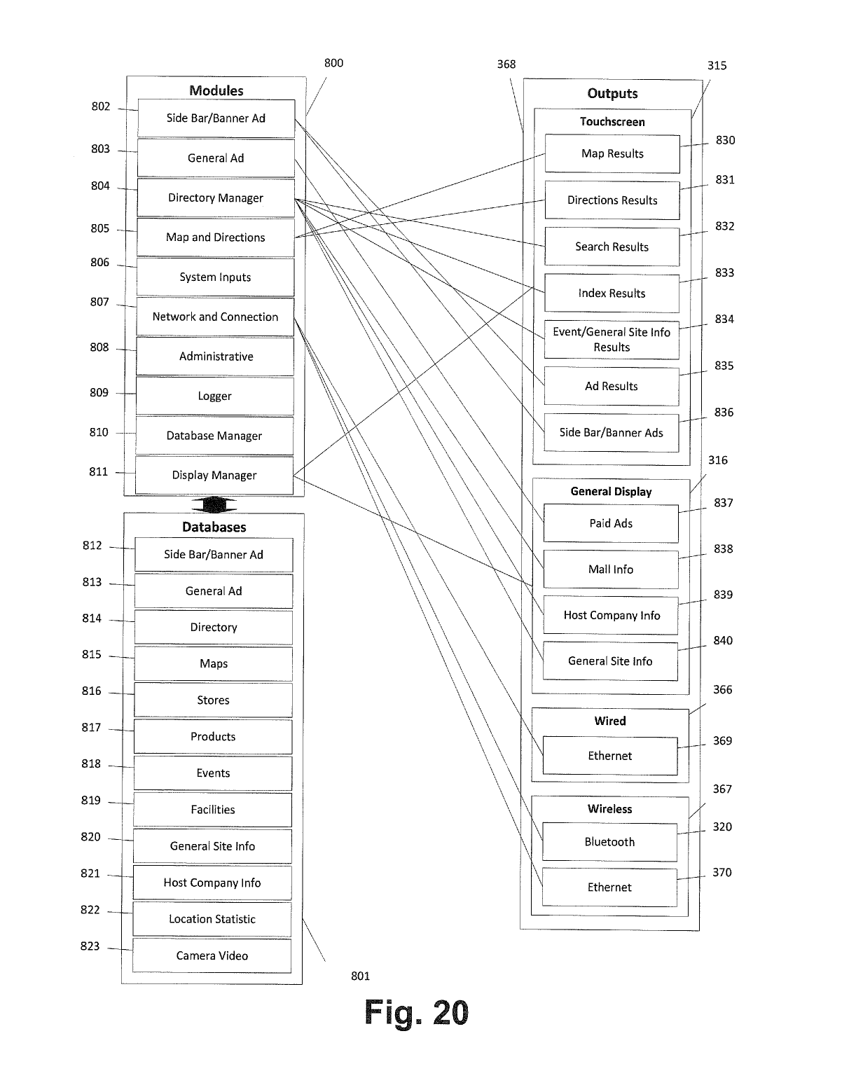

FIG. 20 is a block diagram illustrating the logical control program and database modules used for the operation of the interactive mall map system and how they relate to system output methods according to some embodiments. Specifically, FIG. 20 illustrates the output side of the interactive mall map system 300 whereas FIG. 19 illustrated the input side of the system 300. The module 800 and database 801 are the same modules and databases as described for FIG. 19. Outputs 368 are illustrated in four categories: touchscreen 315, general display 316, wired connection 366, and wireless connection 367. Wired connection 366 comprises the wired Ethernet connection 369 to communicate out from system 300 to the site server 201 (see FIG. 5). The wireless Ethernet connection 370 and Bluetooth connection 320 are able to provide output communication to mobile devices 500 coupled to the system 300. If wired Ethernet connection is not coupled to site server 201, the wireless Ethernet connection 370 is able to additionally serve as the data connection to the site server 201. Touchscreen display 315 illustrates the outputs displayed on the Touchscreen 315 instead of input selections.

Specifically, the outputs shown as blocks in the touchscreen block 315 in FIG. 20 are display results from related selections listed in FIG. 19 for the Touchscreen Block 315. Map Results Block 830 represents a map display managed by map and directions module 805 and can be from a resultant selection from map selection 824 from FIG. 19. Directions results output 831 represents a direction overlay on the displayed map managed by the map and direction module 805. Search results output 832 represents a search listing or map listing results from a user search and is managed by the directory manager module 804. Index results output 833 represents an index listing or map listing of items, such as but not limited to site stores and products, for display and possibly selection by a user and is manager by the directory manager module 804. Event/general site info results output 834 represents a display listing or map listing of the current site events or special site information managed by the Directory manager module 804. Ad results output 835 represents the display of an advertisement selection result with additional advertisement information as managed by the side bar/banner ad module 802. Side bar/banner ads output 836 represents the display of advertisement information for selection managed by the side bar/banner ads module 802. Additionally, other types of touchscreen 315 outputs are contemplated as well known in the art.

As shown in FIG. 20, the general display 316 comprises display outputs which can be shown on the display. Paid ads block 837 represents a display output of advertisements to be shown on the general display 316 and is managed by the general ad module 803. Mall Info block 838 represents a display output which can be an advertisement or general information multimedia display relating to the mall site of installation of system 300 and is managed by the directory manager module 804. Host company info block 839 represents a display output of advertisement or general information multimedia presentation relating to the host company of the system 300 and is managed by directory manager module 804. General site info block 840 represents a display output of general information multimedia relating to the site of installation of system 300 and is managed by directory manager module 804.

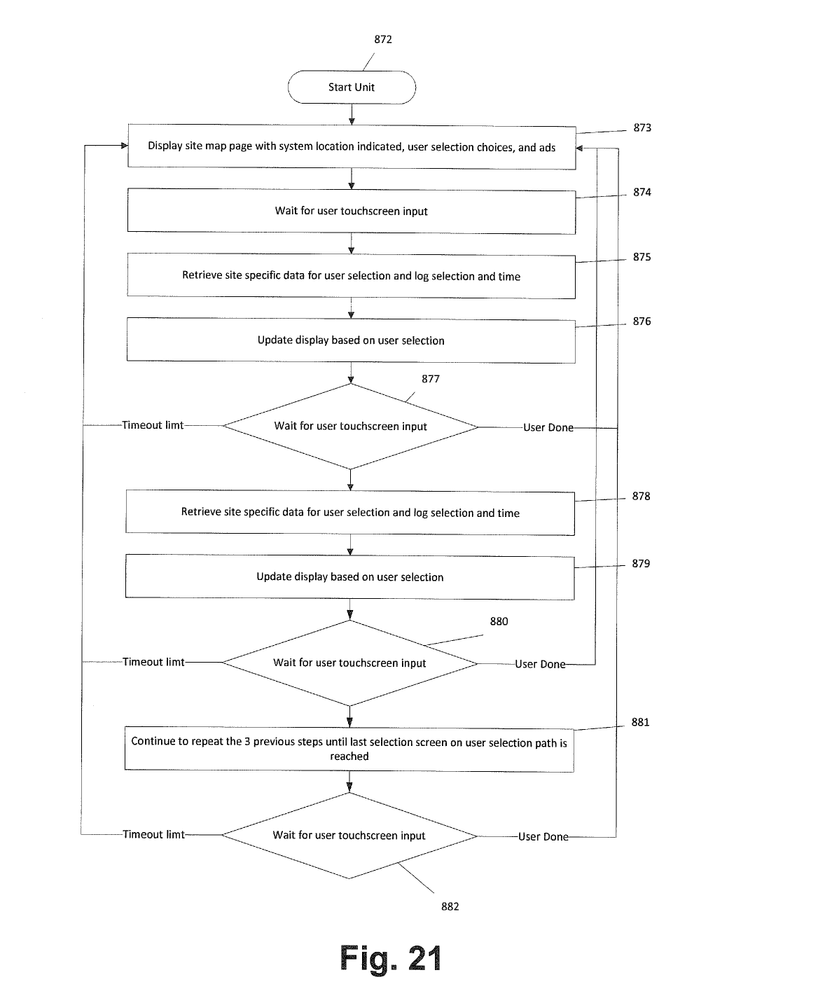

FIG. 21 is a flow chart illustrating the sequential general startup and general user input interaction with the interactive mall map system 300 according to some embodiments. Specifically, FIG. 21 illustrates the basic operation of system 300 during start up from a user's perspective and how it handles input in relation to users of the system. Block 872 represents the start of the system 300 operation. Block 873 follows block 872 and represents the display of the site map with the system 300 being used location indicated on the map, and with user selections available displayed as well as advertisements. Block 874 follows block 873 and represents system 300 waiting for input from a user. Block 875 follows block 874 and represents a selection made by a user. The selection results in the retrieval of data from the system 300 database and logging of the interaction with the user. Block 876 follow block 875 and represents the display of related information retrieved in block 875 in response to the user selection. Decision block 877 follows block 876 and represents the possible responses of the system 300 as the system waits for further user input from the touchscreen.

One path from block 877 represents a timeout condition where the user has not made a selection in a predetermined amount of time and system 300 has returned to block 873 to display the default site map. An alternate path from block 877 represents the user making a selection indicating they are done making a selection or is done using the system and the system returns to block 873 to display the default site map. An additional path represents the user making another selection shown by block 878 and data to complete the requested selection is retrieved from the system database and the selection can be logged. Block 879 follows block 878 and represents the display of related information retrieved in block 878 in response to the user selection. Decision block 880 follows block 879 and represents the possible responses of the system 300 as the system waits for further user input. One path from block 880 represents a timeout condition where the user has not made a selection in a predetermined amount of time the system 300 has returned to block 873 to display the default site map. An alternate path from block 880 represents the user making a selection indicating they are is done making selection or done using the system and the system returns to block 873 to display the default site map.

An additional path leads to block 881 witch represents the repeat of possible user selections down a selection path of choice for a user to gain the site information for which they are requesting from the system. The repeat of the selection path can be represented by a repeat of actions as described for block 877 to 880. The selection path is able to terminate at decision block 882 which allow two final paths. Decision block 882 follows block 881 and represents the possible responses of the system 300 as the system waits at the end of a selection choice sequence from a user. One path from block 882 represents a timeout condition where the user has not made a selection in a predetermined amount of time and system 300 has returned to block 873 to display the default site map. The other path from block 880 represents the user making a selection indicating they are done making selections or is done using the system and the system returns to block 873 to display the default site map.

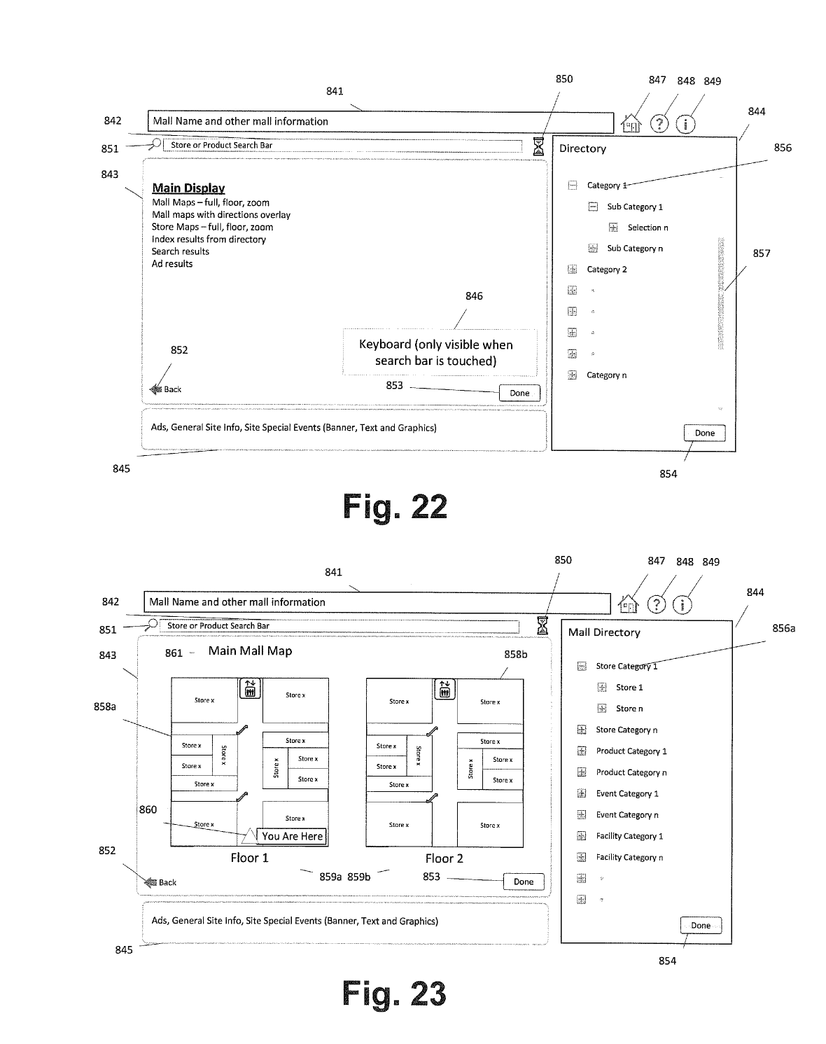

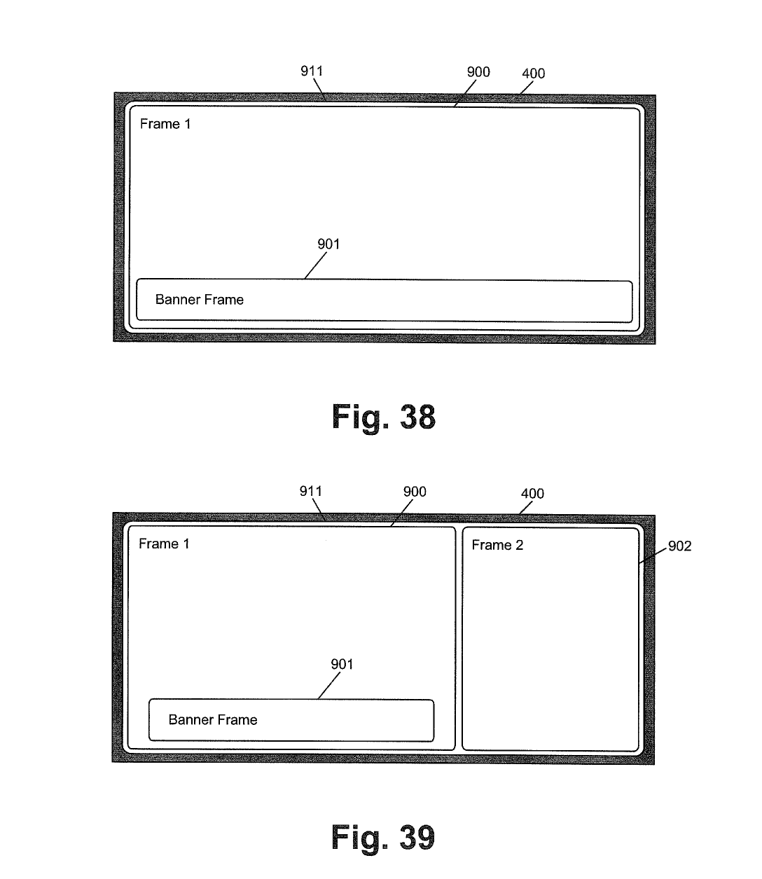

The display screen layout for the general display 316 for the interactive mall map system 300 is as defined for the advertisement display system 400 in FIG. 38 and FIG. 39. FIG. 22 to FIG. 27 illustrate screens using wireframe layouts showing the various screens that are able to be displayed on the touchscreen 315 of the interactive mall map system 300. The screen is able to be used to interact with users of the system 300 to provide services, information and advertisements based on interactions between the user and system. The proportions of the wireframes and display elements are generally shown in relative proportion to each other but can be changed to improve visibility, usability and aesthetics to meet user demand and customer demand. Furthermore, colors are able to be used to improve visibility and aesthetics to meet user demand and customer demand. Wireframe element outlines shown in the screens illustrate the locations and boundaries of each display element and the outlines can or can not be visible in a screen populated with multimedia. Selections of items in wireframe elements (See FIG. 22 to FIG. 27) are able to be logged and used to adjust advertisement score of advertisements to be displayed on site systems 300 and 400, including the system 300 in use by a user. Increase of this score is able to increase the chance of related advertisement to be displayed in the display wireframes of the system 300 and 400. Information displayed in the wireframe elements can be in the form of text, a tree structure, a tabbed structure, graphics, video or multimedia in various combinations on the main display within the wireframe elements. Many display elements are common in FIG. 22 to FIG. 27 and only elements not yet described in a previous figure is defined unless addition definition can be needed for a previously described display element. The term frame can be used in the following descriptions for FIG. 22 to FIG. 26 instead of wireframe and the term frame outline is used to describe a bounty area that comprises selectable and non-selectable viewable elements.

FIG. 22 illustrates a wireframe layout of the main screen for the interactive mall map system 300 showing the location and components of the content to be displayed according to some embodiments. As shown in FIG. 22, the wireframe layout comprises a heading display 841 that can display a text label such as but not limited to a mall site name and other mall information to promote the mall site to the user of the system 300. Frame element 842 represents a search bar where a user of the system can enter text to search for site related information such as stores, products, events, services, and facilities information from the system or site server database. Information can additionally be pulled from websites and other sources over the internet to support the search of site stores, products, events, services, and facilities information. When a user touches inside the search bar 842 and standard keyboard display 846 can become visible to enable the user to enter text, numbers and standard characters. Navigation buttons, Shift and Enter or Search buttons are able to also be visible on the keyboard display 846 to correct or refine an entered search and to initiate the search. Display element 851 is an icon to indicate to the user that the frame element 842 is a search bar. Furthermore, icon 851 can be selected by the user to initiate a search using text entered in the search bar.

Display element 850 is an icon which indicates to the user that the system is busy performing an activity such as a search and is able to only be visible when the system is busy. Frame element 843 represents the main display area which contains viewable and selectable elements to a user such as but not limited to site map views, directions overlay on the maps, store maps, index results, search results and advertisement results. Display element 852 is a navigation button which allows the user to select it and to navigate to a previously viewed screen and content. Each selection is able to update the display in the main display frame 843 one screen view at a time until the screen view has returned to the original default screen view. At the main default screen view, the main display area 843 is able to be hidden. Display element 853 is a button which can be selected by the user to indicate to the system that they have completed their use of the system and can be interpreted by the system as an indication to return to the main default screen view. Frame element 845 represents a multimedia display area and can display items such as but not limited to advertisements. Advertisements displayed in frame 845 are able to change or be replaced based on a score of the advertisements, and further are selectable by the user where a selected advertisement can cause the main display 843 and any frame display element in main display 843 to update with additional information about the advertisement.

Display element 847 is a user selectable home button which is able to cause all frames on the display screen of FIG. 22 to return to the default main screen view. Additionally, if a predetermined about of time has passed without a user selection or system sensor detection and/or related control functions determine the user has moved away from the system, the displayed screen view is able to automatically return to the home default screen view. Display element 848 is a user selectable help button which on selection is able to cause a help window to popup and overlay a portion of the currently displayed screen. The help window is able to list help topics and tips to provide the user with help on using and navigating the currently displayed screen as well as any other help information that can be considered relevant to the user to use the system. A close or done button is able to also be displayed on the help window which is selectable to close the help window and return to the unobstructed view of the screen before the help display element button 848 was selected. Additionally, the help window is able to close without user selection if no selection is made from the help window in a predetermined about our time.

Display element 849 is a user selectable information button which when selected is able to display an information popup window providing the user with general information about the system and site of installation. A close or done button is able to also be displayed on the information window which is selectable to close the information window and return to the unobstructed view of the screen before the information display element 849 was selected.

Additionally, the information window is able to close without user selection if no selection is made from the help window in a predetermined about our time. Frame element 844 represents an information display and navigation area. The area can be used as a directory display section on the main display which can be used to present to the user a selectable directory listing of site related categories such as stores, products and services. The categories display element 856 can be site related categories such as stores, products, events, services and facilities shown in tree structure which each parent category being selectable to reveal related subcategory or child categories of the main parent category selected. The level of child categories displayed can continue down to a level where it can be determined to be sufficient to give the user of the system the site information needed to locate it in the site and gain site shopping related information for a specific subcategory such as store, product, event, service and facility.

The selection of a category or subcategory 856 can cause the multimedia information displayed in the main display frame 843 and advertisement frame 845 to update with relevant information in response to the user selections map from the categories display element 856. Frame element 857 is a scroll bar to enable the user to navigate the categories and subcategories of the category display 856 when expand to a point when all display elements do not fit within the viewable area of the frame 844. The other element of 844 is the display element 854 which is a user selectable done button which when selected updates the display directory frame 844 to return to the original default display of categories 856.

FIG. 23 illustrates a wireframe layout of the main screen with example display elements for interactive mall map system according to some embodiments. The main screen wireframe layout of FIG. 23 is substantially similar to that of FIG. 22 except for the differences described herein. In main display view 843 a map is displayed showing a map of two floors of the site of installation 858a and 858b. Also, a text heading 861 and display elements 859a and 859b indicate the view being presented to the user of the system. The map displays 858a and 858b are able to comprise items such as walkways, entrances, stores, stairs, escalators, elevators, restrooms located within the mall site or other mapping items. Another display icon 860 is the location of the system being used in the mall site. Some or all of the elements displayed on the map are selectable by a user, which is able to cause a popup window to be displayed, or an information overlay such as directions to be displayed, or cause a change in the view display in frame 843, to present the user with relevant information based on the user's selection.

Some display element labels 859a and 859b when selected by the user can cause a change in the display from 843. For example, if display element label 859a is selected, frame 843 is able to update with an expanded display of only the floor 1 map. Other elements used to navigate and view displayed views in frame 843 such as a ‘+’ or ‘−’ symbols for zooming or using a two touch motion method to zoom in and out of a view in frame 843 with arrows and single drag touch to navigate the zoomed frame display. Site category display tree 856a is shown with listed parent categories for stores, products, events, and facilities with stores listed as store type categories listed as parents and each store listed as children subcategories.

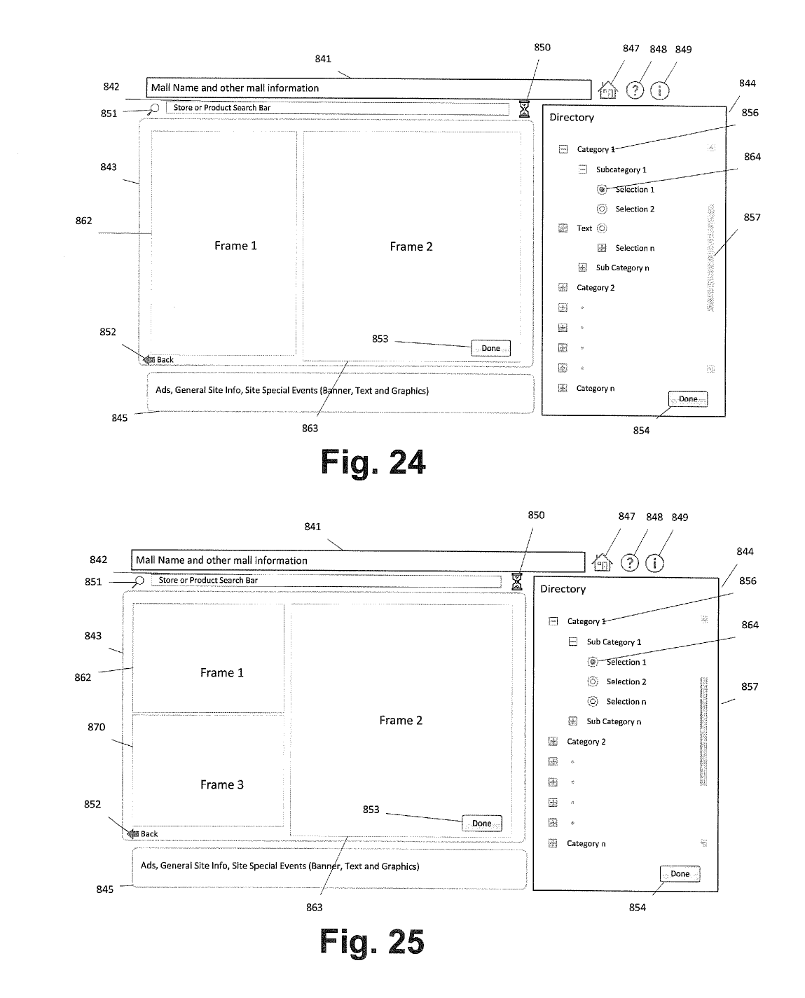

FIG. 24 is an illustration showing a wireframe layout of the interactive mall map system screen in an alternate view to display information and respond to user selections according to some embodiments. Frames are shown in general size relationships to each other but can be scaled to a size as needed to accommodate the information to be displayed. Frame 843 is shown divided in two frame elements 862 and 863, which individually can show site related information in the form of text or multimedia with or without selectable links to more information. Frame element 862 can display selectable view items such as a mall site map or store map while frame element 863 can display selectable view items such as a tabbed display or site products, stores, facilities, or events which can be displayed in response to selections map on a map in frame 862. Furthermore, frame 863 can show the same items listed above in response to selections from the directory category listing 856 by selection of a radio button 864 from a subcategory which can be used as a method of further information selection from a user navigating the directory tree frame elements 844. Furthermore, subcategory radio button 864 enables a user to make a selection from the directory that does not open any further child subcategories, but displays additional information relating the labeled selection next to the radio button 864. The display element done button 853 can reset the dual frame view of FIG. 24 back to the default display described for FIG. 23.

FIG. 25 is an illustration showing a wireframe layout of the interactive mall map system screen in an alternate view showing more display frame elements to show site related information and respond to user selections according to some embodiments. Display frame 843 is divided into three separate frames, frames 862, 863, and 870, which individually can show site related information in the form of text or multimedia with or without selectable links to more information. Frames are shown in general size relationships to each other but can be scaled to a size as needed to accommodate the information to be displayed. Frame 862 and frame 870 are smaller than frame 863 and can comprise small displayed information such as partial or full store or mall site maps and tabbed listing of advertisements, products, site stores, site events and site facilities. Furthermore, frame 862 or 870 can show multimedia display of information such as video advertising for products or for site stores. User selections made in any frames on the display can change the content displayed in the frames. Display frame 863 can comprise display elements which can need more display space to be easily viewable and selectable by a user of the system 300. Frame 863 is able to comprise elements previous described for FIG. 22 to FIG. 24, but can also include an tree structure which is able to be used as a selectable index of site related items such as products or stores which on selection by a user are able to cause an update of frames 862 and 870 with related information. As previously defined, the display element done button 853 is able to reset view of FIG. 25 back to the default display described for FIG. 23.

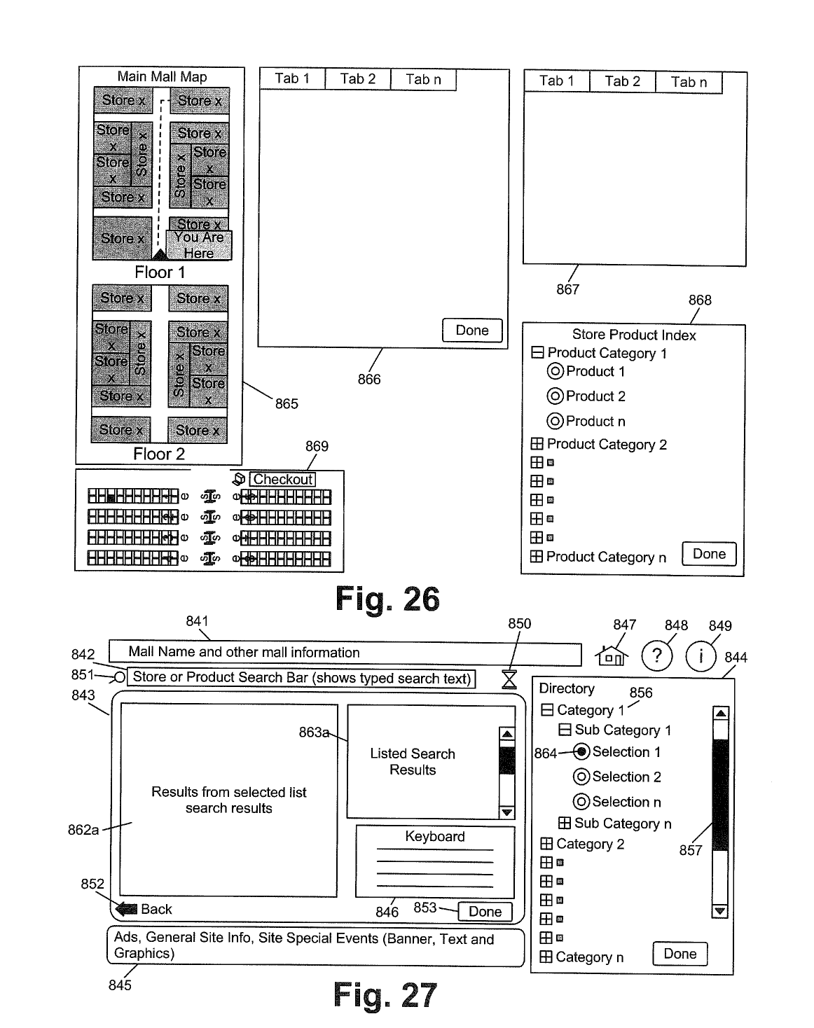

FIG. 26 is a collection of illustrations showing selectable display elements which can be shown in the frame outline elements 843, 862, 863, and 870 previously described in FIG. 18 to FIG. 25 according to some embodiments. Display element 865 represents a site mall map showing a map of the site and location of the system in use as well a direction overly showing a path between the system in use and selected store by a dotted line. The user can make selections from the display element to get information about an item on the map such as a store. The map also comprises labels and titles to give the user more information about the map. Display frame element 866 represents a frame with selectable tabs to display more information than the frame can fit in one frame page. Frame 866 can be used to display information relating to products which can be separated into tabbed pages listing site stores that sale products of interest, show product specifications, show any sales on the products of interest, and images of the product. Furthermore, a store's advertisements can be displayed in separate tabbed pages similar to what can be done in multipage store sales papers. Still furthermore, site event information can be displayed in each tab as an event.

A done display element is shown in frame 866 and is able to be used to reset an entire display view back to a default view. Frame 867 also is a tabbed frame display element but is able to go into a small frame outline and is able to function as described for frame 866 but can show a smaller set of information. Frame element 869 represents a store map showing isles of a store with products on shelves, labels and other standard display elements to present a user with information on a store of interest. Products on the shelves can be shown with boxes and a highlighted box can indicate a product for which a user can be searching. Frame element 868 is an index listing to provide a user with a listing of information of interest such as a product listing for a store with products separated into categories and with child subcategories and finally selectable products which can be used to show on a store map 869 when selected by a radio button from the index. A done display element is shown in frame 868 and is able to be used to reset an entire display view back to a default view. Additionally, scroll bars can be used to aid the navigation of the index when more information is available than can clearly be displayed in the frame.

FIG. 27 is an illustration showing a wireframe layout of the interactive mall map system screen in an alternate view showing a layout for a user search and resultant display according to some embodiments. As described when discussing FIG. 22 above, the search bar 842 is the area where a user search text is able to be entered. Upon selecting anywhere inside the search bar 842 the screen can change display to the format shown in FIG. 27. Frame outline 843 is able to comprise frame elements 862a, 863a, 846 and display element button 853. Frame element 846 represents the keyboard as described for FIG. 22 which is able to enable the user to enter text, characters, and to refine and navigate entered text that is displayed in search bar 842. After the search text is entered and the display element 851 is selected or the search button is selected from the keyboard 846 search results are displayed in frame 863a in a listed format and can comprise short descriptions of each result. Frame 863a can comprise scroll bars for navigation of the displayed result list. Items in the frame 863a list are selectable and upon selection of an item by a user, the selection causes frame 862a to update with additional information about the selected listed item from 863a. The information displayed in frame 862a can comprise information such as a map with location of a store searched, a location of a product searched, time and location of an event searched, advertisements for a product, store or event searched, or facilities or services at the site searched. A done display element is shown in frame 843 and is able to be used to reset an entire display view back to a default view and is able to clear the search bar of searched text.

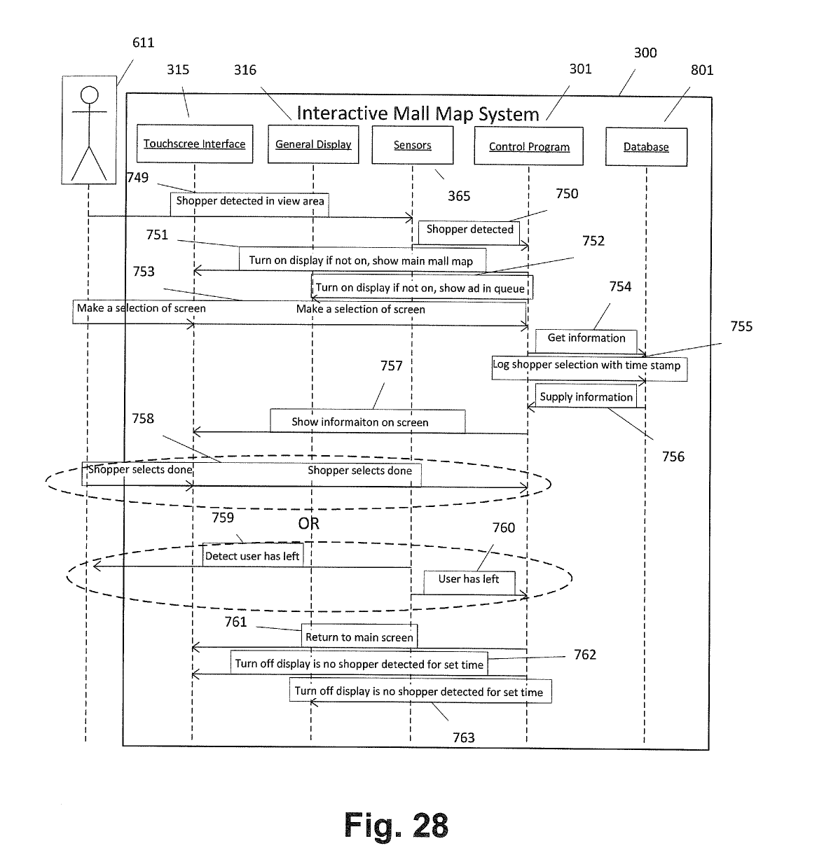

FIG. 28 is a sequence diagram illustration showing a method of user detection and touchscreen selection for the interactive mall map system according to some embodiments. Element 611 represents a user who is able to move into view range of the system 300, make selections on the touchscreen display 315 and/or moves out of touch range of the system. The interactive mall map system 300 is represented by a boxed outline comprising select elements of the system, touchscreen 315, general display 316, sensors 365, control program 301, and/or database 801. At action 749, the user 611 comes within view range of system 300 and is detected by the sensors 365 on the system. At action 750, sensors 365 update control program 301 with the detection of user 611 within viewable range of the system. At action 751, the control program 301 turns on the touchscreen display 315 if it is not already on and shows the default site map view screen. At action 752, the control program 301 turns on the general display 316 if it is not already on and displays the first advertisement with highest advertisement score from the general advertisement database. At action 753, after the user 611 has been detected and displays 315 and 316 are on (because the user is within touch range of the system 300), the user makes a selection from the touchscreen 315 default display. This selection from the touchscreen 315 is able to be relayed to the control program 301.

At action 754, the control program 301 requests data in response to the user selection from the system database 801. At action 755, the control program 301 logs the user selection with time stamp to the database 801. At action 756, the database 801 sends a reply to request 754 to the control program 301 with the data to satisfy the request. At, action 757, the control program 301 updates the touchscreen display 315 with service and advertisement information in response to selection 753 to provide the user 611 with site related information such as products, site stores, site events, site services, and site facilities information. Next, action 758 or 759 and 760 are able to occur. At action 758, the user 611 selects the done display element on the touchscreen display 315 which is forwarded to the control program to indicate the user has completed use of the system 300. Alternatively at action 759, the user 611 leaves viewable range of the system 300 and sensors 365 detect that user 611 has left. Next, at action 760, sensors 365 signal control program 301 that the user has left viewable range of the system 300. As a result, at action 761 the control program 301 resets the displayed view on touchscreen display 315 back to the default main screen in preparation for the next user. At action 762, the control program turns off the touchscreen display 315 if no user is detected within viewable range of the system within a predetermined amount of time. At action 763, the control program 301 turns off the general display 316 if no user is detected within viewable range of the system within a predetermined amount of time. This turning off displays 315 and 316 when no user is in viewable range helps preserve the life time of the displays as well as conserve power usage.

### Advertisement Display System

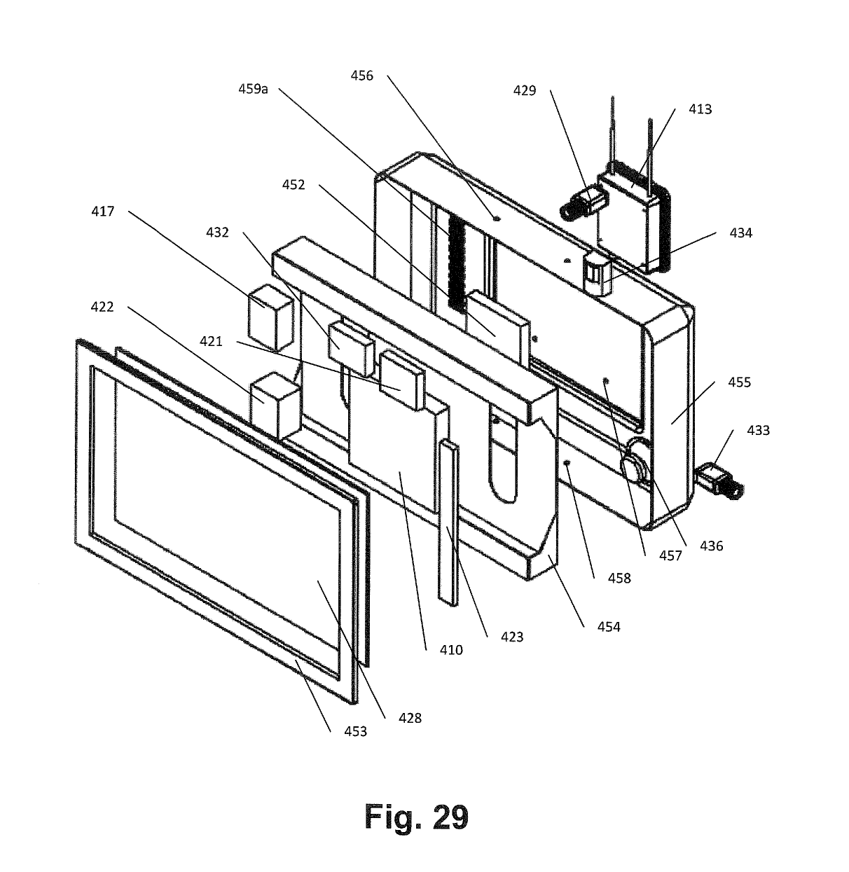

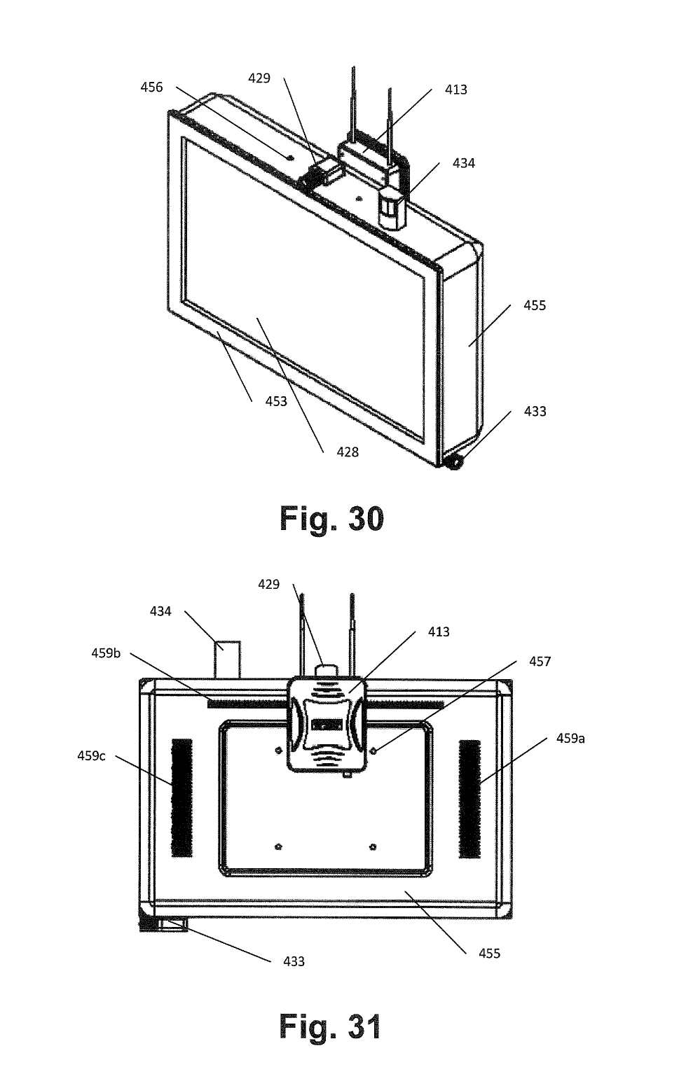

FIG. 29 illustrates a front isometric exploded view of the advertisement display system 400 and FIG. 30 illustrates an assembled front isometric view of advertisement display system 400 according to some embodiments. As shown in FIG. 29 display 428 comprises of a display panel such as an LCD or LED display with possibly a protective covering such as glass with coatings to minimize any impact damage to the display panel and reduce any glare for surrounding light sources. Display 428 is able to present information such as service and advertisement information to shoppers in viewable range of the system 400. Edges of display 428 are able to be protected and concealed from shopper view by front cover 453. Front cover 453 also serves as an addition protection from incidental impacts and frames the viewable area of display 428. Size of the front cover 453 is able to be determined by the size of display 428 and is able to extend to a width beyond display 428 to couple to back cover 455 without a space between the covers 453 and 455 that enables dust or other foreign materials into the unit between the covers. Covers 453 and 455 can be constructed of a material such as but not limited to synthetic polymer and be of a color and sheen to not distract a user's view from the display 428 in the installed environment.

Support frame 454 is an internal frame structure that supports all internal components enclosed by covers 453 and 455 on the advertisement display system 400 as well as the display panel 428. External components depending on weight of the components can also be coupled to frame 454 through the external cover. Frame 454 can be constructed from a single piece of metal, such as but not limited to steel or aluminum, welded or machined, or assembled from a plurality of metal welded or machined parts coupled by fasteners. Thickness and construction of the material used must be to an amount and construction which can support the weight of the system 400 when secured by mounting holes 456 or 457 and not deflect to the amount where secured components are able to be stressed and damaged or be visible when viewing an assembled installed system. Metal can comprise a passivation layer to prevent corrosion. Features on support frame 454 include mounting holes which can be threaded to secure the internal components to set positions on the frame directly or with the use of stand-offs.

Furthermore, penetrations through the frame can be needed to allow the routing of interconnects between components and promote air flow for cooling. Other mounting holes can be used to couple the system 400 to a mounting fixture at the site of installation to put the display system 400 at a viewable height for a shopper. Holes in back cover 455 enable fasteners to pass through the back cover and couple directly to support frame 454. Furthermore, stand-offs or other metal components can be used to facilitate the connection of the system 400 to the site mounting fixture through the back cover 455 to frame 454 which enables a space between the frame 454 and cover 455 for the installation of internal components. The stand-off or other metal components should be at a size, and the mounting location on the frame 454 must also be at a thickness and construction, to support the weight of the system with the added points of stress from any extended mounting components.

Device 410 is the printed circuit board controller for system 400 and is shown in FIG. 29 installed onto frame 454 behind the display panel 428. Controller 410 is a printed circuit board system for controlling the system. In some embodiments, this can be a computer motherboard with video card or motherboard with integrated video functions. In alternate embodiments, the controller 410 is able to comprise any specifically designed circuit board, a complete personal computer, or a compilation of circuit boards to provide control for the system. Placement of controller 410 is able to be in an area to minimize electrical wiring, electrical noise, and meet cooling specifications of the controller. Device 421 is non-volatile data storage device such as a hard drive coupled to controller 410 to provided data storage for system 400. Although a single block is shown for hard drive 421 for ease in illustration, a plurality of hard drives are contemplated (e.g. in a redundant configuration such as a RAID configuration). Alternate embodiments comprise of a single hard driver or more than two to provide sufficient storage, access speed, and data protection. Device 432 is a converter module to convert input and output signals such as a digital signal to a serial data stream, such as USB, which is coupled to controller 410. Signal converter 432 takes signals from sensors placed on the system 400 such as through-beam and proximity sensors and convert these signals in a data stream that can be interpreted by controller 410. In alternate embodiments, the converter 432 can covert both digital and analog signals and the data stream is able to also be Ethernet or other high speed data connection. Furthermore, converter 432 can be integrated into controller 410 or comprise of more than one converter device. Placement of converter 432 is on frame 454 is able to be in a location to minimize electrical wiring and noise, and comply with the data connection media length to the controller 410.

Device 452 is the printed circuit board controller for the display 428 and is installed on the frame 454 and shown in FIG. 29 mounted between the frame and back cover 455. In alternate embodiments, the controller 452 can be installed directly on or integrated with display 428 an installed on the other side of frame 454 closer to the display 428. The alternate install location can be based on size of internal components, interconnect length specifications, design of display 428 with associated controller 452. Furthermore, placement of controller 452 is able to be in an area to minimize electrical wiring, electrical noise, and meet cooling specifications of the controller. Controller 452 is shown as one device in FIG. 29 but can be constructed of a plurality of printed circuit boards coupled by wired interconnects or directly coupled printed circuit boards.

Device 423 is the backlight module for the display 428 which is shown in FIG. 29 and is installed between the display and frame 454. It can also be installed on or integrated directly to display 428 depending on the design of display 428. Backlight module 423 provides the backlighting for the proper function of LED and LCD displays, as well as other related displays requiring a back light, by providing a light source to the display as well as including some control components required for the operation of the module 423. Size and design of the backlight can dependent on the design of display 428 which can be used and should meet the specifications defined for display 428.

Device 417 and 422 are power supply units and are shown in FIG. 29 installed on frame 454 behind the display 428. They can alternately be installed behind frame 454 between the frame and enclosure 455. Power supply 417 is the power supply for the advertisement display system controller 410 and attached sensors and support components which are not directly related to the display 428. Power supply 422 is the power supply for display 428 and related components for the operation of the display such as shown display controller 452, backlight module 423 and the display panel 428. Power supply 417 is a DC supply which can supply voltages and power at levels needed for the operation of coupled components. DC supply 417 can comprise a cooling fan which maintains the temperature of the supply in the specified operating and the supply fan or the addition of an external fan can also be used force air through the system 400 to cool other internal components. In an alternate embodiment, the DC supply 417 is able to comprise of more than one DC supply. Power supply 422 can be constructed as an open frame supply on a printed circuit board or can be an enclosed power supply depending on the power specifications and design of the display 428 and related support components. In an alternate embodiment, power supplies 417 and 422 can be combined into one power supply unit with a plurality of outputs.

Back cover 455 completes the enclosure of all sensitive electronics and prevents accidental damage to the unit from impacts. Furthermore, the cover comprises vent holes or slots 459a to allow proper cooling air flow and the release of heater from internal components, mounting holes for the attachment of external components, and mounting holes 456 and 457 for the mounting of the unit itself at the site of installation. Mounting holes 456 and 457 can be through holes to allow fasteners from a site mounting fixture to pass through the cover 455 and couple directly to frame 454. Fastener features such as screw holes or other fastening features such as slotted snap lock or tabbed snap locks can be incorporated into the back cover to attach the back cover 455 to the front cover 453 as well as connecting the back cover to the support frame 454. The support frame 454 can provide some structural strength to the back cover 455. The thickness of cover 455 should be to an amount to prevent visible deflection of the cover to a shopper in close proximity to the system as well as to withstand an impact that can be typical in an environment such as a shopping mall as well as during transportation and installation. Depth of the cover should be enough to fully enclose all internal components to the system 400 and allow cooling air flow.

Mounting holes on the external area of the cover can be used to mount components with light weight such as sensors 433 and 434 and a camera 429 and possibly the wireless access module 413. If the weight of any externally installed component exceeds the capacity of the enclosure to support the weight, or shows visible deflection, then through holes are able to be used in the cover 455 allowing the mounting to the support frame 454. In an alternate embodiment, the back cover 455 can comprise of two parts: one part covering the back of system 400 and the second covering the sides of the system. In a two part cover design, the covers are able to be assembled with fasteners or other fastening features such as slotted snap locks or tabbed snap locks. Attached to back cover 455 in one embodiment, or to the frame 454 in an alternate embodiment of the invention, are speakers 436. Although one speaker is shown in FIG. 29 a plurality of speakers or no speakers are able to be used. The speakers 436 are able to be placed in a location on system 400 to enable people, such as, shoppers in close proximity of system 400 to hear the sounds from the speakers 436. Sounds from the speaker are able to correlate with multimedia being displayed on display 428. In FIG. 29, the speakers 326 are illustrated facing the back of system 400, but can be installed facing the side and can be of a smaller size than shown in FIG. 29.

Sensor 433 is shown in FIG. 29 mounted to the bottom and close to the side of cover 455.

Sensor 433 is used to detect a shopper or any person who passes by the advertisement display system 400. The sensor can be of a through beam type with a reflector mounted at the entrance of installation, a proximity sensor such as an ultrasonic sensor, and/or other related sensors capable of detecting a person passing within proximity of the sensor. Although FIG. 29 shows one sensor, a plurality of sensors are able to be used. For example, two sensors can be installed if the system 400 is mounted between two entrances ways with one mounted on each side of the system. Detector 434 can be an infrared motion detector or other similar detector to detect a person coming within viewable range of the system. It can be installed in a position to ensure full coverage of the front areas of the system 400 without the detector being blocked by surrounding obstacles in the area of the system 400. To accomplish this, the detector is able to be installed at a high level such as at the top of the system. The detector is able to be used to trigger an event when a person is in viewable range of the system, such as turn on displays if off or turn off displays if no person is detected in viewable range for a predetermined time.

Camera 429 is used to detect people in viewable range of the system 400 and the video or images can be logged for later review if necessary. Camera 429 is installed in a location on top of system 400 and positioned in a way to give a clear view of the users in front of the system which are in viewable range. Camera 429 enables features which can require video or in a situation where video is able to enhance a service such as recognizing a person or making an approximate recognition of a person by clothes color to provide more relevant advertising based on a person's interactions with site interactive mall map system 300. Furthermore, camera 429 is able to be used monitor system 400 for vandalism of the system and provide images of the person causing damage to the system. Although as shown in FIG. 29, the system 400 comprises a single camera, a plurality of cameras (e.g. to cover a wider area of view as well as behind the system display 428) is contemplated. In an alternate embodiment, camera 429 can be installed inside cover 455 and a view port for the camera is constructed by creating an opening in front cover 453.

Wireless node 413 couples the system 400 to the site wireless data network. Wireless node 413 is able to be a wireless access point with wired data network connection and network switching capability. As shown in FIG. 29, the wireless node 413 is coupled to the outside back of cover 455 at the top portion enabling the antennas from the wireless node to be at a level higher than top of cover 455. Alternatively, the wireless node 413 can be inside cover 455 with or without the antennas being exposed to outside the cover 455 or other orientations that can provide increase signal strength when installed on system 400. Alternatively, the wireless node 413 is able to be a printed circuit board coupled directly to controller 410. Furthermore, wireless node 413 couples controller 410 to the site wireless network 202 and is able to also function as a wireless access point for connection of site mobile devices 500 within range to the site wireless network 202. Still further, the node 213 is able to be the wireless data network link between mobile device 500 in proximity of system 400 and the database stored on system 400.

FIG. 31 is an assembled back view of advertisement display system 400 according to some embodiments. As shown in FIG. 31, vents 459a-c are able to be placed in locations on back cover 455 to enable cooling air flow and release of heater from internal components to ensure the temperature specifications of the internal components are not exceeded. The vents 459 can be place in a horizontal row as shown by vent 459b or vertical row as shown by vents 459a and 459c. In alternate embodiments, there can be a plurality of columns and rows of vertical and horizontal vents at location throughout the back cover, such as lower back bottom area of cover 455, the bottom or top of cover 455, or sides of cover 455 to meet the thermal specifications of the internal components installed in system 400.

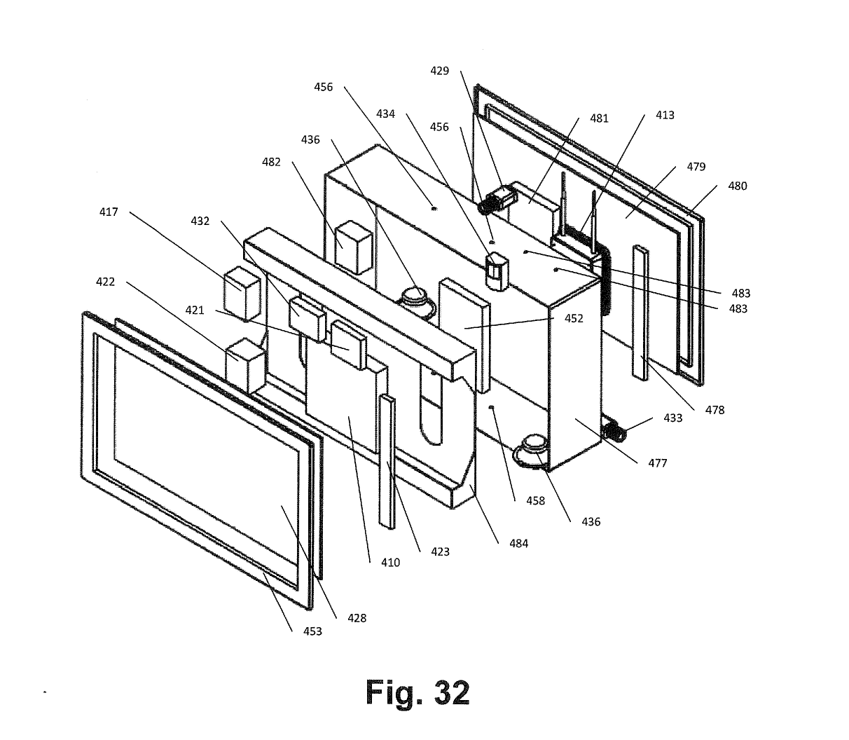

FIG. 32 is an illustration of an alternate advertisement display system which uses two display panels and is shown as an exploded isometric view according to some embodiments. The dual display advertisement display system shown in FIG. 32 is an alternate configuration of the advertisement display system 400 which is constructed with a display on the front and back of the system for multidirectional display. The system of FIG. 32 is substantially similar to the system 400 described above except for the differences described herein. As shown in FIG. 32, the wireless access node 413 is inside the double display advertisement system and can be mounted to the internal frame 484. The cover 477 replaces back cover 455 from FIG. 29. Specifically, the cover 477 is used to enclose the space between both displays 428, 479 and enclose support frame 484 and internal components. The cover 477 comprises features to couple display covers 453 and 480 to form the complete enclosure as well as installation through holes 456 and through holes 483. Furthermore, cover 477 is able to comprise features to fasten the cover to the internal frame 484 possibly from the sides, top and bottom. Still further, features such as cooling vent holes can be incorporated around cover 477 to provide ventilation to ensure internal component operate in their specified temperature range when the system is operated in a typical room temperature environment.

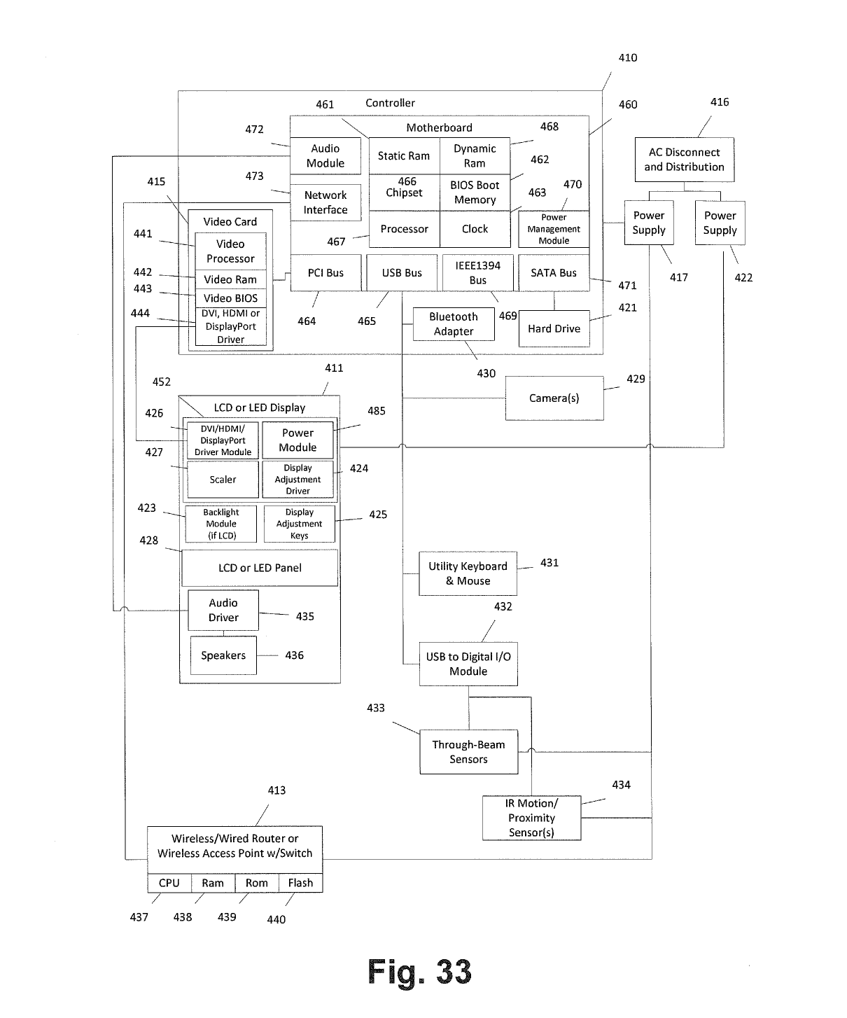

Hole 483 enables the antennas of wireless node 413 to protrude and can not be needed if the antenna for the wireless not is routed inside the enclosure system enclose. Internal frame support 484 is similar as internal frame support 454 from FIG. 29 with the exception of changes to supporting feature to couple cover 477 to the frame 484. Furthermore, additional support feature can be needed to secure the second display hardware as can be done with the first set of display hardware described in FIG. 29. The second set of display hardware comprises of display panel 479, controller 481, power supply 482 and backlight module 478. Display panel 479 is mounted to back side of frame 484 and functions as described for display 428 in FIG. 29 except for the use as the second monitor display and can be identical to display panel 428. Controller 481 is mounted to the back side of frame 484 and is the controller for the second display 479 and couples to system controller 410 and is powered by power supply 482. Controller 481 functions as defined for controller 452 in FIG. 29 but is coupled and supports the second display 479 and can be identical to panel 452. Power supply 482 is mounted to the backside of frame 484 and powers panel 479, controller 481, and backlight module 478. Power supply 482 is able to get power from an internal power distribution device such as described for device 416 for FIG. 33. Furthermore, power supply 482 can be identical to power supply 422 and functions as described for supply 422 in FIG. 29 but for the support of the second display. Backlight module 478 is the backlight module for the second display panel 479 and is installed and functions as described for backlight module 423 in FIG. 29 and can be identical to module 423. Display cover 480 covers the second display panel 479 and is installed, constructed and functions as described for cover 453 in FIG. 29 with the exception of cover the second display panel and can be identical to cover 453.

FIG. 33 is a block diagram showing electronic components of the advertisement display system 400 showing general connection and grouping relationships according to some embodiments. Specifically, FIG. 33 provides additional details of some components described in FIG. 29. The device 416 is an AC power distribution device which can provide features such as AC disconnect, overcurrent protection, overvoltage protection and distribution. The functions of device 416 can alternately be incorporated in the power supplies 417 and 422. Device 416 is shown coupled to device 417 and device 422, DC power supplies, to supply AC power to DC power supplies. In an alternate embodiment, AC distribution device 416 can couple to controller 410 and wireless node 413 to supply power to these devices instead of power supply 417. In such embodiments, the devices are able to have individual coupled or internal power supplied to provide DC power to each individual device. FIG. 33 shows in one embodiment the DC power supply device 417 coupled to the system controller's 410 power management and distribution module 470, wireless node 413, sensor 433, and detector 434. USB to Digital I/O Module 432 and camera 429 can additionally need DC power supplied from DC power supply 417 depending on the type of module and camera installed. Power supply device 422 is coupled to the power module 485 of the display 411 and supplies the power to meet the specifications of the display. In an alternate embodiment power supplies 417 and 422 can be combined into one power supply with a plurality of outputs.

The controller 410 is able to comprise a motherboard 460, a video card 415 and Bluetooth adapter 430. Alternatively, the video card 415 functions can be incorporated into motherboard 460. Motherboard 460 can be a standard personal computer motherboard, mainboard, system board, a custom PCB or other computing device. The power management module 470 manages the power connection interfaces to the power supply 417 and regulates and monitors voltage levels for the motherboard 460. SATA bus 471 provides SATA, serial advanced technology attachment, or other related technology for connections and communication control interface to hard drives or other non-volatile storage devices coupled to the motherboard 460. IEEE1394 bus 469 provides connections and communication control interface for any devices that can be coupled to the motherboard 460 using the IEEE1394 standard. USB bus 465 provides connections and communication control interface for any devices using USB, universal serial bus, or other serial communication protocols. PCI bus 464 is a Peripheral Component Interconnect standard peripheral bus or other related input output bus to provide a connection and control interface to attach circuit boards which conform to any of the Peripheral Component Interconnect standards.

Network interface 473 is an Ethernet or other related data network communication connection and any needed control interface to provided network data connection between the motherboard 460 and a coupled network. Audio module 472 provides connections and any needed control to interface the motherboard 460 to attached audio devices. Processor 467 is the central processing unit of the motherboard and provides core control, interface with software and firmware programs, and data input/output and processing operations. Chipset 466 manages communication and interfaces between components on the motherboard such as processor 467, memory, input output components and bus systems. Static ram 461 is memory on the motherboard which is non-volatile or does not require refreshing and is used by the processor 467 to move and store data, and can be used by other devices for data storage. Dynamic ram 468 is memory on the motherboard which is volatile and is used by the processor 467 to move and store data, and can be used by other devices for data storage. BIOS Boot Memory 462 is non-volatile memory used to provide instructions to processor 467 on power up to initialize components on and coupled to motherboard 460. Clock 463 is the motherboard clock which provides a pulsed signal for the synchronization of logic and data transfer operation on components and between components attached to the motherboard.

Video card 415 is a video card which is part of controller 410, can be coupled to PCI Bus 464 and is coupled to display assembly 411 to provide video signals to the display or displays. Video card 415 is able to be a single card with two video connections to displays. Alternatively, the video card 415 can comprise a plurality of video cards with each having a connection to motherboard 460 or functions performed by video card 415 can be incorporated into motherboard 460. Furthermore, display connections on video card 415 comprise one connection for each card or comprise a plurality of display couples on each card. Video card 415 is able to be a video card such as used in personal computers or any specialized video display device which interfaces with motherboard 460 for the purpose of displaying images on the attached display or displays. Video card 415 is able to comprise a video processor 441, video ram 442, video BIOS 443, and display driver module 444. Video processor 441 is a graphics processing unit which provides central control and data processing for the video card. Video ram 442 provides volatile and non-volatile data storage for the video processor 441 and storage for input and output operations between components on and coupled to video card 415. Video BIOS 443 provides instructions and data to the video processor 441 and coupled components such as the motherboard processor 467. Display driver module 444 provides connections to the video display assembly 411 as well as other interface components to interface with the connection and communication standards used by the attached displays to transmit video signals for graphics display on the attached displays.

Hard drive 421 is a non-volatile data storage device coupled to SATA bus 471 with a SATA cable or other cable compliant with the hard drive 421 and motherboard 460 connection bus for non-volatile data storage. Although a single block is shown for hard drive 421 for ease in illustration, one embodiment comprises of two hard drives in a redundant configuration such as RAID. Alternate embodiments comprise of a single hard driver or more than two to provide sufficient storage and data protection.

Bluetooth adapter 430 is shown as part of controller 410 in FIG. 33, is attached to motherboard 460 by USB bus 465 and can be in close proximity to the motherboard or plugged directly into a USB connection port. Bluetooth adapter 430 can also be installed at a high position within system 400 for increased range and coupled to USB bus 465 using a USB cable or Bluetooth adapter 430 can be integrated into motherboard 460. Bluetooth adapter 430 provides wireless connection capability on system 400 for mobile devices 500 in range of the Bluetooth adapter 430 supporting a plurality of version of the Bluetooth standard. A Bluetooth connection between mobile devices 500 and system 400 provides an alternate data connection method to provide services, information and advertising information from the database on system 400 and can also be done with a wireless Ethernet connection. Furthermore, the connection can be used to determine mobile devices 500 proximity to system 400.

Camera 429 is a camera installed on system 400 and is coupled to controller 410 using USB bus 465 and specification compliant USB cable. Alternatively, the camera can be coupled to another bus or PCB installed in motherboard 460. Utility keyboard and mouse 431 is a standard USB keyboard and mouse coupled to controller 410 using USB bus 465 to provide on-site troubleshooting and service access to data and control programs on system 400 by an authorized agent. Utility keyboard and mouse 431 can be coupled to system 400 by authorized agent at the time of troubleshooting and service by an externally or covered USB connector. USB to I/O signal converter 432 provides an input and output interface between sensors and detectors attached to the converter and controller 410. Converter 432 is coupled to the controller's 410 motherboard 460 by USB bus 465 and USB cable or alternatively can be coupled to another bus or couple to or integrated into a PCB card installed in motherboard 460. Converter 432 is powered by, either the USB connection, PCI bus 464, or DC supply 417 depending on the module selected. Alternately, converter 432 can couple to controller 410 using the network interface 473 instead of USB bus 465. Sensors 433 and detectors 434 are coupled to signal converter 432 with electrical connections to provide digital output signals from the sensor to inputs on the converter 432 to ultimately be used by controller 410 for system 400 operations. Furthermore, sensors 433 and detectors 434 are electrically coupled to the DC power supply 417 to meet operating DC power specifications for each sensor.

Wireless node 413 is a wireless access point with wired data network connection and network switching capability. Wireless node 413 is coupled to network interface 473 with a cable such as an Ethernet cable providing a high speed data connection between controller 410 and wireless node 413 to couple to a site data network. Wireless node 413 is shown in FIG. 33 coupled to DC supply 417 for DC power, which can be needed for operation of the node. CPU 437 is the central processor of the wireless node providing central control for all data process and input and out operations. Ram 438 is volatile memory for data storage for data processing operations. Rom 439 is non-volatile read only memory for instruction and information for startup and basic operation of the wireless node 413. Flash 440 is non-volatile read and writable memory for data and configuration storage such as such as an operating system and control program.

Display assembly 411 is video display device such as a LCD or LED monitor or TV display device. Display assembly's 411 controller 452 is coupled to the advertisement display system's 400 controller 410 through video card 415 and is powered by DC supply 417. Display assembly 411 is shown in FIG. 33. Display controller 452 comprises of power module 485, display driver 426, scaler 427, and adjustment driver 424. Other components of the display assembly 411 which are able to not be part of the display controller 452 are the backlight module 423, adjustment keys or buttons 425, display panel 428, audio driver 435, and speakers 436. Power module 485 provides a power connection to DC supply 422 and manages, monitors, and distributes DC power for display assembly 411. LCD or LED panel 428 is the display panel visible to a user which is driven by display driver 426 which translate input signals from the video card 415 and drives the inputs to panel 428 to display an image. Scaler 427 can adjust the image on panel 428 to a range of resolutions if needed and adjustment keys 425 and adjustment driver 424 can also adjust the displayed image quality on panel 428 as well as provide a button to turn the display on and off. Display driver 426 can also incorporate a controller with CPU and memory to provide menu options for the display 428. Backlight module 423 provides light and control for the backlight of the LCD or LED display panel 428. Audio driver 435 is able to be part of display assembly 411. Audio driver 435 provides amplified audio output signals from the audio module to speakers 436 from audio input signal from display driver 426 sent from video card 415 with associated video signals. Alternatively, the audio driver 435 can be integrated into display controller 452. Alternatively, the audio driver 435 can be coupled to audio module 472 on motherboard 460 and provides amplified audio output signals from the audio module to speakers 436 using DC power from DC power supply 417.

In some embodiments, the system 400 comprises additional sensors or input devices to increase functionality of the system. Sensors or input devices such as but not limited to RFID readers and bar code scanners can be used. An RFID reader can be installed inside the systems cover and attached to the internal frame or mounted externally on the cover. It can be powered by power supply 417, and coupled to controller 410 by an available bus such as USB bus 465. The added RFID reader on the advertisement display system 400 which can be located at the entrance and exit point of an installed location such as a store is able to enable detection of a purchased product which can be logged into the system database and can be used to adjust advertisement score of an associated product. A bar code reader can also be added to enable the user to scan a product UPC code and get additional information about a product which can be displayed on the system display. The use of a bar code reader by a user is able to also be logged and can affect advertisement scores for associated products.

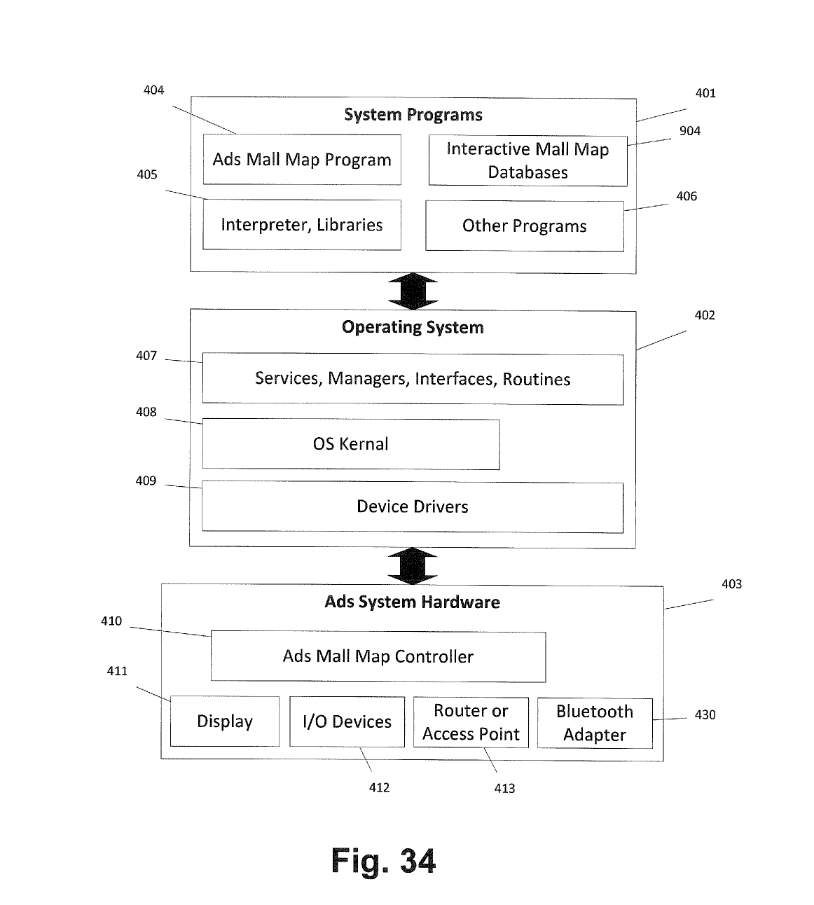

FIG. 34 is a block diagram illustrating the layered construction of the advertisement display system 400 general operational structure from hardware interface to logical control program according to some embodiments. The lower level block is the system 400 hardware 403. The mid-level block is the operating system 402 and software drivers to interface the system hardware 403 for logical control operations. Top level is the logical control program 401 for the advertisement display system 400 which is able to perform data processing operations to achieve the functional results using the hardware components of system 400. Operating system 402 provides data interface between the system hardware 403 and control program 401.

Block 403 illustrates the advertisement display system 400 hardware and components which are used as modes of sensor input and output of information and advertisements to users and data connections between components on the system 400 and other systems such as the interactive mall map system 300, mobile devices 500 and site server 201. Display assembly 411 provides output information to a user or group of users in viewable range of the system 400. I/O Devices 412 comprises of sensor 433, detector 434, cameras 429, keyboard and mouse 432, and speakers 436 as well as I/O signal converter 432 and audio driver 435 from FIG. 29 through FIG. 33. Access point 413 and Bluetooth adapter 430 are shown and are used for data input and output operations. Advertisement display system controller 410 interfaces input and output hardware devices 411, 412, 413, and 430 to software with the first level of low level software interface described by operating system block 402.

Block 402 illustrates the components to efficiently link the hardware 403 of the advertisement display system 400 to programs which enable data processing to provide information and advertisements to shoppers in visual range and mobile devices coupled to system 400. The components comprise of device drivers 409, operating system kernel 408, and software services programs, manager programs, and interface programs 407. The hardware to software interface component of operating system 402 is the device drivers 409. Device driver 409 comprise of all software programs to interface each hardware component to the operating system kernel 408, services programs, manager programs and interface programs 407 of the operating system as well as components of the system programs 401. Device drivers 409 can be specific to and defined by hardware used and operating system installed on system 400. OS kernel 408 is the core functionality of the operating system to function on system 400. Software services programs, manager programs and interface programs 407 are all programs and data files to support the functions of OS kernel 408 and to provide interface capabilities to advertisement display system programs 400. Operating system 402 controls the operation of and directs processing programs on the system 400.

Block 401 comprises of system programs which are the advertisement display system control program 404, any needed interpreters and libraries 405, advertisement display system databases 904, and any other software programs 406 to operate the system 400. Advertisement display system program 404 is a control program developed for the advertisement display system to perform the functions as described herein in conjunction with other software and hardware components on the system 400. Interpreter and libraries 405 are software programs and data files to provide interface between the advertisement display system program 404 and operating system 402. In some embodiments, some functions of the advertisement display program 404 can directly access operating system 402. The selection and use of interpreters and libraries 405 is determined by programming language or languages used to develop the advertisement display program 404, operating system 402 selected for use, and the extent to which control functions are performed by custom developed control programs used or integrated third party software programs used. Other programs 406 comprise any other software program needed for operation and management of the advertisement display system 400 such as a virus checker or software programs to monitor or perform service on a hardware or software components of the system 400.

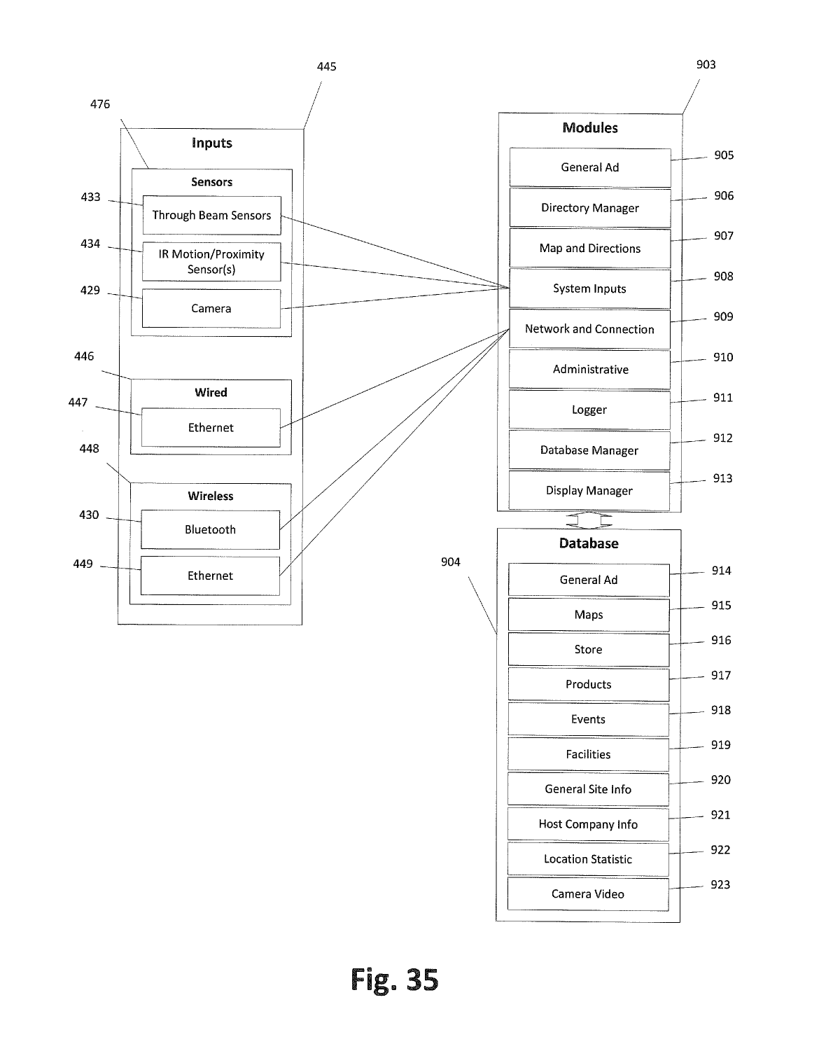

FIG. 35 is a block diagram illustrating system input methods and how they relate to functional blocks of the logical control program and database modules used for the operation of the advertisement display system 400 according to some embodiments. The input block 445 is able to comprise all the system inputs including both physical input devices and input methods, functional modules 903 which represents the control program module which controls the functional blocks of the advertisement display system 400 control program 404, and the databases block 904 which controls the databases used to store and retrieve information for the system 400 local control program 404. Block 445 inputs are segmented into blocks 476 sensors, block 446 wired connections, and block 448 wireless connections. Sensor block 476 comprises through beam sensors 433, IR motion and proximity sensor 434, and camera 429.

Module 903 comprises functional features of the advertisement display system 400 control program and database 904 comprises database features of the advertisement display system 400 control program. The general ad module 905 manages the general advertisements which are displayed on the display assembly 411. Data for display by the general ad module 905 is stored and accessible on the system 400 by the general ad database 914. Directory manager module 906 manages the directory listing for the site of system 400 installation. Directory manager module 906 manages content displayed on display assembly 411 while accessing data for display from the stores database 916, products database 917, events database 918, facilities database 919, general site info database 920 and host company info database 921 can be accessed for more information for display regarding site stores, products, events, facilities, and general, or host information about the site. Map and directions module 907 manages the store or site map which can be displayed on system 400 to provide a shopper with a map of the store which the system 400 is installed. Map and direction module 907 displays a store or site map while accessing data for the map display from maps database 915 and can also access the stores database 916, events database 918, and facilities database 919 to display or overlay more information relating to store or site events, or store or site facilities for display.

System inputs module 908 manages the physical system inputs, through beam sensor 433, IR motion/proximity sensor 434, and camera 429. System inputs 908 formats and stores data collected from sensor 476 to the location statistics database 922 and camera video database 923. Network and connection module 909 manages the data network connections through the wired Ethernet connection 447 and wireless Ethernet 449 and Bluetooth connection 430. Network and connection module 909 manages the connections to the site server 201 from FIG. 5 as well as connection to mobile devices 500 within range of system 400. Some connection data can be stored in the location statistics database 922 such as but not limited to the number of mobile devices 500 coupled to the system with time stamp. Administrative module 910 manages the version of control program installed on the system, ensures the databases are updated, and manages the unique system identifier for the system 400 along with other administrative software management activities such as background checks that everything is functioning as expected. Logger module 911 manages the logging of activities on the system 400 and supports system inputs module 908, network and connection module 909, and database manager module 912, while logging information to the location statistics database 922.

Database manager module 912 manages access between all databases 904 and control logic module 902 which reads or writes to the database. Management activities are able to include but are not limited to ensuring no two module write to a database at the same time, ensuring the correct versions of the databases are installed on the system 400 and coordinate with the logger module 911 to log reads and writes to the databases. Display manager module 913 manages what multimedia information is displayed and when the information is displayed in frames on the display assembly 411. Display manager module 913 is able to call other control logic modules 903 to display multimedia information in display frames and can accept requests from other control logic modules 903 in response to user requests to have the display manager 913 update the display appropriately for the request made.

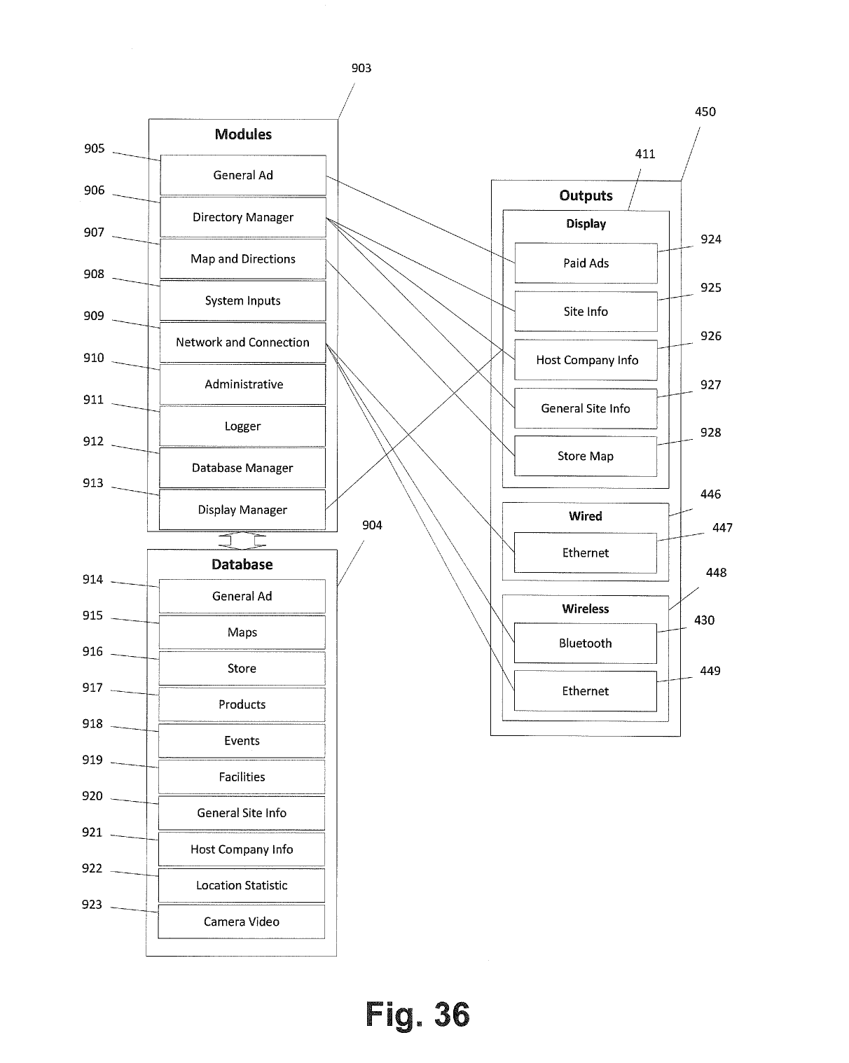

FIG. 36 is a block diagram illustrating the logical control program and database modules used for the operation of the advertisement display system and how they relate to system output methods according to some embodiments. In particular, FIG. 36 illustrates the output side of the advertisement display system 400 as FIG. 35 illustrated in the input side of the system 400. The module 903 and databases 904 are substantially similar to those described for FIG. 35 except for the differences described herein. Outputs 450 comprise three categories: display 411, wired connection 466, and wireless connection 448. Wired connection 446 comprises the wired Ethernet connection 447 for communicating out from system 400, to the site server 201 (see FIG. 5). The wireless Ethernet connection 449 and Bluetooth connection 430 are for outputting communications to mobile devices 500 coupled to the system 400. If wired Ethernet connection is not coupled to site server 201 the wireless Ethernet connection 449 is able to additionally serve as the data connection to the site server 201. Display assembly 411 comprises display outputs which can be shown on this display. Paid ads block 924 represents a display output of advertisements to be shown on the display 411 and is managed by the general ad module 905. Advertisements are able to be shown on display 411 which are able to be multimedia ads for but not limited to, site stores, products or brands.

Site info block 925 is for display output which can be an advertisement or general information multimedia presentation relating to the mall site of installation of the system 400 and is managed by the directory manager module 906. Host company info block 926 is for display output of advertisement or general information multimedia display relating to the host company of the system 400 and is managed by directory manager module 906. General site info block 927 is for display output of general information multimedia display relating to the site of installation of system 400 and is managed by directory manager module 906. Store map module 928 is for the display of the store map which is able to represent elements of the store such as isles, product locations, general store layout, and checkout locations similar to that described in FIG. 26 element 869 for the interactive mall map system 300 but without touch capability and is managed by the map and directions module 907.

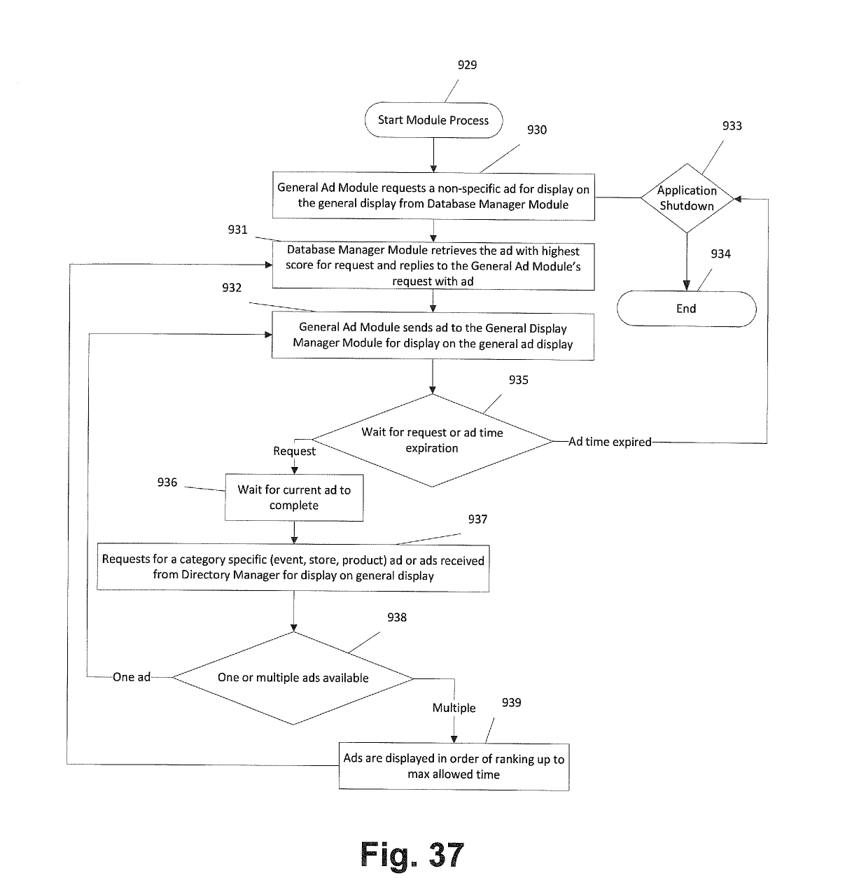

FIG. 37 is a flow chart illustrating the basic function the advertisement display system for the display of advertisements on the system 400 according to some embodiments. Step 929 represents the start of the system 400 operations. Step 930 follows step 929 and represents the start of the system 400 retrieval of the first advertisement for display. In step 930, the general ad module 905 requests an ad from the database manager module 912. At Step 931, an advertisement for display is returned from the database, which can be done by the database manager module 912 retrieving the advertisement with the highest advertisement score from the general ad database 914 and replying to the general ad module 905 with the advertisement for display. Step 932 follows step 931 and represents displaying the requested advertisement on the display in the proper location and format. This is able to be accomplished in step 932 by the general ad module 905 sending the advertisement to the display manager 913 which displays the advertisement in the proper location and format on display assembly 411 for system 400.

Decision step 935 follows step 932 and represents the two possible actions which can occur next. Decision step 935 represents waiting for the advertisement to complete or a request to display specific information or an advertisement on the display. One path from step 935 is when the advertisement display time has expired and the system control goes to decision step 933, which checks if there is a request to shut down system 400. If there is a request to shut down the system 400, the system is shut down and powered off or reboots based on the shutdown request in step 934. Otherwise, the method returns to step 930. If there is a specific request at step 935, the system waits at step 936 until the current displayed advertisement is complete. Step 937 follows step 936 and represents a request from the site data network or system 400 to display specific information or advertisement or category of information or advertisements. Furthermore, step 937 request uses the directory manager module 906 to request the specific information or information relating to a category of information from the database manager module from the appropriate database for display on system 400. Decision step 938 follows step 937 and represents the possibility that an advertisement request such as an advertisement category request can result in a plurality of advertisements returned. Decision step 938 illustrates two paths depending on the returned results from request 937. If only one advertisement is returned for the request, the path leads to step 932 resulting in the display of the advertisement or specific information on the system 400 display. If more than one advertisement is returned from the request, the path leads to step 939 which determines which advertisement to display based on the advertisement score of the returned advertisement from the request. Once all advertisements are shown for step 939, control goes back to step 931. The cycle shown in FIG. 37 is able to continue until a shutdown request is received by system 400 and ending the system operations at step 934.

FIG. 38 and FIG. 39 are illustrations of screen wireframe layouts showing two display configurations on the advertisement display system 400, display assembly 411, which are able to display advertisements and information on the system display according to some embodiments. Specifically, FIG. 38 is an illustration of a basic screen wireframe layout with a small set of frames for the display of multimedia advertisements and site of installation information. Frame 900 is the main frame and is the location where the main display of advertisements and information are able to be displayed. The displayed advertisements and information displayed in frame 900 can be in the form of multimedia such as text, pictures, video and audio in any combination. Frame 901 is an area across the bottom of the display assembly 411 when smaller information feeds can be displayed such as text with information about the advertisement being displayed, information about the store or site of installation of the system 400, or any site general announcements that can be displayed in the frame area. The frame 901 can be an overlay to from 900 which enables advertisements in frame to use the entire display area with a small area being overlaid with information such as text or can be segmented area where the advertisement in frame 900 being displayed ends at the top of frame 901. Further, in the segmented layout, the background of frame 901 can be any solid color to make the information such as text being shown in frame 901 visible to a shopper in typical viewable range of system 400 in the site of installation. Frame 901 is able to selectively not be visible (e.g. periodically, after a period of inactivity, based on user input) such that only advertisement and information from frame 900 are shown. In such embodiments wherein frame 901 is not always visible, it is able to only be visible in times when there is information to be displayed.

FIG. 39 is an illustration of a basic screen wireframe layout with additional frames for the display of multimedia advertisements and site of installation information for the advertisement display system. Specifically, FIG. 39 is an alternate display configuration from FIG. 38 for the advertisement display system 400, display assembly 411, which is able to display advertisements and information on the system display. Frames 900 and 901 function and are positioned as described for FIG. 38 but frame 902 is added to the display. Frame 900 and 901 width is reduced and frame 902 is position on the side of the display using the vertical display area on the side. Frame 902 can comprise information for the store or site such as but not limited to store hours, store map, store advertisement, and any multimedia information for the promotion of the store or site of installation. Frame 902 can additionally display information in relation to an advertisement being displayed in frame 900 or information being displayed in frame 901. Furthermore, the information or advertisement shown 902 can be static or changing based on the store or site preferences.

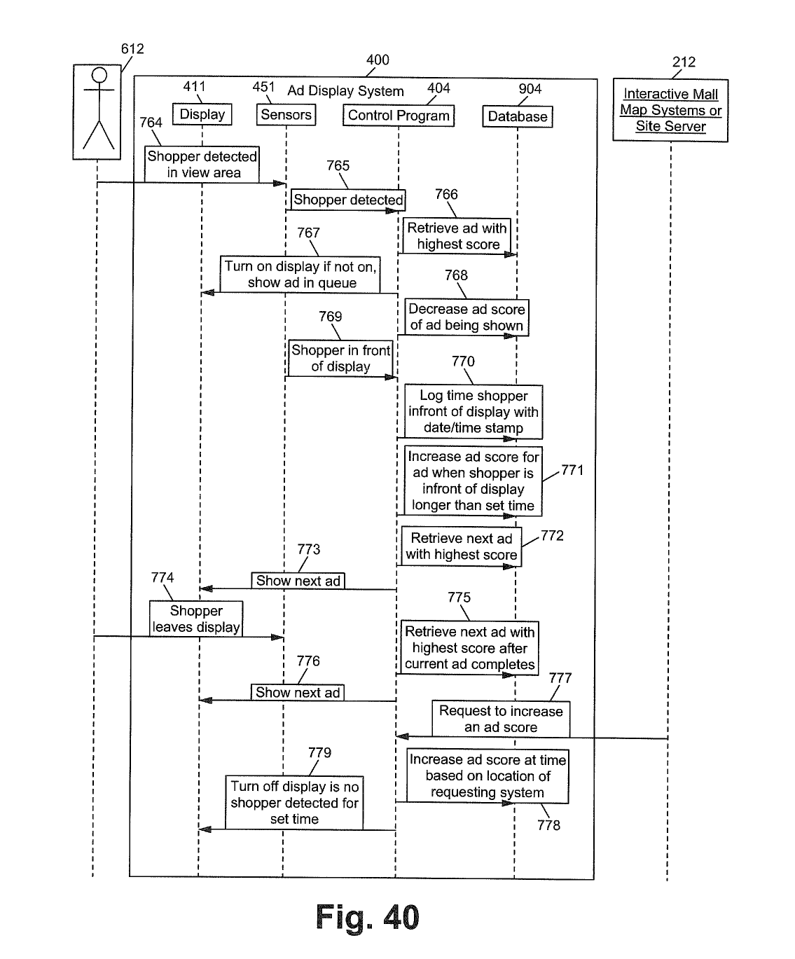

FIG. 40 is a sequence diagram illustration showing a method of shopper detection and advertisement display for the advertisement display system 400 in a general sequence according to some embodiments. FIG. 612 is a person such as a shopper who is able to move into view range of the system 400 and move out of view range of the system. System box 400 is shown with select element of the system 411, 451, 404, and 904. Block 212 represents either the interactive mall map system 300 or the site server 201 as a site system or server which is able to send information to the advertisement display system 400. At action 764, the shopper 612 comes within view range of system 400 and is detected by the sensors 451 on the system. Next at action 765, sensors 451 update control program 404 with the detection of a shopper 612 within viewable range of the system. At action 766, an advertisement is retrieved from the system database 904. In some embodiments, the retrieved advertisement is the one with the highest advertisement score in the dataset 904.

At action 767, the control program turns on the display 411 if not already on and shows the advertisement retrieved from action 766. At action 768, the control program 404 decreases the score for the advertisement retrieved from action 766 in the database 904. At action 769, the sensors 451 detect a shopper in front of system 400 and presumably looking at the system display and advertisements or information being shown. Furthermore, the sensors 451 detection of a shopper in front of the system 400 is input into the control program 404. At action 770, the control program 404 updates the database 904 with the time and date of when a shopper was detected in front of the system 400. At action 771, the control program 404 updates the advertisement score for the advertisement in the database what was being shown when the shopper 612 was detected standing in front of the system 400. At action 772, the control program 404 retrieves the next advertisement for the display with the highest advertisement score. At action 773, the control program 404 sends the next advertisement retrieved from action 772 to the display 411 to be displayed. At action 774 the shopper 612 leaves the viewable range of system 400 which is detected by sensor 451. At action 775, the control program retrieves the next advertisement from the database with the highest score to be displayed after the currently displayed advertisement is complete. At action 776, the control program 404 sends the next advertisement to the display 411 to be shown. At action 777, the site interactive mall map system or site server 212 sends a request to increase the advertisement score of one or more advertisements to the control program 404. At action 778, the control program 404 updates one or more advertisement in the database 904. Furthermore, the control program can delay the update of an advertisement for a set time in the database 904 based on the request or location of the requesting system or server 212. At action 779, the control program 404 turns off display assembly 411 due to no shoppers being detected in the viewable range of the system 400 for a predetermined period of time.

### Mobile Device

Mobile device 500 is a mobile device such as smart phone, tablet computer, or lap top computer with an application installed to interface with systems and components described herein. In one embodiment, the mobile device is a smart phone with a control application installed to use the hardware features of the mobile device to couple to a site data network through a wireless data network node such as an advertisement display systems 400 or an interactive mall map systems 300. Alternatively, the mobile device 500 can be any device with a battery, central processing unit, memory, input devices such as touchscreen or buttons, wireless antenna and controller for a wireless connection method such as wireless Ethernet or Bluetooth or a cellular data RF connection type, and a display screen.

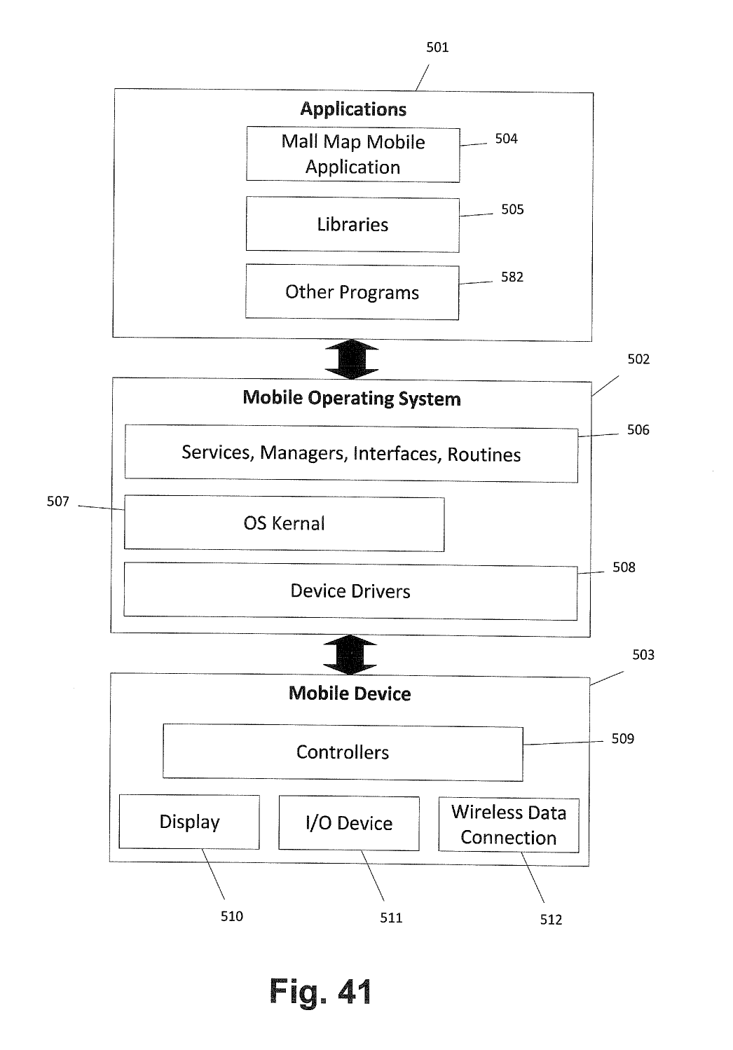

FIG. 41 is a block diagram illustrating the layered construction of the mobile device 500, with installed application, general operational structure from hardware interface to control application according to some embodiments. The lower level block is the mobile device 500 hardware 503. The mid-level block is the operating system 502 and software drivers to interface the mobile device hardware 503 for logical control operations. Top level 501 is the control application 501 for the mobile device 500 which is able to perform data processing operations to achieve the functional results using the hardware components of mobile device 500. Operating system 502 provides a data interface between mobile device hardware 503 and control application 501.

Block 503 is the physical components of the mobile device 500. Display 510 comprises touchscreen display or non-touchscreen display with buttons which provides input and output of information between the system and a user. I/O Device 511 can comprise of buttons, speakers, and microphone. Wireless data connection 512 comprises any combination of wireless Ethernet, Bluetooth or any type of cellular data RF connection or any related RF data connection. Mobile device controllers 509 interfaces input and output hardware devices 510, 511, and 512 to the first level of low level software interface described by operating system block 502.

Block 502 comprises the components to efficiently link the hardware 503 of the mobile device 500 to programs which enable data processing to provide services, information and advertisements to users of the installed application on the mobile device 500. The components comprise device drivers 508, operating system kernel 507, software services programs, manager programs, and interface programs 506. The hardware to software interface component of operating system 502 is the device drivers 508. Device driver 508 is able to comprise all software programs to interface each hardware component to the operating system kernel 507, services programs, manager programs and interface programs 506 of the operating system as well as components of the system programs 501. Device drivers 508 used are specific and defined by hardware used and operating system installed on mobile device 500. OS kernel 507 is the core functionality of the operating system to function on mobile device 500. Software services programs, manager programs and interface programs 506 are all programs and data files to support the functions of OS kernel 507 and to provide interface capabilities to mobile device application 501.

Block 501 comprises a the mall map mobile application 504, any needed interpreters and libraries 505, and any other software programs 582 which can be needed for the functionality of mobile device 500. Mall map mobile application 504 is a control application developed for the installation on a mobile device to perform the functions as described herein in conjunction with other software and hardware components on the mobile device 500. Libraries 505 can comprise of software programs and data files to provide interface between mall map mobile application 504 and operating system 502. In some embodiments, some functions of mall mobile map application 504 can directly access operating system 502. The selection and use of libraries 505 is determined by programming language or languages used to develop the mall mobile application 504, operating system 502, and the extent to which control functions are performed by custom developed control programs used or integrated third party software programs used. Other programs 582 comprise of any other software program which can be needed for operation of the mall map mobile application 504.

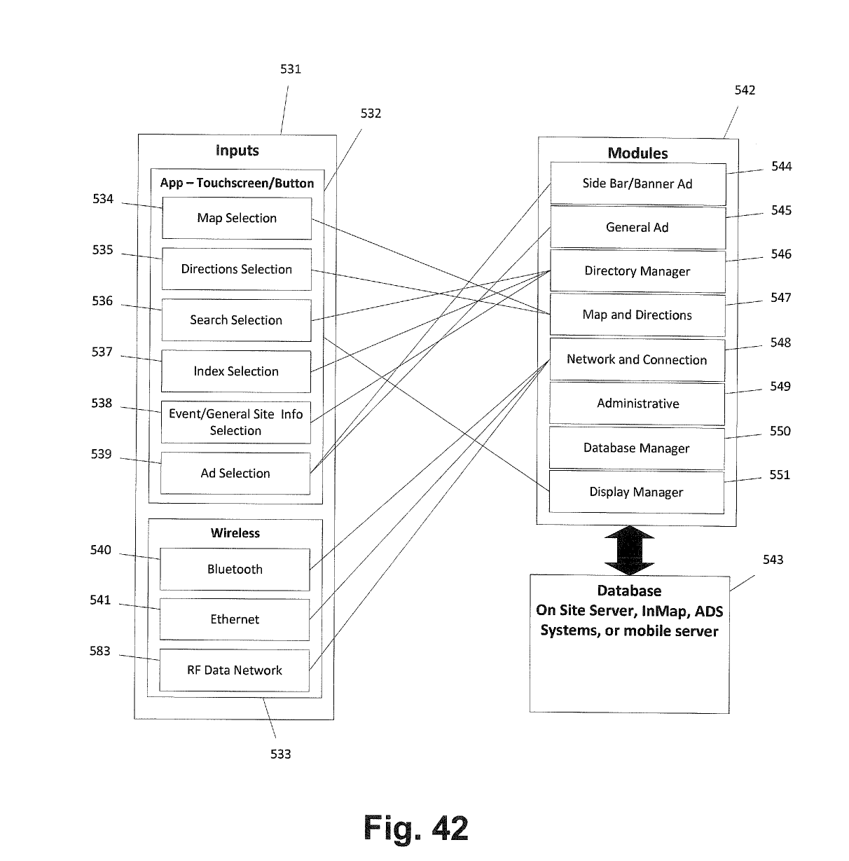

FIG. 42 is a block diagram illustrating system input methods and how they relate to functional blocks of the logical control application and remote database modules used for the operation of a mobile device with the mall map mobile application installed according to some embodiments. The input block 531 is able to comprise all the system inputs both physical input devices and input methods. The functional module 542 comprise the functional operating modules which are the functional blocks of the mall map mobile application 504. The database block 543 is a database on either an interactive mall map system 300, an advertisement display system 400, site servers 201, and/or host company mobile server 102. Input block 531 is segmented into display touchscreen and buttons blocks 532 and wireless connections block 533. The wireless connections block 533 comprises the Bluetooth block 540, wireless Ethernet block 541, and RF data network block 583. The wireless Ethernet block 541 is the mobile device 500 RF components and controllers, which can be needed for the device to access and communicated on a wireless Ethernet, or related technology, data network. Bluetooth block 540 is the mobile device RF components and controllers for the device to communicate with a Bluetooth node within range of the mobile device 500. RF data network block 583 is the RF components and controllers for the device to access and communicated on a cellular data network or related network.

The display touchscreen and buttons block 532 is shown with sub-blocks that represent input selections displayed on the mobile device 500 display and are used to link the user of the mobile device with mall map mobile application to data and services through the display touchscreen and buttons block 532. Specifically, the input selections are able to comprise map selection 534, directions selection 535, search selection 536, index selection 537, event/general site info selection 538, and advertisement selection 539. It is noted that these general input selections are merely exemplary and other types of selections are contemplated. Map selection 534 is a user selection option from the display touchscreen and buttons block 532 from a displayed map which can result in the display of more and related information about the selection from the displayed map. Directions selection 535 is a user selection option from a displayed map or listing of points of interest such as a directory for a site which displays the user's current location and the destination location as well as possible routes between the two locations through the site covered by the mobile device with mall map mobile application 500. Search selection 536 is a user selection option using a search field on the display which the user can enter a point of interest, a product, or any words that can be used to search for information, services or advertisements relating to a site using a mobile device with mall map mobile application 500. Results from such a search are listed on the display for the user to make the appropriate selection. Index selection 537 is a user selection option which comprises of a list of points of interests, services or advertisements from which a user can make a selection to set more information and related information for the selection which is able to be displayed. Event/general site info selection 538 is a user selection option from which a user can select from a site map or list of events for the site any current or future event at the site of special information about the site which is able to result in the return display of more and related information to the event. Advertisement selection 539 is a user selection option from which a user can select any advertisement being displayed or listed as a summary on the screen to get more and related information regarding that advertisement. More and related information includes but not limited to information such as site stores that sell a product relating to the advertisement, or products sold by a store relating to the advertisement, or detailed description of a store or product from a selected advertisement, or specification for a product from a selected advertisement or images of the product or store relating to the selected advertisement.

Modules 542 are shown with sub-blocks listing functional blocks of the mall map mobile application 504. Databases block 543 is a database on an interactive mall map system 300, an advertisement display system 400, a site servers 201, and/or host company mobile server 102, that are accessible to mall map mobile application 504, which have databases as described as described above. Mobile device 500 is able to comprises no database, so the mall map mobile application accesses the information needed for the operation of the mall map mobile application 504 from remote databases. Alternatively, the mobile device 500 is able to comprise a local database. The remote database used for connection depends on the current location of the mobile device 500 and the current speed of the data network connection for the mobile device. Select site data can be provided based on either user selection or the current location of the mobile device 500. Side bar/banner ad block 544 manages the side bar or a banner ad which can be displayed on the mobile devices display is selected by the user through the ad selection interface selection 539. Data for display by the side bar/banner ad module 544 is accessed from a remote database 543 through any of the wireless connections described for block 533.

General ad block 545 manages the general advertisements which can be displayed on the mobile device 500 display. Data for display by the general ad module 545 is accessed from a remote database 543 through any of the wireless connections described for block 533. Directory manager block 546 manages the directory listing for a select site from mobile device with mall map mobile application 500. Directory manager 546 manages content displayed on the mobile device 500 display and manages user selections from a search selection 536, index selection 537, and event/general site info selection 538 inputs while accessed from a remote database 543 through any of the wireless connections described for block 533. Map and directions block 547 manages the map displayed and direction between the mobile device with mall map mobile application 500 to a destination selected by the user at a select site. Map and direction module 547 displays the map on the mobile device 500 display and manages user selections from the map selection 534 and direction selection 535 inputs with data accessed from a remote database 543 through any of the wireless connections described for block 533. Network and connection block 548 manages the data network connections through the wireless Ethernet 541, Bluetooth connection 540 and RF data network connection 583. Network and connection 548 manages the data connections described in wireless block 533 for the operation of the mall map mobile application 504 on mobile device 500.

Administrative block 549 manages the operation of the mall map mobile application 504 and manages authentication of the mobile device 500 with the mall mobile application 504 installed to a system for access to a remote database 543. Database manager block 550 manages database access and formatting between the mall map mobile application 504 and remote database 543 through any of the wireless connections described for block 533. Display manager block 551 manages what multimedia information is displayed and when the information will be displayed in frames on the mobile device 500 display. Display manager module 551 is able to call other modules 542 to display multimedia information in display frames and can accept requests from other modules 542 in response to user requests to have the display manager 551 update the display appropriately for the request made.

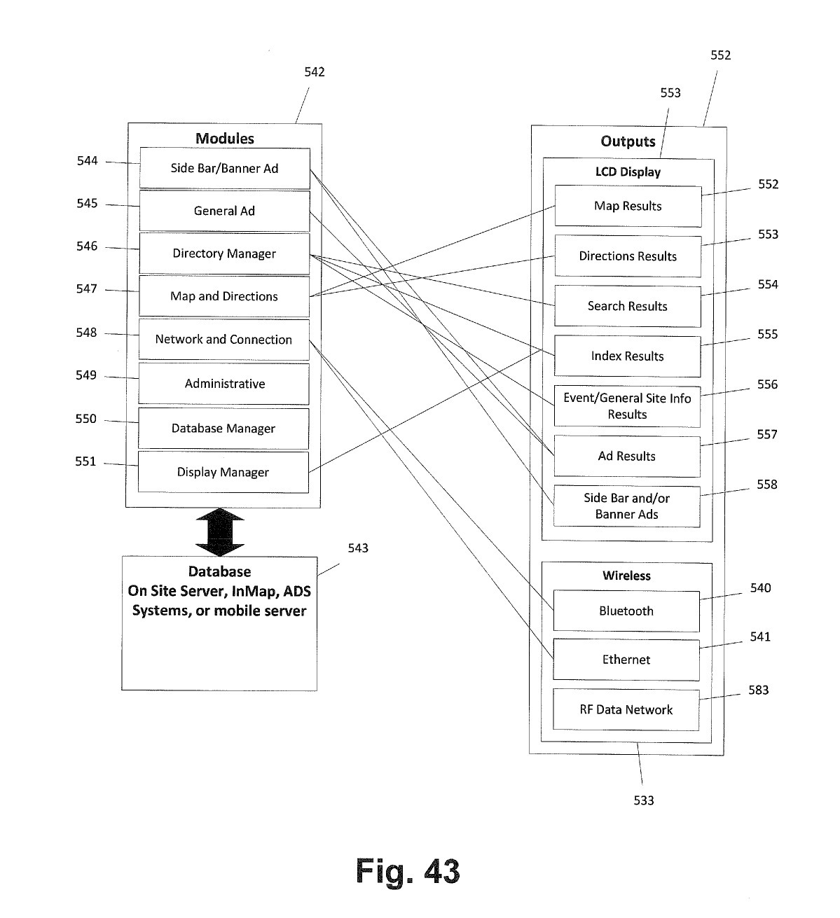

FIG. 43 is a block diagram illustrating the logical control application modules used for the operation of the mobile device with mall map mobile application 500 and how they relate to system output methods according to some embodiments. FIG. 43 illustrates the output side of the mobile device with the mall map mobile application 500. The module 542 and remote database 543 are the same as described for FIG. 42. Outputs 552 comprise two categories: output display 553 and wireless connection 533. The wireless block 533 comprises the wireless Ethernet connection 541, Bluetooth connection 540 and RF data network connection 583. Display 553 is as described in FIG. 42 but illustrates the outputs displayed on the output display 553 instead of selections. Specifically, the outputs of the output display block 553 comprise display results from related selections listed in FIG. 42, which are able to be displayed through the output display block 553. Map Results Block 552 is a map display as managed by map and directions module 547 and can be from a resultant selection from map selection 534 from FIG. 42. Directions results output 553 is a direction overlay on the displayed map as managed by the map and direction module 547. Search results output 554 is a search listing or map listing results from a user search and is managed by the directory manager module 546. Index results output 555 is an index listing or map listing of items, such as but limited to site stores and products, for display and possibly selection by a user and is manager by the directory manager module 546. Event/general site info results output 556 is a display listing or map listing of current site events or special site information managed by the directory manager module 546. Ad results output 557 is the display of an advertisement selection result with addition advertisement information as managed by the side bar/banner ad module 544. Side bar/banner ads output 558 is the display of advertisement information for selection as managed by the side bar/banner ads module 558.

FIG. 44 is a sequence diagram illustration showing a method of user interaction with the host company server outside a site with the host company systems, using a mobile device with an application installed which allows access to the host company mobile server databases according to some embodiments. Host company mobile server 102 comprises the host company mobile server database 189 and mobile server control program 188. Network 21 is a data network or connections of different types of networks such as the internet, as well as cellular, home, public Wi-Fi or other similar network. Mobile device 500 comprises the control application 504 installed on the mobile device 500. User 614 is an end user who is using the mobile device 500 to access data from the remote host company mobile server.

At action 655, the user 614 opens the control application 504 on mobile device 500, which is able to provide access to service data on the host company mobile server. At action 656, the control application 504 requests to couple to mobile server 102 (and more specifically site server control program 188) over network 21. Control program 188 replies to the request 656 with response 657 which is an authentication request to control application 504 to determine if it is a control application that is approved by the host company to access and/or what level of access to grant to the mobile server 102. Reply 658, from control application 504 to control program 188, is in response to request 657 and is able to be used to determine if control application 504 is authorized to access mobile server 102 and what restrictions can be placed on that access. If access is authorized, the process continues. If access is not authorized, control application 504 and mobile device 500 are denied access to any data on mobile server 102.

After authorization, the control application 188 logs the connection of the mobile device to database 189 with data such as but not limited to time stamp, unique identifier for mobile device such as MAC address and mobile application version number. Also after authorization for control application 504 to access mobile server 102, at action 660 the control application 504 requests the user's 614 permission to determine the user's current location. At action 661, the user's provides permission to determine current location after the user makes a selection on the mobile device to grant permission to determine the user's location. As a result, the control application 504 is able to acquire the user's current location by longitude and latitude using the mobile device's GPS hardware and the device's positioning software. Alternatively, other position determination methods are able to be used. At action 662, the control application 504 requests information about sites, such as mall site, in the user's geographical area. The user's geographic area is able to be determined by a preset radius on the mobile server control program 188. At action 663, the mobile server program 188 requests for data from mobile database 189 for sites determined in the user's geographic area, data retrieved for the sites can include information such as but not limited to address, distance from user 614, hours or operation and primary attractions (e.g. anchor stores or special event). At action 664, the mobile server database 189 replies to control program 188 with the data for the requests sites. At action 665 represents the control program 188 sending the list of sites with summary data about each site to mobile application 504 for display and selection of a site for more information to user 614.

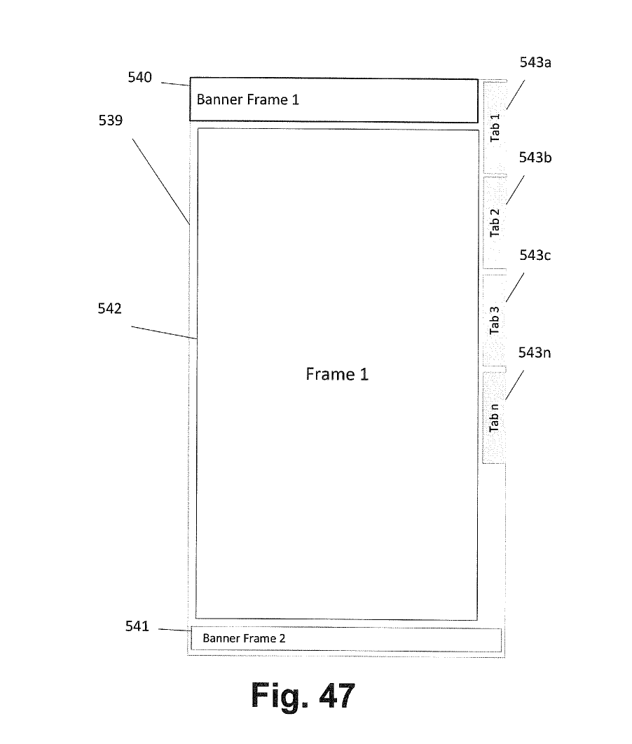

At action 666, the user 614 makes a selection on mobile device 500 for a site presented from action 665 which is processed by control application 504. At action 667, the control application 504 requests more detailed information about the selected site from control program 188. At action 668, the control program 188 requests additional information about the selected site from mobile server database 189. The additional information requested is determined by the control program 188 and can include data such as but not limited to the data that was already provided in the site list selection, full site listing of attractions such as a full store listing and events, listing of products at site, listing of services and maps of site. At action 669, the mobile server database 189 sends a reply to the mobile control program 188 for the request for detailed site information from action 668. At action 670, the control program 188 logs into the mobile database 189 for the site information request from action 668 with the name or unique identifier of the requested site as well as time stamp and unique identifier for mobile device making the request such as MAC address. At action 671, the control program 188 sends control application 504 the data to fill display frames on the mobile device 500 which is able to include the additional information for the site request from action 667. Control application 504 is able to update the user's mobile device display screen to present the user with the additional information for the site. For example, the display screens and frames are able to be as described in FIG. 47 through FIG. 51. At action 672, the control application displays the additional site information to user 614.

At action 673, the user 614 makes a selection from the additional site information provided from action 671. The selection can be something such as selecting a store from the store listing on the mobile devices display. From the selection a new display or window can display a request to the user to further refine the request. At action 674, the control application 504 updates the mobile device display in reaction to action 673 to request further refinement in the request such as displaying a selection for the user to choose a category for information such as but limited to store sales or store map. At action 675, the user makes a selection from the category display from action 674 which is interpreted by the control application 504 which then determines more data needs to be requested from the mobile server 102. The user's selection can be but not limited to a selection for a request to get more information about sales and special for the selected store from action 673. At action 676, the control application 504 requests from mobile server control program 188 the information to complete the request to the user's selection from action 675. The mobile server program 188 interprets the request from action 626 and determines what information is requested to be extracted from database 189. At action 677, the mobile server control program 188 requests the needed data from database 189 to complete the request from action 676. At action 678, the mobile server database 189 responds to control program 188 for the request from action 677 with the data requested. At action 679, the mobile server control program 188 responds to the mobile control application 504 with the data to complete the request from action 676. Mobile control application receives the data and prepares the data for display in display frames on the mobile device 500. At action 682, the control application 504 updates the mobile device 500 display to present user 614 with information from action 679 to complete the request from action 675 for more information for a category such as but not limited to a selected store sales and special. At action 680, the mobile server control program 188 sends a request to database 189 to log information relating to the request from action 676 such as but not limited to the information requested and what databases were accessed such as store sales or specials data was provided, time stamp, and unique identifier for mobile device making the request such as MAC address.

Authentication, which was confirmed in action 658, is able to be granted to a mobile device with authorized mobile application for a present time monitored by control application 188 and is able to expire if no requests are received within that present time. Furthermore, addition measures can be taken to increase security of transactions using encoding of the transaction and security keys for a transaction period or each transaction which can be needed for authentication. The authentication measures determine that the mobile device 500 accessing mobile server 102 is using an authorized host company control application 504 to prevent excessive and unauthorized data extraction from the mobile server database 189.

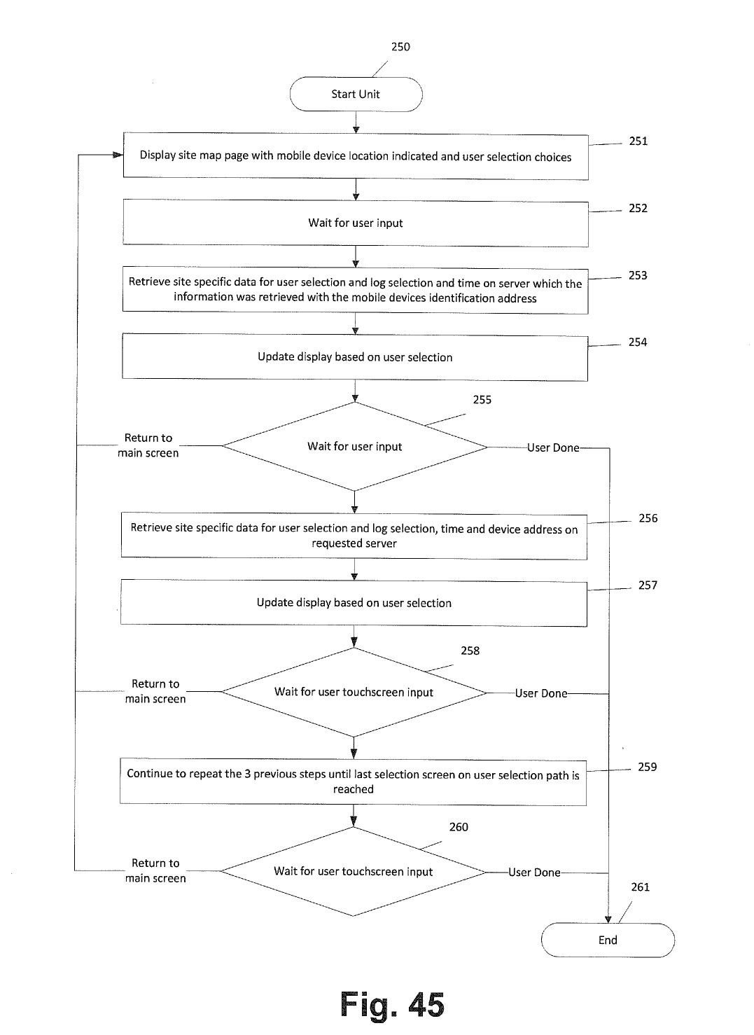

FIG. 45 is a flow chart illustrating the sequential general startup and general user input interaction with a mobile device using the host company mobile application to access data from the host company systems located at the site of use of the mobile device according to some embodiments. Step 250 represents the start of the control application 504 on mobile device 500 at a site which is covered by the host company systems such as the interactive mall map 300 and advertisement display system 400. At step 251, the site map is displayed with the user's location indicated on the map, with user selections available displayed. At step 252, the control application 504 waits for input from the user. At step 253, a selection is made by a user. The selection results in the retrieval of data from an interactive mall map 300 or advertisement display system 400 database in close proximity of the mobile device 500 by the control application 504 with relating mobile device and selection information logged. At step 254, related information retrieved in step 253 is displayed in response to the user selection.

At decision step 255, the mobile control application 504 waits for further user input. The method returns to step 251 if there is user selection indicating that the current activity is complete and that the user would like to return to the default map screen. Alternatively, if the user makes a selection indicating they are done making a selection or are done using the control application 504, the control application is shut down at the end step 261. Alternatively, if the user makes another selection from the current display shown, at step 256 the data to complete the requested selection is retrieved from an interactive mall map or advertisement display system database (e.g. in close proximity of the mobile device 500) with information relating to the mobile device and selection logged. At step 257, related information retrieved in step 256 in response to the user selection is displayed. At step 258, the mobile control application 504 waits for further user input. If there is user selection indicating that the current activity is complete and/or that the user would like to return to the default map screen the method returns to step 251. Alternatively, if the user makes a selection indicating they are done making selection or are done using the control application 504, the control application shuts down at the end step 261. A third path leads to step 259 with represents the repeat of possible user selections down a selection path of choice for a user to gain the site information for which they are requesting from the mobile control application 504. The repeat of the selection path can be represented by a repeat of actions as described for step 255 to 258.

The selection path illustrated by decision step 260 allows two paths. One path from step 260 represents a return to step 251 by user selection indicating that the current activity is complete at that the user would like to return to the default map screen. An alternate path from step 260 represents the user making a selection indicating they are done making selection or are done using the control application 504 and the control application should shut down as indicated by the illustrated path to the end step 261. End step 261 represent the end of the application executing in a mode which presents information from the control application 504 to the mobile device 500 display.

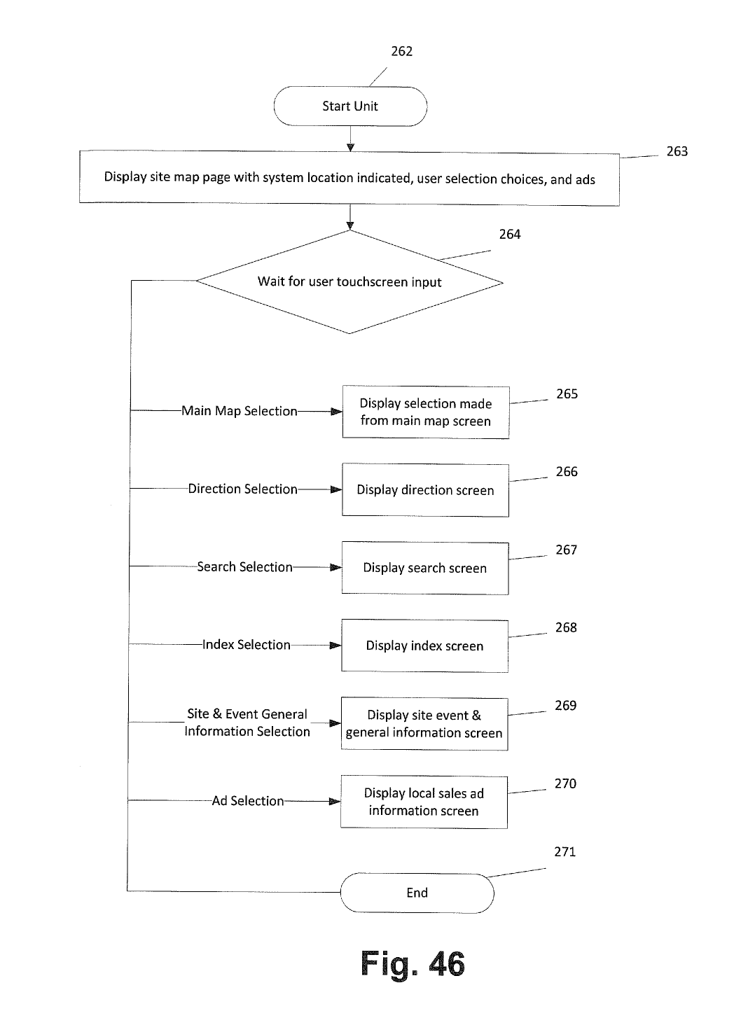

FIG. 46 is an extension of FIG. 45 and is flow chart illustrating a method of getting and processing input from a user with a mobile device using a host company application to access data from the host company systems located at the site of use of the mobile device according to some embodiments. Step 262 is the start step indicating the control application 504 is starting up on the mobile device 500. At step 263, the site map with the user's location indicated on the map is displayed and/or user selections available are displayed. At step 264, the control application 504 waits for input from the user in the form of a presented selection option. Besides the path to the end step 271 other possible selection options are illustrated by steps 265, 266, 267, 268, 269, and 270.

If the user selects an item from main map selection, at step 265, the control application updates the mobile devices display frame to show increased detailed display of information for the selection made from the map display. The increased detail shown is able to be from a selection of a store from a mall map which results in the main map display, which is able to be a mall map, to update to possibly a store map, a listing of store products, store hours of operation, store description, store sales or specials. Alternatively, other information that can be displayed on a map and/or be selectable. If the user makes selection for direction, at step 266, the display updates thereby presenting the user with additional selection options for direction of a site location or event. Further, in some embodiments the selection of step 266 is able to cause a direction path overlay to be shown on the site map from the user's current location to a selected site location or event. If search selection is made by the user, at step 267, the control application 504 display frame updates to provide search options such as a search bar with a keyboard if the mobile device 500 is not equipped with a keyboard. An alternate search option is able to be by voice control if the mobile device 500 supports such input. The search selection enables the user to search the current site database for items such as but not limited to stores, products, events, services, sales, specials, or facilities as can be done with the search function defined for the interactive mall map system 300. The resulting search display is able to be updated with a list from which a user can make a selection and more information and related information to the selection is displayed.

If an index selection is made by the user, at step 268, the control application display frame is updated with a listing of site related items in categories such as but not limited to points of interests, stores, products, facilities, services or advertisements from which a user can make a selection and more information and related information to the selection is displayed. If a selection of site and events general information is made by the user, at step 269, the control application display frame is updated with a listing of site and site related events and general information for the current site such as but not limited to hours and days of operation of event, names of upcoming events, images relating to events or the site with selection options for each shown event or general information listed which are able to update the display with additional detail information related to the selected event or general information selection. If an advertisement selection is made by the user from an advertisement displayed on the site map screen or frame or a general selection for advertisements or specials information from the site map screen, at step 270, the control application display frame is updated with a listing of site related advertisement or the display of a specific advertisement in the form of multimedia or images or text. Additionally, when a list of advertisements is displayed, a selection from the list is able to further present selection options to refine the listing of advertisements down to a selection of a specific advertisement. Alternatively, if the user selection indicates they are done making selection or done using the control application 504, the control application shuts down at end step 271.

FIG. 47 to FIG. 51 illustrate screens using wireframe layouts showing the various display formats that are displayed on the a mobile device 500 using a host company control application 504 to interact with a user and provide the user with services, information and advertisements relating to the current site or selected location of the user according to some embodiments. User selection of items in wireframe elements are able to be logged and used to adjust advertisement score of advertisements to be displayed on site systems 300 and 400. Information displayed in the wireframe elements can be in the form of text, a tree structure, a tabbed structure, graphics, video or multimedia in various combinations on the main display within the wireframe elements. The wireframe layouts of FIGS. 47 to 51 are substantially similar except for the differences described herein.

FIG. 47 is an illustration showing a wireframe layout of the main screen on a mobile device using a mobile control application showing the location and components of the content to be displayed according to some embodiments. The host company mobile application 504 is able to be substantially similar to the application as described in FIGS. 41 to 46. Specifically, the mobile application manages the content and layout of the displayed wireframe and display element along with the mobile device hardware and software responsible for managing the device's display. Outline 539 is the display screen of a mobile device 500 such as a smart phone display. Frame element 540 is a banner frame which can display text with the site name and other site information to promote the site to the user. Frame element 541 is a search bar or an additional banner frame to provide information about the site to the user or show advertisements relating to the current site. Frame 542 is the main display area where information, services, and advertisements are able to be presented to the user for interaction with the control application 504. Information, services and advertisements displayed in frame 542 can be in the form of text, a tree structure, a tabbed structure, graphics, video or multimedia in various combinations on the mobile devices display within the wireframe elements. Selection elements 543a to 543n, or 543 collectively, are a selection method which provides labeled selection display elements to indicate additional pages of information, services or advertisements which the user can select to navigate to the alternate pages from a currently displayed page. The selection elements 543 can be in the form of tabs, buttons, text, or graphics or any other similar display element that is able to clearly represent a selection option to a user of the mobile device 500.

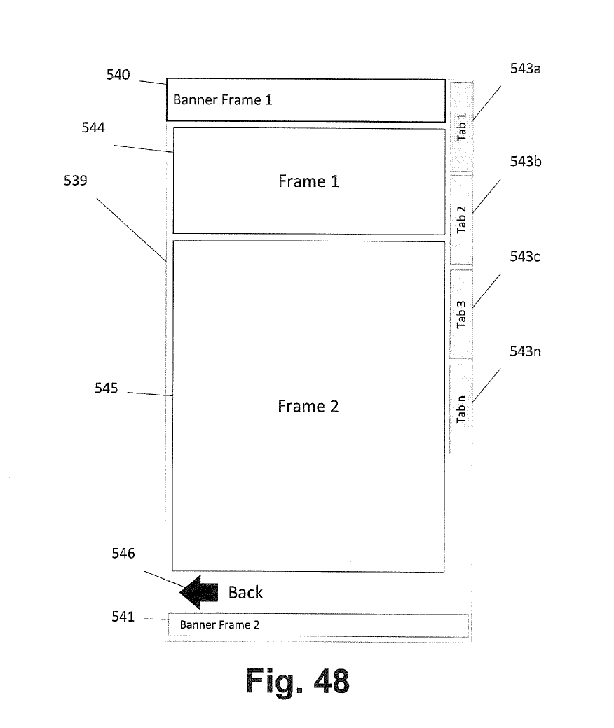

FIG. 48 is an illustration showing an alternate wireframe layout of the main screen on a mobile device using a mobile control application showing the location and components of the content to be displayed according to some embodiments. Again, the host company mobile application 504 is able to be substantially similar to the application as described in FIGS. 41 to 46. Outline 539 and frames 540, 541, and 543 function as described in FIG. 47, however frame 542 is broken into two frames 544 and 542 and a display element 546 has been added. Frame 545 is the display area where information, services, and advertisements are able to be presented to the user for interaction with the control application 504. Information, services and advertisements displayed in frame 544 can be in the form of text, a tree structure, a tabbed structure, graphics, video or multimedia in various combinations on the mobile devices display within the wireframe element. Further, frame 544 is a secondary display area where information, services, and advertisements can be presented to the user for interaction with the control application 504. Information, services and advertisements displayed in frame 544 can be in the form of text, a tree structure, a tabbed structure, graphics, video or multimedia in various combinations on the mobile devices display within the wireframe element. The size of the frames 544 and 545 in relation to each other and other display elements can be adjusted based on the information, services or advertisements that can be displayed in the elements. Furthermore, frame 544 can be omitted from the display and frame 545 can expand to cover the open display area previously occupied by frame 544. Display element 546 is a navigation button which allows the user to select it and to navigate to a previously viewed screen and content. Each selection is able to update the display in frames 544 and 545 one screen view at a time until the screen view has returned to the original default screen view. At the main default screen view, the display element 546 is able to not be visible.

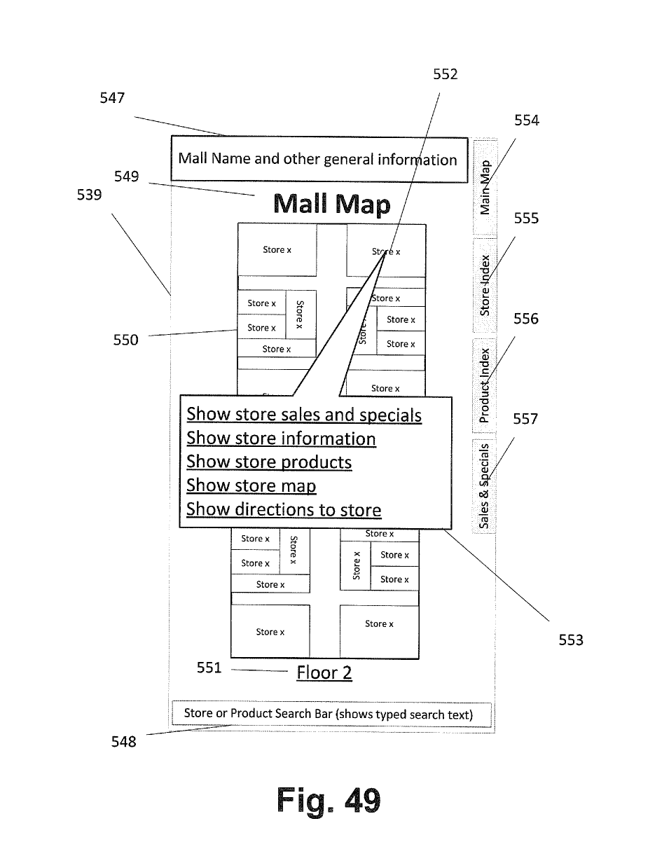

FIG. 49 is an illustration showing a wireframe layout for a main display screen of the mobile control application on a mobile device display with additional details of possible display elements according to some embodiments. The wireframe layout of FIG. 49 is similar to FIG. 47, but populated with additional graphic detail to provide addition information on one method that can be used to display information in display element areas. Outline 539 is the display of a mobile device 500 such as a smart phone display as defined in previous figures. Frame 547 is a frame located at the top of the display which can display text with the site name and other site information to promote the site to the user. One type of displayed information is text listing the current site name such as the mall name with general information about the site (e.g. hour of operation). Frame 548 is a frame located at the bottom of the display which can be a search bar or a banner frame to provide information about the site or show advertisements relating to the current site. In the case where a search bar is displayed, the user can enter text to search for site related information such as stores, products, events, services, and facilities information from the system or site server database. Information can additionally be pulled from websites and other sources over the internet to support the search of site stores, products, events, services, and facilities information. The mobile devices default keyboard is able to be used to enter text for search in frame 548 if it is being used as a search bar and enabled when the user makes a selection in frame 548.

Display element 549 is a title used to label the current displayed information in the main display frame and is able to change with the displayed information in the main display to provide information to the user to understand the presented display which can be but not limited to the text, a tree structure, a tabbed structure, graphics, video or multimedia in various combinations on the mobile devices display. One display element possibility is able to be a site mall map shown by display element 550, which is able to include a map of the mall site showing stores, facilities, services and events. The display element such as 550 can also include additional labels for a particular part of the display element such as display element 551 to better provide clarity or give directions to the user in respect to the displayed text, tree structure, tabbed structure, graphics, video or multimedia. Display point 552 is the user's selection on a display element or a location on a display element such as but not limited to the selection of a store on a site map. The resultant selection can open a window, box, overlay or call out which comprises selectable links to provide the user with additional information about the selected element.

Display element 553 is a container with selectable links in the shape of a call out to which is able to be opened from the selection of the display point 552 to provide a user with the options for the selection of additional information about the selected display element or selection location on a display element. Links presented in display element 553 can include but are not limited to information for a store selection which can include a link for store advertisements, specials, products, general information about the store such as hours of operation, and map of the store or direction to the store. Display element 554, 555, 556, and 557 are selectable links as defined by display element 543 in FIG. 47 and FIG. 48 but with additional details of one possible configurable option. Display element 554 is able to be a selection option which when selected by a user is able to update the main display frame such as frame 542 from FIG. 47 to display site main map such as a mall map as shown in FIG. 49. Display element 555 is able to a selection option which when selected by a user is able to update the main display frame such as frame 542 from FIG. 47 to display a selectable text index listing of stores at a mall site. Display element 556 is able to a selection option which when selected by a user is able to update the main display frame such as frame 542 from FIG. 47 to display a selectable text index listing of products available at a mall site. Display element 557 is able to a selection option which when selected by a user is able to update the main display frame such as frame 542 from FIG. 47 to display a selectable text index listing of sales and specials at a mall site. The tab style selection method such as 554, 555, 556, and 557 used to navigate to other display screen as shown in FIG. 49 can include more selection options than presented and can require the size of the tabs or display element to be adjusted to fit the display area 539 without significant obstruction or adjusts to other element in a current display.

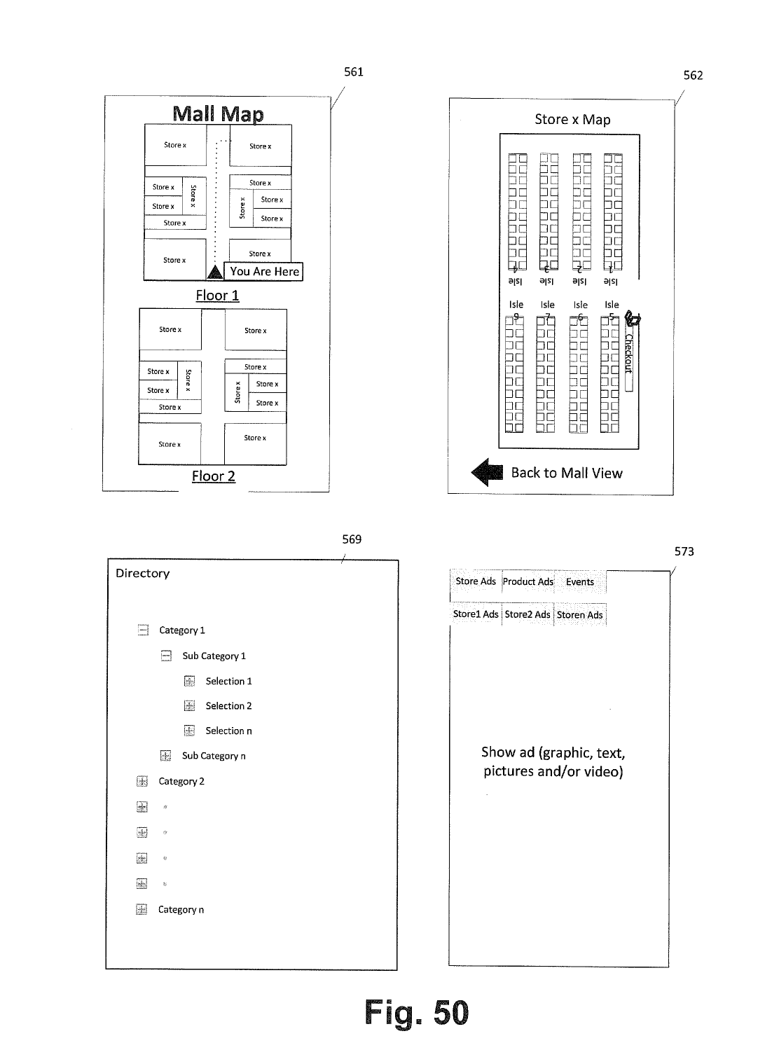

FIG. 50 is a collection of illustrations showing selectable display elements which can be shown in frame 542 from FIG. 47 according to some embodiments. Display element 561 is a site mall map showing a map of a site and location of a user as well a direction overlay showing a path between the user and selected store by a dotted line. The user can make selections from the display element to get information about an element on the map such as a store. The map is also able to comprise labels and titles to give the user more information about the map. Display frame element 573 is a frame with selectable tabs to display more information than the frame can fit into one frame page. Frame 573 can be used to display information relating to products which can be separated into tabbed pages listing site stores that sale the product, show product specification, show any sales on the product, and images of the product. Furthermore, a store's advertisements can be displayed in separate tabbed pages similar to what can be done in store multipage sales paper. Still further, site event information can be displayed with each tab shown as an event.

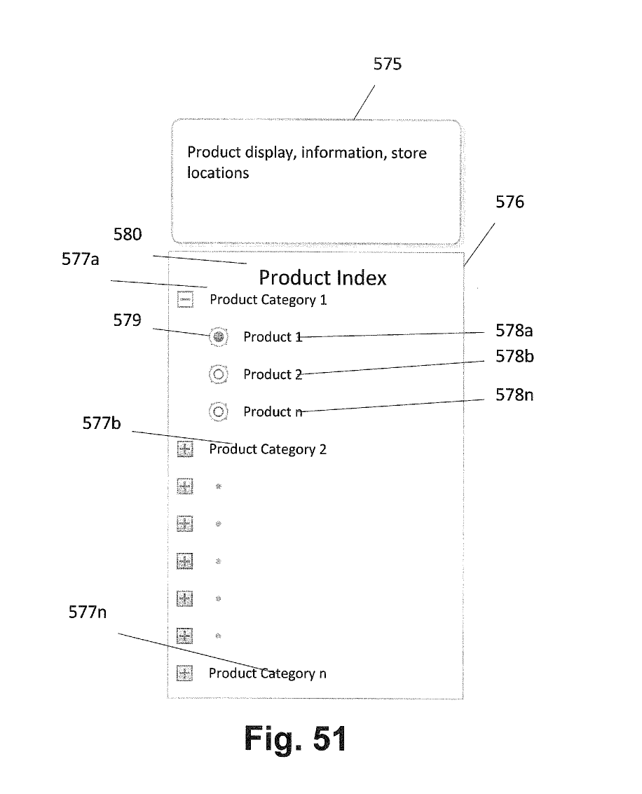

Frame element 562 is a store map showing isles of a store with products on shelves, labels and other standard display elements to present a user with information on a store of interest. Products on the shelves can be shown with boxes and a highlighted box can indicate a product for which a user is searching from a mobile device 500 using a mobile control application 504. Furthermore, there can be navigation display elements such a back button with or without a text label to return to a previous screen display. Frame element 569 is an index listing to provide a user with a tree structure listing such as that described in FIG. 51 for frame 576. Furthermore, frame element 569 can display a listing such as but not limited to a listing of information of interest such as a product listing for a store with products separated into categories with child subcategories and finally selectable products which can be used to show the product on a store map 562 when selected by a radio button from the index. Additionally, scroll bars can be used to aid the navigation of the index when more information is available than can clearly be displayed in the frame.

FIG. 51 is an illustration showing a wireframe layout of two frames showing one possible display layout in a tree structure according to some embodiments. In particular, FIG. 51 illustrates two frames which correspond to frames 544 and 545 from FIG. 48, but show additional detail of a possible display method to present service information to a user of the mobile control application 504 on a mobile device 500. One method of displaying information to user such as a shopper at a mall site is to present product information in a tree structure. Frame element 576 is the directory display frame with a tree structure which is used to present to the user a selectable directory listing of site related categories such as stores, products and services similar to what can be presented today on a free standing print mall map with interactive and additional information. Display element 580 is a title used to label the current displayed information in the display frame to provide information to the user to understand the presented display. Display element 580 is able to be, but is not limited to, a title such as Product Index to indicate to the user that the selection tree presented is for a list of site products.

Display element 577a, 577b, and 577n are able to be a top level category heading as a parent to child level selection. The parent category display elements 577 can be site related categories such as stores, products, events, services and facilities shown in a tree structure with each parent category being selectable to reveal related subcategory or child categories of the main parent category selected. Selectable child categories are represented by display elements 578a, 578b, and 578n, or 578 collectively, and are listed in increased detail from the parent listing such as but limited to a specific product such as specific shoe selected from a parent category 577 of footwear. Radio button 579 from a subcategory 578 can be used as a method of further information selection from a user navigating the directory tree in frame 576. On selection of radio button 579, information from the selection can be presented such as video, text, graphics, or multimedia providing information to the user relating to the product at the current site of use or site of selection using mobile device 500. The information from the radio button selection can be shown in display frame 575. The information shown in frame 575 can be, but is not limited to, a picture of a product, location at the site which sells the product and any sales at the site related to the product or store selling the product.

### Server

FIG. 52 is a block diagram illustrating the layered construction of a site server 201, mobile application server 102 and/or host server 101 with general operational structure from hardware interface to logical control program and database according to some embodiments. As shown in FIG. 52, the lower level block is the server hardware 106, the mid-level block is the operating system 190 and software drivers to interface the server hardware 106 to control operations, and the top level 192 is the control program, database and any other programs for operation of the server which performs data processing operations to achieve the functional results of the interactive service and advertising system. Operating system 190 provides a data interface between the server hardware 106 and control programs 192.

Block 106 illustrates the hardware components of the server and components which are used as modes of input and output of data between other systems such as interactive mall map systems 300, advertisement display systems 400, and mobile devices 500 as well as users authorized to have by the host company. Furthermore, input and output of data can occur between servers 101 and 201. Block 115 is able to comprise a display monitor coupled to the server to provide an interface for an authorized user accessing the server. Block 116 is able to comprise a keyboard and mouse or other input device an authorized user can use to operate, update or service a server as well as any other input or output device an authorized user can use to interact with the server or get notification from the server not covered in block 106 descriptions. Block 117 is able to comprise a single or plurality of data storage units such as hard drives to store data for the operation of the server as well as the data for the operation of the systems and other servers. Block 118 is a data connection for transferring data in and out of the server, such as an Ethernet connection, to other routers, switches, systems, servers or computers authorized to couple and access the server or any other device authorized to couple to the server which can interface with block 118. Block 114 is other server hardware not described in descriptions for items 155 through 118 for the server hardware 106 which includes typical hardware items used to construct a server such as motherboard, CPU, memory, video card, case, power supply and any other hardware items which can be needed for the operation of a server.

Block 190 represents the server operating system and illustrates the components to efficiently link the hardware 106 of the server to programs 192. The components are able to comprise one or more of device drivers 187, operating system kernel 112, and software services programs, manager programs, and interface programs 111. The hardware to software interface component of operating system 190 is the device drivers 187. The device drivers 187 are able to comprise some or all libraries, files, and programs to interface each hardware component of the server to the operating system kernel 112, and in some cases, to services programs, manager programs and interface programs 111 of the operating system, and/or to components of the system programs 192. Device drivers 187 used are specific and defined by hardware used and operating system installed on the server. OS kernel 112 is the core functionality of the operating system to function on the server. Software services programs, manager programs and interface programs 111 are all programs and data files to support the functions of OS kernel 112 and to provide interface capabilities to the server programs 192. Operating system 190 can be a commercial paid, open source, or custom software operating system to control the operation of and directs processing programs on the server.

Block 192 is able to comprise system programs which are the host company server programs 107, any needed interpreters and libraries 108, server databases 164, server management application 109, and storage management programs 110 to operate the server. Server program 107 is a control program developed for the server to perform the functions in conjunction with other software and hardware components on the server. Interpreter and libraries 108 are software programs and data files to provide interface between server program 107 and operating system 190. In some embodiments, some functions of server program 107 can directly access operating system 190. The selection and use of interpreters and libraries 108 is determined by programming language or languages used to develop the server program 107, operating system 190 selected for use, and the extent to which control functions are performed by custom developed control programs, used or integrated third party software programs display elements. Server management programs 109 are able to comprise programs which can execute on the server which can assist in the operation of the server for efficient and proper operation of the server hardware and software configuration. The programs 109 are able to include but are not limited to virus checkers, access security programs, performance monitoring, and performance and access logging programs. Storage management programs 110 are able to comprise programs which can execute on the server which can assist in the operation and management of the server storage devices for efficient and proper operation for the server hardware, and software configuration. The programs 110 are able to include but are not limited to data recover programs, disk usage management programs, performance monitoring, performance and access logging programs, and any program which can be needed for the storage hardware devices attached to the server to operate on the server.

FIG. 53 is a block diagram illustrating system input and output methods and how they relate to functional blocks of the server control program and server database modules used for the operation of the server in a interactive service and advertising system according to some embodiments. The blocks are input block 162 comprising some or all of the system inputs (e.g. physical input devices and input methods), functional modules 163 (which represent the functional operating module which are the functional blocks of the server control program), the databases block 164 (which are the databases used to store and retrieve information for the server control program), and the output block 165 which can be considered the outputs of the server (e.g. physical and data outputs as well as methods of output).

Block 162 inputs are able to comprise a keyboard and mouse 167, files 168, and wired Ethernet 169 and optical driver 191. The keyboard and mouse 167 is one way of directly inputting data and commands into the serve by an authorized user. Data files 168 are one method of moving data into the server such as files to build or update the database 164. The data files 168 are able to comprise data which can be needed for each database category such as but is not limited to data files comprising text data, multimedia, video, audio, images and selectable links such as URL links. Ethernet connection 169 is a wired Ethernet connection and is able to be one data input method for transferring data such as filed 168 over a data network to input into the server database 164 or update a server control program with any other programs for the operating system or operation of the server. Optical drive 191 is another input method for transferring data such as files 168. The drive 191 can be used to update server databases 164 or to update a server control program or any other programs for the operating system or operation of the server. Block 165 outputs are able to comprise the monitor display 166 and wired Ethernet connection 169. Ethernet connection 169 function as previously described for the inputs but also can be considered one output method of data to routers, switches, systems, servers or computers authorized to couple and access the server or any other device authorized to couple to the server. The monitor 166 is any display interface which a user can view to interface with the server and receive response from the server.

Modules 163 are shown with sub-blocks listing functional blocks of the host company server control program 107, from FIG. 52. Databases 164 are shown with sub-blocks listing primary databases blocks of the server database. Module block database interface 170 manages the updates and transfer of database files between servers 101, 102, 201 and systems 300 and 400 to keep all the server and system databases up-to-date which can request access to all databases listed in database 164. The host server 101 is able to disseminate the database updates with server 102, 201, and system 300, and 400 receiving the updates which can be considered a downstream update. Logging data from servers and system as well as advertisement score data can be transferred upstream as well as downstream. The server database interface 170 is the module responsible for the exchanges described above of this paragraph relating to servers. Module block network and connection 171 manages the data network connections through the Ethernet connection 169. Database interface module 170 works with database manager module 174, and network and connection module 171 to interface with other servers and systems to transfer data from and to the server database 164. Network and connection 171 manages the connections to the servers 101, 102, 201 and systems 300 and 400. Some connection data is able to be stored in the location statistics database 185. For example, the mobile server 102 is able to log connection data (e.g. the number of mobile devices 500 coupled to the system) along with a time stamp.

Module block administrative 172 manages the version of control program installed on the system, ensures the databases are updated, and manages the unique server identifier along with other minor administrative control management activities such as background checks to ensure everything is functioning as expected. Module block logger 173 manages the logging of activities, connections, and access events to database 164 on the server working with database interface module 170, network and connection module 171, and logging of information to the location statistics database 185. Module block database manager 174 manages the access between all databases 164 and function modules 163 which reads or writes to the database. Management activities include but are not limited to ensuring no two module write to a database at the same time, ensuring the correct versions of the databases are installed on the server and coordinate with the logger module 173 to log reads and writes to the databases. Database 164 is able to comprise one or more databases or database categories including data which can be in the form of text data, multimedia, video, audio, images and selectable links such as URL links. Database 175 stores data for display by the side bar/banner ad modules for systems 300, 400 and 500. Side bar/banner ad database 175 can comprise text data, multimedia, video, audio, images and selectable links such as URL links for advertisement display in banner frames on system 300 and 400 and can be replicated from host server 101 to site server 201 to systems 300 and 400 as well as from host server 101 to mobile server 102. Database 176 comprises advertisement data for general advertisement displays on system 300, 400 and 500 and can comprise data such as text data, multimedia, video, audio, images and selectable links such as URL links for advertisements. General advertisement database 176 can be replicated from host server 101 to site server 201 to systems 300 and 400 as well as from host server 101 to mobile server 102. Database 177 comprises a directory listing for display on system 300, 400 and 500 and can comprise data such as text data, images and selectable links such as URL links for listing display. Directory database 177 can be replicated from host server 101 to site server 201 to systems 300 and 400 as well as from host server 101 to mobile server 102. Database 178 comprises sites with system 300 and 400 installed map data for display on system 300, 400 and 500 and can comprise data such as text data, images and selectable links such as URL links for listing display relating to site maps. Maps database 178 can be replicated from host server 101 to site server 201 to systems 300 and 400 as well as from host server 101 to mobile server 102.

Database 179 comprises specific store data relating to stores in sites with system 300 and 400 installed for the purpose of display on system 300, 400 and 500. Data can be in the form of text data, multimedia, video, audio, images and selectable links such as URL links for providing user or shopper general information on stores as well as links to specific advertisements in the database 176 for a store. Stores database 179 can be replicated from host server 101 to site server 201 to systems 300 and 400 as well as from host server 101 to mobile server 102. Database 180 comprises specific product data for products sold by stores in sites with system 300 and 400 installed for the purpose of display on system 300, 400 and 500. Product data can be in the form of text data, multimedia, video, audio, images and selectable links such as URL links for providing user or shopper information on the product such as but not limited to locations where it can be purchased in a site, descriptions and images or video of products, ratings or reviews of products as well as link to specific advertisements in the database 176 for a product. Product database 180 can be replicated from host server 101 to site server 201 to systems 300 and 400 as well as from host server 101 to mobile server 102. Database 181 comprises specific event data for event which can occur at sites with systems 300 and 400 installed for the purpose of display on systems 300, 400 and 500. Event data can be in the form of text data, multimedia, video, audio, images and selectable links such as URL links for providing user or shopper information on an event such as but not limited to locations where and when the event will occur, the subject or topic of the event, name of the event as well as link to specific advertisements in the database 176 for an event. Event database 181 can be replicated from host server 101 to site server 201 to systems 300 and 400 as well as from host server 101 to mobile server 102.

Database 182 comprises facility data for facilities at sites with systems 300 and 400 installed for the purpose of display on systems 300, 400 and 500. Facility data can be in the form of text data, multimedia, video, audio, images and selectable links such as URL links for providing user or shopper information on the site facilities such as locations where they are located by showing them on a site map and what they are such as but not limited to stairs, escalators, bathrooms, elevators, exits, water fountains, information counters, carts, and entrances. Facility database 182 can be replicated from host server 101 to site server 201 to systems 300 and 400 as well as from host server 101 to mobile server 102. Database 183 comprises general site information data for a site with system 300 and 400 installed for the purpose of display on systems 300, 400 and 500. General site information data can be in the form of text data, multimedia, video, audio, images and selectable links such as URL links for providing user or shopper information about the site such as but not limited to hours of operation, address, name of location, owner of location and primary point of interest for location. General site information database 183 can be replicated from host server 101 to site server 201 to systems 300 and 400 as well as from host server 101 to mobile server 102.

Database 184 comprises host company information for the purpose of display on system 300 and 400. Host company information data can be in the form of text data, multimedia, video, audio, images and selectable links such as URL links for providing user or shopper information about the host company of the system such as but not limited to the name of company, contact information for the company such as sales contact and any primary points of interest relating to the host company. Host company information database 184 can be replicated from host server 101 to site server 201 to systems 300 and 400 as well as from host server 101 to mobile server 102. Database 185 comprises location usage statistic data for systems 300 and 400 installed at sites. Location usage statistics data can be in the form of text data and includes but not limited to data for the usage of a system 300 and 400 as well as mobile server 102 and site server 201. Furthermore, data can include time stamps of events, types of data requested, what systems or devices with unique identifiers have requested data or access to system or servers, and duration of request or transfer of data. Location usage statistic database 185 can be replicated from system 300 and 400 to site servers 201 then to host server 101 as well as from mobile server 102 to host server 101. Database 186 can comprise camera video from systems 300 and 400 installed at sites as requested by the host server 101. Camera video data can be in the form of text designators and video from systems 300 and 400 comprising time stamp on video and unique identifier or the location where the video was captured. Furthermore, audio can also be capture in location where acceptable by local laws and regulations. Camera video database 186 can be replicated from system 300 and 400 to site servers 201 then to host server 101.

The interactive service and advertising system, method and device described herein has numerous advantages. The interactive service and advertising system, method and device provides the benefit of a touchscreen display of a site's map and directory which is displayed showing coupled information, such as when a store is selected in the directory it is also highlighted on the map and vice versa. Further, the dynamic displays of a map and directory enable use of a smaller display area. The reductions in required display space is achieved while providing significantly more capabilities and a reduced footprint required to provide site patrons with map and directory information while presenting relevant advertisements to support the costs associated with the interactive map and advertisement system. The low relevance of advertisements shown on previous systems is improved with the interactive map and advertisement system due to the information services provided to the user of the system providing site, store, and product information which in turn enable the system to determine the current preferences of the user based their selection. For example, a selection on the system touchscreen for shoes may cause an advertisement to be shown for shoes.

Additionally, a request for information for shoes from a mobile device coupled to the system through a wireless connection is able to also trigger an advertisement for shoes on the systems non-touch display. The camera inputs can also be combined with the selections made on the touchscreen to enhance the determination of the user's preferences. Other sensor types are used for detection of people in close proximity and view range of the system to enhance the accuracy of the systems vision system. Combining the user inputs from touchscreen, mobile device, and vision system, an understanding of a user or the site of installation users can be determined in real-time enabling highly relevant advertisement to be shown as well as build a database of a sites shopper analytics to improve a site's shopping experience, and product and service offerings. By providing connection and control methods to personal mobile devices, select information can be shown on one of the system non-touch displays to provide the display of information not easily readable on the mobile devices display such a full or floor mall map showing the mobile devices location and point of interest as well as surrounding stores.

The interactive service and advertising system, method and device has been described in terms of specific embodiments incorporating details to facilitate the understanding of the principles of construction and operation of the interactive service and advertising system, method and device. The specific configurations shown and the methodologies described in relation to the various modules and the interconnections there between are for exemplary purposes only. Such reference herein to specific embodiments and details thereof is not intended to limit the scope of the claims appended hereto. It will be apparent to those skilled in the art that modifications may be made in the embodiments chosen for illustration without departing from the spirit and scope of the system. For example, although many reference are relating to a retail shopping mall, the system and its functions are not limited to a mall setting. The system and methods described are also able to be applied to a retail store where the map displays is of the store and directory lists products and product categories sold by the store. Advertisements shown are able to be those shown by brands that are sold by the retail store. Furthermore the system may be applied to any large indoor location where map is able to be used to help a user navigate to a location or a directory is able to be used to find a specific location or information about a location such as at hospitals or large exposition type events.

What is claimed is:

1. An interactive service and advertising system, comprising:
a first interactive device having a first display and a first content database storing one or more content items each having a first content score; and
a first controller coupled with the first interactive device, wherein the first controller selects and displays a selected content item having the highest first content score on the first display for a predefined content period.

2. The system of claim 1, wherein the first interactive device comprises one or more first sensors that cause the first controller to select and display the selected content item when the first sensors detect one or more users are proximate the first interactive device.

3. The system of claim 2, further comprising a user database storing one or more user entries, wherein the first sensors detect one or more characteristics of users that are proximate the first interactive device and the first controller stores the characteristics for each of the users in one of the user entries.

4. The system of claim 3, wherein the characteristics are selected from the group consisting of a media access control address of a device of the user, a presence of the user, one or more images of the user, a location of the user relative to the first interactive device, areas of the first interactive device gazed upon by the user and user data submitted by the user on the first interactive device.

5. The system of claim 4, wherein the user data submitted by the user on the first interactive device is selected from the group consisting of a sale, a product and a destination.

6. The system of claim 4, wherein based on one or more of the characteristics the first controller determines one or more attributes of the corresponding user selected from the group consisting of age, gender, hair color, eye color, clothing color, height, weight and race.

7. The system of claim 6, wherein the first controller adjusts the first content score of one or more of the content items based on the characteristics, the attributes or both.

8. The system of claim 7, wherein during the predefined content period the first sensors detect one or more content analytic values that are then associated with the selected content item in an analytic database by the first controller, wherein the content analytic values are selected from the group consisting of:
a quantity of users proximate the first interactive device;
a duration that each of the users proximate the first interactive device is proximate the first interactive device;
whether the selected content item was displayed in the areas gazed upon by the users proximate the first interactive device; and
the user data submitted by the users proximate the first interactive device relating to the selected content item, the attributes of the users proximate the first interactive device.

9. The system of claim 7, wherein the first controller identifies a user detected by the first sensors by matching one of the user entries to the user based on the characteristics stored in the matched user entry, and further wherein the first controller adjusts the first content score of one or more of the content items based on the matched user entry.

10. The system of claim 9, further comprising a second controller coupled with a second interactive device having a second display, one or more second sensors and a second database storing one or more of the content items each having a second content score, wherein the second controller selects and displays the content item having the highest second content score on the second display.

11. The system of claim 10, wherein the second controller identifies a user detected by the second sensors by matching one of the user entries to the user based on the characteristics stored in the matched user entry, and further wherein the second controller adjusts the second content score of one or more of the content items based on the matched user entry.

12. The system of claim 11, wherein the second controller adjusts the second content score of one or more of the content items based on one or more of the characteristics detected by the first sensors and a location of the second interactive device relative to a location of the first interactive device.

13. The system of claim 12, wherein the adjustment of the second content score of the one or more of the content items based on one or more of the characteristics detected by the first sensors and the location of the second interactive device relative to the location of the first interactive device is limited to a predetermined walk period whose length is based on the distance between the first and second interactive devices.

14. The system of claim 1, wherein the first controller increases the value of the content score of a content item displayed on the first display when the first sensors detect that the one or more users are proximate the first interactive device for a predefined score period while the content item was being displayed.

15. The system of claim 1, wherein the first controller decreases the value of the content score of the selected content item upon the display of the selected content item on the first display.

16. The system of claim 1, wherein the first interactive device is configured to wirelessly couple to a mobile device such that the first controller receives one or more commands from the mobile device and transmits one or more of the content items from the first content database to the mobile device based on the commands.

17. An interactive service and advertising device, comprising:
a first display;
a memory storing a first content database including one or more content items each having a first content score; and
a first controller coupled to the first display and the memory, wherein the first controller selects and displays a selected content item having the highest first content score on the first display for a predefined content period.

18. The device of claim 17, further comprising one or more first sensors that cause the first controller to select and display the selected content item when the first sensors detect one or more users are proximate the first display.

19. The device of claim 18, further comprising a user database storing one or more user entries, wherein the first sensors detect one or more characteristics of users that are proximate the first display and the first controller stores the characteristics for each of the users in one of the user entries.

20. The device of claim 19, wherein the characteristics are selected from the group consisting of a media access control address of a device of the user, a presence of the user, one or more images of the user, a location of the user relative to the first display, areas of the first display gazed upon by the user and user data submitted by the user via the first sensors.

21. The device of claim 20, wherein the user data submitted by the user via the first sensors is selected from the group consisting of a sale, a product and a destination.

22. The device of claim 20, wherein based on one or more of the characteristics the first controller determines one or more attributes of the corresponding user selected from the group consisting of age, gender, hair color, eye color, clothing color, height, weight and race.

23. The device of claim 22, wherein the first controller adjusts the first content score of one or more of the content items based on the characteristics, the attributes or both.

24. The device of claim 23, wherein during the predefined content period the first sensors detect one or more content analytic values that are then associated with the selected content item in an analytic database by the first controller, wherein the content analytic values are selected from the group consisting of:
a quantity of users proximate the first display;
a duration that each of the users proximate the first display is proximate the first display;
whether the selected content item was displayed in the areas gazed upon by the users proximate the first display; and
the user data submitted by the users proximate the first display relating to the selected content item, the attributes of the users proximate the first display.

25. The device of claim 23, wherein the first controller identifies a user detected by the first sensors by matching one of the user entries to the user based on the characteristics stored in the matched user entry, and further wherein the first controller adjusts the first content score of one or more of the content items based on the matched user entry.

26. The device of claim 17, wherein the first controller increases the value of the content score of a content item displayed on the first display when the first sensors detect that the one or more users are proximate the first display for a predefined score period while the content item was being displayed.

27. The device of claim 17, wherein the first controller decreases the value of the content score of the selected content item upon the display of the selected content item on the first display.

28. The device of claim 17, wherein the first controller is configured to wirelessly couple to a mobile device such that the first controller receives one or more commands from the mobile device and transmits one or more of the content items from the first content database to the mobile device based on the commands.

29. An interactive service and advertising server, comprising:
a memory storing a content database including one or more content items each having a first content score associated with a first interactive device and a second content score associated with a second interactive device; and
a server controller coupled with the first interactive device, wherein the server controller selects and displays a selected content item having the highest first content score on a first display of the first interactive device for a predefined content period.

30. The server of claim 29, wherein the first interactive device comprises one or more first sensors that cause the server controller to select and display the selected content item when the first sensors detect one or more users are proximate the first interactive device.

31. The server of claim 30, further comprising a user database stored on the memory and including one or more user entries, wherein the first sensors detect one or more characteristics of users that are proximate the first interactive device and the server controller stores the characteristics for each of the users in one of the user entries.

32. The server of claim 31, wherein the characteristics are selected from the group consisting of a media access control address of a device of the user, a presence of the user, one or more images of the user, a location of the user relative to the first interactive device, areas of the first interactive device gazed upon by the user and user data submitted by the user on the first interactive device.

33. The server of claim 32, wherein the user data submitted by the user on the first interactive device is selected from the group consisting of a sale, a product and a destination.

34. The server of claim 32, wherein based on one or more of the characteristics the server controller determines one or more attributes of the corresponding user selected from the group consisting of age, gender, hair color, eye color, clothing color, height, weight and race.

35. The server of claim 34, wherein the server controller adjusts the first content score of one or more of the content items based on the characteristics, the attributes or both.

36. The server of claim 35, wherein the memory further comprises an analytic database and during the predefined content period the first sensors detect one or more content analytic values that are then associated with the selected content item in the analytic database by the server controller, wherein the content analytic values are selected from the group consisting of:
a quantity of users proximate the first interactive device;
a duration that each of the users proximate the first interactive device is proximate the first interactive device;
whether the selected content item was displayed in the areas gazed upon by the users proximate the first interactive device; and
the user data submitted by the users proximate the first interactive device relating to the selected content item, the attributes of the users proximate the first interactive device.

37. The server of claim 36, wherein the server controller identifies a user detected by the first sensors by matching one of the user entries to the user based on the characteristics stored in the matched user entry, and further wherein the server controller adjusts the first content score of one or more of the content items based on the matched user entry.

38. The server of claim 37, wherein the second interactive device comprises a second display and one or more second sensors, wherein the server controller selects and displays the content item having the highest second content score on the second display.

39. The server of claim 38, wherein the server controller adjusts the second content score of one or more of the content items based on one or more of the characteristics detected by the first sensors and a location of the second interactive device relative to a location of the first interactive device.

40. The server of claim 39, wherein the adjustment of the second content score of the one or more of the content items based on one or more of the characteristics detected by the first sensors and the location of the second interactive device relative to the location of the first interactive device is limited to a predetermined walk period whose length is based on the distance between the first and second interactive devices.

41. The server of claim 29, wherein the server controller increases the value of the content score of a content item displayed on the first display when the first sensors detect that the one or more users are proximate the first interactive device for a predefined score period while the content item was being displayed.

42. The server of claim 29, wherein the server controller decreases the value of the content score of the selected content item upon the display of the selected content item on the first display.

43. A method of providing an interactive service and advertising system, the method comprising:
scoring one or more content items in a first content database with a first controller such that each of the content items has a first content score;
selecting a selected content item of the content items that has the highest first content score with the first controller; and
displaying the selected content item on a first display of a first interactive device for a predefined content period with the first controller.

44. The method of claim 43, further comprising detecting when one or more users are proximate the first display with one or more first sensors and initiating the selection and display of the selected content item when the first sensors detect that the one or more users are proximate.

45. The method of claim 44, further comprising detecting one or more characteristics of users that are proximate the first display with the first sensors and storing the characteristics for each of the users in a separate user entry within a user database.

46. The method of claim 45, wherein the characteristics are selected from the group consisting of a media access control address of a device of the user, a presence of the user, one or more images of the user, a location of the user relative to the first interactive device, areas of the first interactive device gazed upon by the user and user data submitted by the user on the first interactive device.

47. The method of claim 46, wherein the user data submitted by the user on the first interactive device is selected from the group consisting of a sale, a product and a destination.

48. The method of claim 46, further comprising based on one or more of the characteristics determining with the first controller one or more attributes of the corresponding user selected from the group consisting of age, gender, hair color, eye color, clothing color, height, weight and race.

49. The method of claim 48, further comprising adjusting the first content score of one or more of the content items with the first controller based on the characteristics, the attributes or both.

50. The method of claim 49, further comprising, during the predefined content period, detecting one or more content analytic values with the first sensors and associating the analytic values with the selected content item in an analytic database with the first controller, wherein the content analytic values are selected from the group consisting of:
a quantity of users proximate the first interactive device;
a duration that each of the users proximate the first interactive device is proximate the first interactive device;
whether the selected content item was displayed in the areas gazed upon by the users proximate the first interactive device; and
the user data submitted by the users proximate the first interactive device relating to the selected content item, the attributes of the users proximate the first interactive device.

51. The method of claim 49, further comprising identifying a user detected by the first sensors with the first controller by matching one of the user entries to the user based on the characteristics stored in the matched user entry, and adjusting the first content score of one or more of the content items with the first controller based on the matched user entry.

52. The method of claim 51, further comprising:
storing one or more of the content items in a second content database with a second controller such that each of the content items has a second content score;
selecting a content item of the content items having the highest second content score with the second controller; and
displaying the content item on a second display of a second interactive device with the second controller.

53. The method of claim 52, further comprising identifying a user detected by the second sensors with the second controller by matching one of the user entries to the user based on the characteristics stored in the matched user entry, and adjusting the second content score of one or more of the content items with the second controller based on the matched user entry.

54. The method of claim 53, further comprising adjusting the second content score of one or more of the content items with the second controller based on one or more of the characteristics detected by the first sensors and a location of the second interactive device relative to a location of the first interactive device.

55. The method of claim 54, wherein the adjustment of the second content score of the one or more of the content items based on one or more of the characteristics detected by the first sensors and the location of the second interactive device relative to the location of the first interactive device is limited to a predetermined walk period whose length is based on the distance between the first and second interactive devices.

56. The method of claim 43, further comprising increasing the value of the content score of a content item displayed on the first display with the first controller when the first sensors detect that the one or more users are proximate the first interactive device for a predefined score period while the content item was being displayed.

57. The method of claim 43, further comprising decreasing the value of the content score of the selected content item with the first controller upon the display of the selected content item on the first display.

58. The method of claim 43, further comprising wirelessly coupling a mobile device with the first controller such that the first controller receives one or more commands from the mobile device and transmits one or more of the content items from the first content database to the mobile device based on the commands.
